(19) United States
(12) Patent Application Publication
(10) Pub. No.: US 2026/0249471 A1
(43) Pub. Date: Aug. 27, 2026

(54) SYSTEM AND METHOD FOR AUTOMATIC ALIGNING AND CONNECTION OF SOLAR MODULES AND GROUND STRUCTURES

(71) Applicant: The AES Corporation, Arlington, VA (US)

(72) Inventors: Diego Botelho, Reston, VA (US); Scott Kalm, Arlington, VA (US); Nicolas Riehl, Arlington, VA (US); Deise Yumi Asami, Reston, VA (US); John Christopher Shelton, Vienna, VA (US); Nathan McKerley, Pittsburgh, PA (US); Philip Beard, Pittsburgh, PA (US)

(73) Assignee: The AES Corporation, Arlington, VA (US)

(21) Appl. No.: 19/549,887

(22) Filed: Feb. 25, 2026

Related U.S. Application Data
(60) Provisional application No. 63/763,226, filed on Feb. 25, 2025.
(60) Provisional application No. 63/910,604, filed on Nov. 3, 2025.

(51) Int. Cl. B25J 9/16; B25J 5/00; H02S 20/20

(52) U.S. Cl. CPC B25J 9/1687; B25J 5/00; B25J 9/1697; H02S 20/20

(57) ABSTRACT

A system and method for automatic aligning and connection of solar modules and ground structures. Installation of a solar module to a ground structure can be both labor-intensive and time-intensive. The system and method performs one or more automatic operations that may be used to install the solar module to the ground structure, including automatically orienting fasteners into a predetermined orientation; automatically moving one or both of the solar module or a part of the ground structure so that the solar module and the part of the ground structure are physically contacting/aligned; and automatically fixedly connecting the solar module and the part of the ground structure together using the fasteners with predetermined orientation.

### REFERENCE TO RELATED APPLICATIONS

The present application claims priority benefit to U.S. Provisional Application No. 63/763,226 filed on Feb. 25, 2026, and to U.S. Provisional Application No. 63/910,604 filed on Nov. 3, 2025, both of which are incorporated by reference herein in their entirety.

### FIELD OF THE INVENTION

The present application relates generally to solar module installation, and more specifically, to systems and methods for securing a solar module to a racking structure.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A photovoltaic or solar array includes a collection of solar modules (interchangeably termed solar panels) connected to one another and configured to capture and convert sunlight into electricity. Construction of a solar array typically involves coupling or attaching a plurality of solar modules to an installation or racking structure. The racking structure may be disposed below the plurality of solar modules and configured to support the solar modules. The racking structure may further include one or more attachment points at which individual solar modules may be coupled to the racking structure.

The large size and fragile nature of the solar module pose unique challenges for the installation of solar modules. Additionally, the large number of solar modules typically included in a solar array make construction of a solar array labor intensive, time consuming, and costly. For example, coupling each solar module to the racking structure may require fasteners (e.g., pins) to be passed through confined spaces before being inserted through mounting holes included in the solar module and racking structure. Repeating this process for each solar module included in a solar array is both labor intensive and time consuming.

### SUMMARY

In one or some embodiments, a method (such as a computer-implemented method) of, in combination, automatically moving a solar module into alignment with ground structure and automatically fastening the solar module to the ground structure is disclosed. The method includes: automatically moving, using at least one perception system, the solar module into alignment with the ground structure; and automatically fastening, using the at least one perception system, the solar module that is aligned to the ground structure; wherein automatically moving and automatically fastening are performed in combination.

In one or some embodiments, a system configured to perform, in combination, automatically moving a solar module into alignment with ground structure and automatically fastening the solar module to the ground structure is disclosed. The system includes: at least one solar module movement system to move the solar module; at least one fastening system to fasten the solar module to the ground structure; at least one perception system; and at least one controller in communication with the at least one solar module movement system and the at least one fastening system. The at least one controller may be configured to: automatically control, using the at least one perception system, the at least one solar module movement system to move the solar module into alignment with the ground structure; and automatically control, using the at least one perception system, the at least one fastening system to fasten the solar module that is aligned to the ground structure; wherein the at least one controller is configured to control automatically moving and automatically fastening to be performed in combination.

In one or some embodiments, a computer-implemented method of automatically fastening a solar module to ground structure is disclosed. The method includes: responsive to receiving an indication that the solar module has been placed in alignment on the ground structure: automatically accessing position information indicative of aligned holes on the solar module and the ground structure; automatically moving a fastener tool based the position information; automatically routing, along a nonlinear path, a fastener in a predetermined orientation into the aligned holes on the solar module and the ground structure; and automatically fastening, using at least one fastening robotic system, the solar module to the ground structure.

In one or some embodiments, a system configured to automatically fasten a solar module to ground structure is disclosed. The system includes: fastening tool configured to route a fastener and to fasten the fastener; at least one motor configured to move at least a part of the fastening tool; and at least one controller in communication with the at least one motor. The at least one controller configured to: responsive to receiving an indication that the solar module has been placed in alignment on the ground structure: automatically access position information indicative of aligned holes on the solar module and the ground structure; automatically control, based the position information and using the at least one motor, the fastening tool to move the at least a part of the fastener tool; automatically control the fastener tool to route, along a nonlinear path, the fastener in a predetermined orientation into the aligned holes on the solar module and the ground structure; and automatically control the fastening tool to fasten the solar module to the ground structure.

In one or some embodiments, a computer-implemented method of, in combination, automatically orienting a fastener and automatically inserting the fastener into aligned holes of a solar module and ground structure is disclosed. The method includes: automatically orienting the fastener in a predetermined orientation at: a central station that replenishes the fasteners in an automated vehicle that performs automatic fastening; an automated trailer that transports the fasteners to the automated vehicle; or the automated vehicle; and automatically inserting, by the automated vehicle, the fasteners that are in the predetermined orientation into the aligned holes of the solar module and the ground structure.

In one or some embodiments, a system configured to, in combination, automatically orient a fastener and automatically insert the fastener into aligned holes of a solar module and ground structure is disclosed. The system includes: structure configured to orient the fasteners into a predetermined orientation, the structure resident on a central station that replenishes the fasteners in at least one automated vehicle that performs automatic fastening; an automated trailer that transports the fasteners to the at least one automated vehicle; or the at least one automated vehicle; a fastener tool configured to insert the fasteners into the aligned holes and to fasten the solar module to the ground structure using the fasteners; and at least one controller configured to: control the structure to orient the fasteners into the predetermined orientation; and control the fastener tool to automatically insert the fasteners in the predetermined orientation into the aligned holes of and to fasten the solar module to the ground structure using the fasteners.

In one or some embodiments, a computer-implemented method of automatically positioning a solar module to be in alignment with ground structure is disclosed. The method includes: automatically generating, using at least one perception system associated with fastening, alignment data; and automatically moving, using the alignment data from the at least one perception system associated with fastening, the solar module to be in alignment with the ground structure.

In one or some embodiments, a system configured to automatically position a solar module to be in alignment with ground structure. The system includes: at least one perception system associated with fastening; at least one positioning system configured to position the solar module; and at least one controller in communication with the at least one perception system and the at least one positioning system. The at least one controller configured to: automatically generate, using the at least one perception system associated with fastening, alignment data; and automatically controlling the at least one positioning system to move, using the alignment data from the at least one perception system associated with fastening, the solar module to be in alignment with the ground structure.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1A is a first example block diagram of the solar module installation system.

FIG. 1B is a second block diagram of the solar module installation system.

FIG. 1C is a third block diagram of the solar module installation system.

FIG. 1D is a fourth block diagram of the solar module installation system that includes at least two autonomous vehicles.

FIG. 1E is a fifth block diagram of the solar module installation system that includes at least two autonomous vehicles.

FIG. 1F is a block diagram of a plurality of solar module mobile installation tools wirelessly communicating with a central controller.

FIGS. 2A-C are block diagrams of different sequences of inputting predetermined oriented fasteners into automatic fastener(s) fixed connection.

FIGS. 2D-E are block diagrams of different implementations of the automatic fastener(s) alignment with a vibration sub-system.

FIGS. 2F-G are block diagrams of different implementations of the automatic fastener(s) alignment with a robotic sub-system.

FIG. 2H is a block diagram of the automatic fastener(s) alignment with a moving platform sub-system.

FIGS. 2I-J are front and rear perspective views of the moving platform sub-system.

FIG. 2K is a perspective view of the holder for the drum of the moving platform sub-system.

FIGS. 2L-M are different implementations of drums for different fastener alignment of the moving platform sub-system.

FIG. 2N is a perspective view of the moving platform sub-system with an air blowing sub-system working in conjunction with the moving platform sub-system.

FIG. 2O is a view of the moving platform sub-system sorting two different types of fasteners, such as pins and collars, that are fed to an automatic fastener fixed connection system.

FIG. 2P is a flow chart for automatically aligning the fastener(s), automatically aligning the solar module and at least a part of the ground structure, and automatically fixedly connecting the solar module and at least a part of the ground structure.

FIG. 3A is a diagram illustrating alignment of a solar module and an intermediate support structure in accordance with one example of the present disclosure.

FIG. 3B illustrates an intermediate support structure in accordance with one example of the present disclosure.

FIG. 3C is a diagram illustrating an act of installing a solar module and an intermediate support structure.

FIG. 4A is a block diagram of the fastener connection module.

FIG. 4B is a block diagram of the fastener connection movement module in FIG. 4A.

FIG. 5A is a first expanded block diagram of the fastener connection movement module in FIG. 4B.

FIG. 5B is a second expanded block diagram of the fastener connection movement module in FIG. 4B.

FIG. 5C is a flow chart for determining a motion profile for the fastener and controlling movement of the fastener into the aligned holes according to the motion profile.

FIG. 6 illustrates a first perspective view of a tool for inserting a fastener through aligned holes of a solar module and an intermediate support structure and automatically coupling a threaded coupling to the fastener.

FIG. 7A illustrates a second perspective view of the tool of FIG. 6.

FIG. 7B illustrates a fastener insertion subassembly in accordance with one example of the present disclosure.

FIG. 8A illustrates a fastener coupling subassembly in a first position in accordance with one example of the present disclosure.

FIG. 8B illustrates a fastener coupling subassembly in a second position in accordance with one example of the present disclosure.

FIG. 9A illustrates a system for automatically installing a solar module and an intermediate support structure in accordance with one example of the present disclosure.

FIG. 9B illustrates a cross section of different modules of the solar module mobile installation tool and the ground structure in a single autonomous device.

FIG. 9C illustrates a cross section of different modules of the solar module mobile installation tool and the ground structure in a multiple autonomous devices.

FIG. 9D illustrates a flow chart for using a perception system associated with fastening in order to automatically move the solar module toward and in alignment with the ground structure.

FIG. 10 illustrates an end of arm assembly tool in accordance with one example of the present disclosure.

FIG. 11 illustrates an operation of installing a solar module and an intermediate support structure is illustrated in accordance with one example of the present disclosure.

FIG. 12 illustrates a fastener insertion subassembly in accordance with another example of the present disclosure.

FIG. 13 illustrates an alignment tool in accordance with one example of the present disclosure.

FIG. 14 illustrates an alignment tool in contact with a racking structure in accordance with one example of the present disclosure.

FIG. 15 illustrates a flow chart for automatically installing a solar module and an intermediate support structure in accordance with one example of the present disclosure.

FIG. 16 illustrates a flow chart for automatically moving a solar module relative to an intermediate support structure in accordance with one example of the present disclosure.

FIG. 17 illustrates a solar module installation tool in accordance with one example of the present disclosure.

FIG. 18 illustrates a flow chart for automatically aligning a solar module and at least one intermediate support structure.

FIG. 19 illustrates a bottom view of a solar module and a pair of intermediate support structures in accordance with one example of the present disclosure.

FIG. 20 illustrates a flow chart for automatically fastening a solar module to at least part of the ground structure.

FIG. 21 is a diagram of an exemplary computer system that may be utilized to implement methods described herein

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, installation of a solar module to a ground structure, such as a racking structure, may be both labor-intensive and time-intensive. This may be especially true when the racking structure includes one or more structural pieces. As one example, the racking structure may be composed of multiple structural pieces, such as: piles (or other type of ground-driven or ground-based structure) installed into the ground to provide foundational support; mechanical structure connected to the piles (e.g., for tracking the sun, a rotatable structure, such as torque tubes, may be configured to rotate the solar modules about an axis to enable the array to track the sun; for non-tracking structure, non-movable mechanical structure); and brackets, clamps, skeletal structures, mechanical links, or the like that are configured to connect the mechanical structure to the solar modules. Other types of racking structures are contemplated. Typically, the racking structure is built from the ground upward, with the piles installed first, after which, the mechanical structure is mechanically connected to the piles, with the brackets/clamps, etc. connected to the mechanical structure, and finally, the solar modules are connected to the brackets/clamps.

Thus, the process of installing the solar modules (either individually, in partial strings, or in full strings) is time intensive, subject to error, and prone to damaging the solar modules. In practice, the solar modules may be installed at the site in strings (e.g., at least 30 solar modules are both mechanically and electrically connected together in a single string), with multiple strings (such as at least 5 strings, at least 6 strings, at least 7 strings, etc.) connected together to a junction box.

In this regard, the step of connecting the solar modules to the ground structure (e.g., the bracket/clamps) may comprise: (i) aligning the solar modules with the ground structure (e.g., aligning opening(s) on the respective solar module with mating opening(s) on the ground structure); (ii) positioning fastener(s) into a predetermined orientation; (iii) inserting the fastener(s) in the predetermined orientation into the aligned solar modules (e.g., inserting pin(s) or the like into the aligned opening(s)); and (iv) performing at least one operation to affix the fastener (e.g., affixing a collar and/or swaging the fastener; torquing the rivet). Any one, any combination, or all of (i), (ii), (iii), or (iv) may be entirely automatic (e.g., without operator input) or partially automatic (e.g., with input from an operator). Further, (i) may comprise a predicate step to fastening (e.g., including performing any one, any combination, or all of moving the solar module toward the ground structure, positioning the solar module in predetermined relation to and/or in alignment with the ground structure and/or placing the solar module into physical contact (and aligned with) the ground structure). After (i), the fastening process may include any one, any combination, or all of (ii), (iii), or (iv).

Moreover, in one or some embodiments, all of (i), (ii), (iii), and (iv) are performed. Alternatively, less than all of (i), (ii), (iii), and (iv) are performed. For example, the fastener(s) may be pre-oriented in the predetermined orientation, thus obviating performing (ii). Moreover, (i), (ii), (iii), and (iv) need not be performed in the sequence as designated. For example, (ii) may be performed prior to (i), (iii), and (iv). Further, one or more devices may be used to perform (i), (ii), (iii), or (iv). As one example, a single device may be configured only to perform (ii). Alternatively, a single device may be configured to perform (ii) and (iii). Still alternatively, a single device may be configured to perform (ii), (iii), and (iv).

Thus, in one or some embodiments, the above processes may each be performed by different devices, as discussed in more detail below. For example, the automatic orientation may be performed by an automatic fastener(s) orientation module, the automatic feeding may be performed by an automatic feeding mechanism (e.g., a receptacle, tube, or the like), the automatic moving may be performed by an automatic solar module-ground structure alignment module (e.g., robotic system(s) or the like), and the automatically fixedly connecting may be performed by an automatic fastener(s) installation module. Alternatively, at least two of the processes may be performed by the same device (e.g., automatic orientation of the fastener(s), automatic feeding, and the automatic fixed connection of the fastener(s) may be performed by the same device, as discussed further below). Still alternatively, all four of the processes may be performed by the same device.

Further, in one or some embodiments, the system may include stationary device(s) and mobile device(s). In this regard, any one, any combination, or all of (i), (ii), (iii), and (iv) may be performed on the stationary device(s) and the remainder may be performed on the mobile device(s). Alternatively, the system may only include mobile device(s).

Thus, in one or some embodiments, automatically fastening of the solar module to the ground structure may be implemented as being in combination with the automatic movement of the solar module toward, in alignment with, and/or placement on the ground structure. The in combination implementation, which may be performed in one or more ways, may treat the automatic moving and the automatic fastening, not as discrete actions, but as interrelated. In particular, in combination may comprise any one, any combination, or all of: (A) using same perception system (e.g., using the same perception system hardware (e.g., camera); the same perception system software (e.g., algorithms to identify aspect(s) of any one, any combination, or all of: the solar module (e.g., its pose and/or position); the ground structure; or the already-placed solar modules on the ground structure)); (B) using same data (or same type of data) (e.g., data for performing the alignment of the holes on the solar module with the holes on the ground structure (such as 2D or 3D spatial data of the aligned holes)); or (C) using a perception system associated with the automatic fastening to perform the automatic moving and/or vice versa (e.g., the perception system associated with automatic fastening may generate data in order to perform any one, any combination, or all of: transporting the solar module to be in predetermined relation to the ground structure; aligning the solar module with the ground structure; or placing the solar module on the ground structure; the data from the perception system may be generated before automatically picking the solar module from a cradle or during transport of the solar module to the ground structure).

Thus, in one or some embodiments, in combination may include using a perception system associated with the automatic fastening for performing the automatically moving and/or vice versa. Generally speaking, a perception system may generate sensor data, which may then be analyzed in order to generate an output (e.g., identifying aspect(s) of an object, such as hole(s) in ground structure and/or hole(s) on a solar module; identifying relationship(s) between objects, such as a distance or delta between objects; identifying position of a part of an object (such as 2D or 3D position of hole(s) on an object). Such output may then be used for one or more tasks (e.g., hole(s) on the ground structure may be used to control the positioning system to move the solar module toward the ground structure; relationship(s) between objects or positions of objects may be used to control the positioning system (e.g., the positioning robot and/or the positioning stage) to align the solar module and ground structure).

In one particular instance, the perception system associated with the positioning system may be used to identify aspect(s) of the ground structure. For example, the perception system associated with the positioning system may generate sensor data of the ground structure. In turn, the sensor data may be analyzed in order to identify (e.g., in 2D or 3D space) a particular part in the ground structure, such as a clamp or torque tube, and/or an aspect of the particular part, such as holes in the clamp. In turn, the identified part and/or identified aspects may be used by the perception system associated with the fastening system. In particular, the perception system associated with the fastening system may, using the identified part and/or identified aspects, obtain its own sensor data, which may be more refined or focused on the identified part and/or identified aspects, thereby improving the identification of the parts and/or aspects (e.g., identify the hole(s) in the ground structure with more accuracy in 3D space). In turn, the identified parts and/or aspects may be used by the positioning system to move the solar module proximate to or in alignment with the ground structure.

In another particular instance, the perception system associated with fastening may generate sensor data of at least a part of the solar module and at least a part of the ground structure (e.g., an image showing both the solar module and ground structure) for moving/aligning the solar module with the ground structure. Specifically, the sensor data may be analyzed in order to generate alignment data, which in turn may be used to automatically move the solar module toward the ground structure (e.g., to be a predetermined distance from) and/or to be in alignment (or closer to alignment in an iterative system of alignment) with the ground structure. As one example, the perception system associated with the automatic fastening may generate an image of the solar module/ground structure. Thereafter, the image may be analyzed to generate the alignment data, which may comprise 2D or 3D data or a delta indicating misalignment. One or more systems may perform the analysis of the image, such the perception system associated with the automatic fastening or the perception system associated with the automatic moving (e.g., by transmitting the sensor data thereto).

In the instance where the perception system associated with the automatic fastening generates sensor data to automatically move the solar module in predetermined relation to the ground structure, after the solar module is moved into predetermined relation to the ground structure, the perception system associated with the automatic fastening may generate additional alignment data (such as iteratively generate the additional alignment data) in order to align the solar module with the ground structure (such as iteratively and automatically move the solar module into alignment with the ground structure).

As one example, the alignment data may comprise 2D or 3D data indicative of aspect(s) on the solar module (e.g., holes) and aspect(s) on the ground structure (e.g., holes, such as slots, on the ground structure). In practice, the perception system may compare the 2D or 3D data of the aspect(s) on the solar module and on the ground structure in order to identify a deviation (e.g., a distance between the hole(s) on the solar module and on the ground structure) in order to command the positioning system (e.g., the positioning robot and/or the positioning stage) in order to move the solar module in order to reduce the deviation. Such steps may be iteratively performed until the deviation is less and/or no greater than a predetermined amount. Once the perception system determines that the solar module is aligned with the ground structure, the fastening device may then use the positioning data (e.g., 2D or 3D data of the aligned holes) to control the fastening tool to perform the fastening (e.g., the fastening tool may be moved toward the aligned holes based on 2D or 3D data of the aligned holes in order to insert the fastener, swage, torque, etc.). In this regard, automatically moving the solar module into alignment with the ground structure and automatically fastening the solar module to the ground structure may use the same data (e.g., the 2D or 3D data of the aligned holes).

As another example, the alignment data may comprise a delta or a difference that is indicative of a distance between aspect(s) on the solar module (e.g., holes) and aspect(s) on the ground structure (e.g., holes, such as slots, on the ground structure). In practice, the perception system may command the positioning system (e.g., the positioning robot and/or the positioning stage) in order to move the solar module in order to reduce the delta. Such steps may be iteratively performed until the delta is less and/or no greater than a predetermined amount. Once the perception system determines that the solar module is aligned with the ground structure, the fastening device may then use the perception system associated with the fastener to generate positioning data (e.g., 2D or 3D data of the aligned holes) to control the fastening tool to perform the fastening (e.g., the fastening tool may be moved toward the aligned holes based on 2D or 3D data of the aligned holes in order to insert the fastener, swage, torque, etc.). Thus, in such an example, the same system (e.g., the perception system associated with the fastener) may be used for both automatically moving/aligning and automatically fastening.

Various perception systems are contemplated, including, by way of example, vision systems (e.g., computer vision systems), AI systems, or the like. Further, the perception system may be associated with the automatic fastening in one or more ways, such as physically (e.g., proximate to the hardware to perform the fastening (e.g., the fastening robot); on the same autonomous vehicle (e.g., in the instance where respective autonomous vehicles are used to perform the automatic moving and the automatic fastening)); or in communication with (e.g., data generated by the perception system is used by and/or routed through the controller for controlling the fastener robot). Different types of autonomous vehicles are contemplated, such as an autonomous vehicle with wheels, an autonomous vehicle with legs (e.g., a humanoid robot), or the like.

Moreover, in one or some embodiments, automatic fastener orientation into a predetermined orientation for the fastener may be paired with automatically installing the fastener in one or more ways. As one example, the automatic fastener orientation may be performed in one or more parts of the fastening process, including at: a central station that replenishes the fasteners in an automated vehicle that performs automatic fastening; an automated trailer that transports the fasteners to the automated vehicle; or the automated vehicle that performs the automatic fastening. In this regard, the automatic orienting of the fasteners (e.g., performed by a fastener orientation device) is integrated in a part of the automatic fastening process (whether in replenishing the fasteners or in performing the fastening). In one or some embodiments, the fastener orientation device may comprise: structure configured to automatically perform one or more movements to orient a respective fastener into the predetermined orientation (e.g., in order to orient fastener(s) into a predetermined orientation); and structure configured to maintain the predetermined orientation of the respective fastener during transport to an automatic insertion device (e.g., to place the oriented fastener(s) into a receptacle with the receptacle being in the automatic insertion device; using channels, tubes, or the like to route the oriented fastener(s) to the automatic insertion device). After which, the fastener(s) in the predetermined orientation may be placed in a structure (e.g., a receptacle) and/or moved to another device (e.g., an automatic fastener(s) installation module). Still after which, the automatically oriented fasteners may be automatically inserted within aligned holes (e.g., at least partly or entirely aligned holes), as discussed further below. Typically, the fasteners may be randomly dispersed within a box, resulting in random orientation of the fasteners. So that, for correct automatic insertion of the fastener within the aligned holes (e.g., at least partly or sufficiently aligned so that a fastener may be inserted therein), a predicate step is performed to position or place the fasteners in a predetermined orientation. Alternatively, the fasteners may already be in a predetermined orientation (such as at the manufacturing plant), thereby obviating the need for automatic orientation.

Various ways are contemplated for positioning or placing the fastener(s) into the predetermined orientation. In particular, movement on the fastener may result in positioning or placing the fastener(s) into the predetermined orientation. The movement may be a direct movement on the respective fastener. For example, a device, such as a robot, may directly move the fastener(s) into the predetermined orientation. Alternatively, or in addition, the movement may be an indirect movement on the respective fastener, such as the respective fastener placed on or within a device, with the device moving resulting in the indirect movement on the respective fastener. Regardless, the movement of the fastener(s) may result in the fastener(s) being placed into the predetermined orientation.

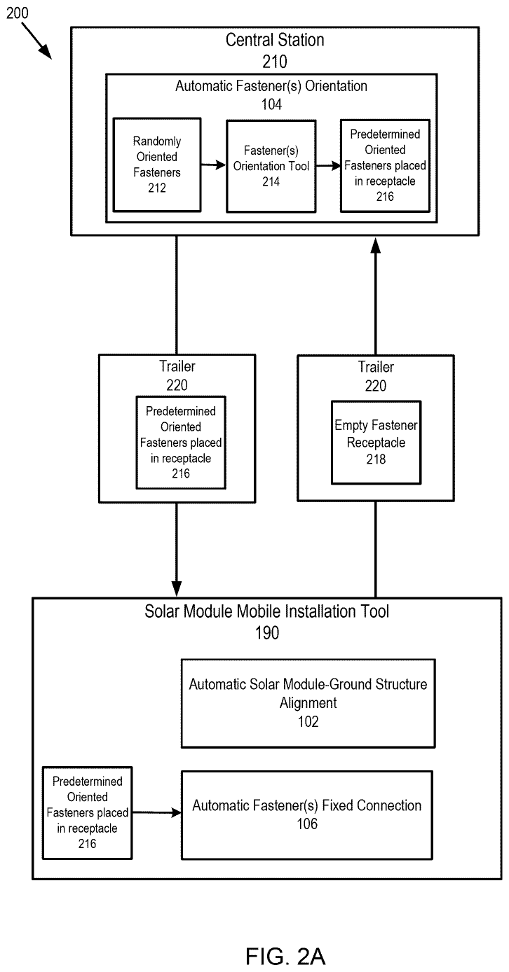

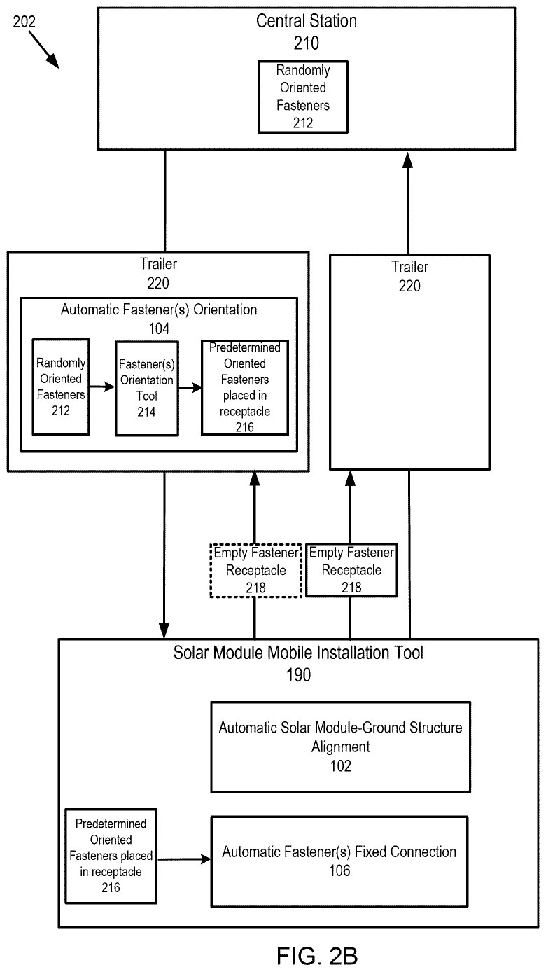

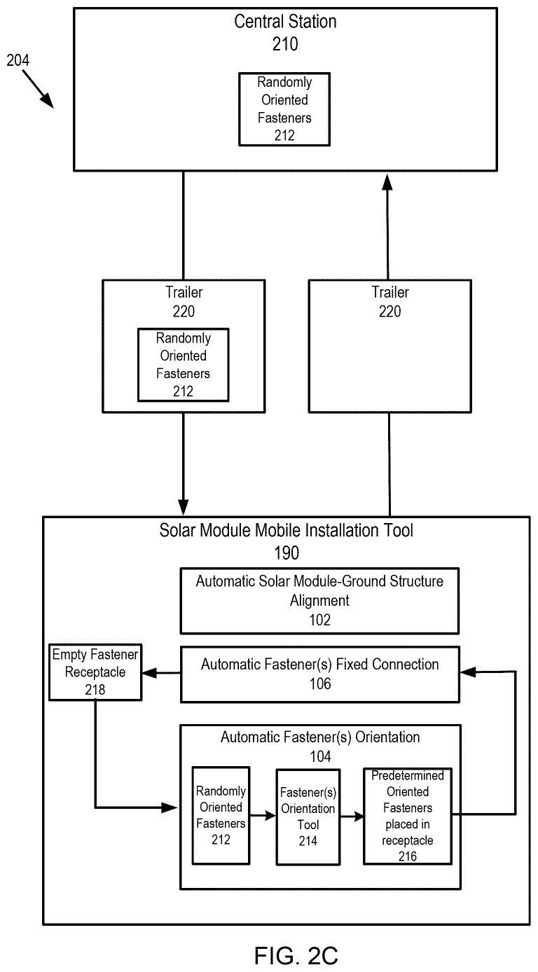

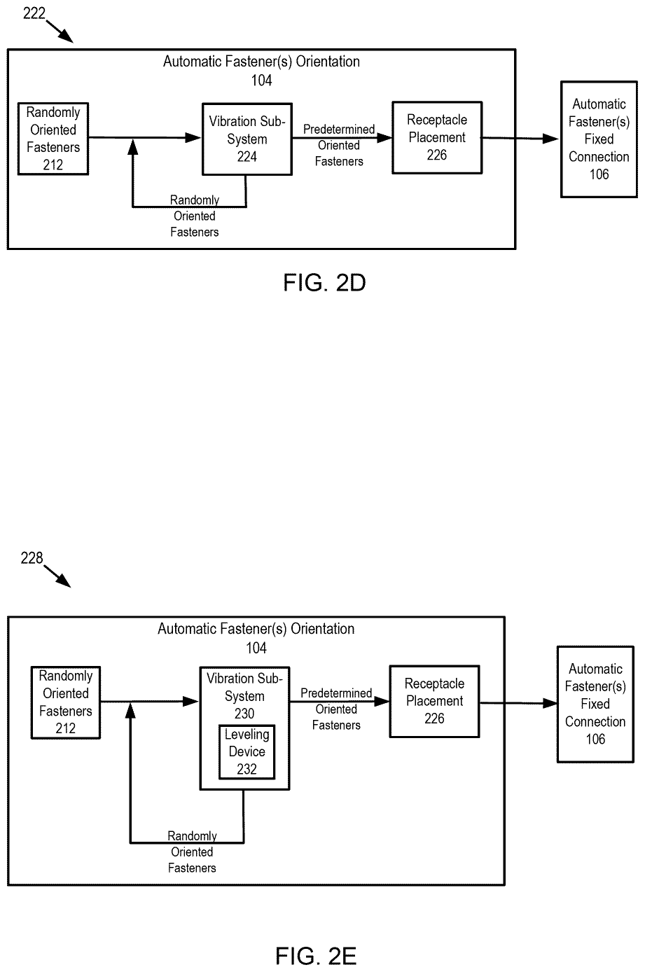

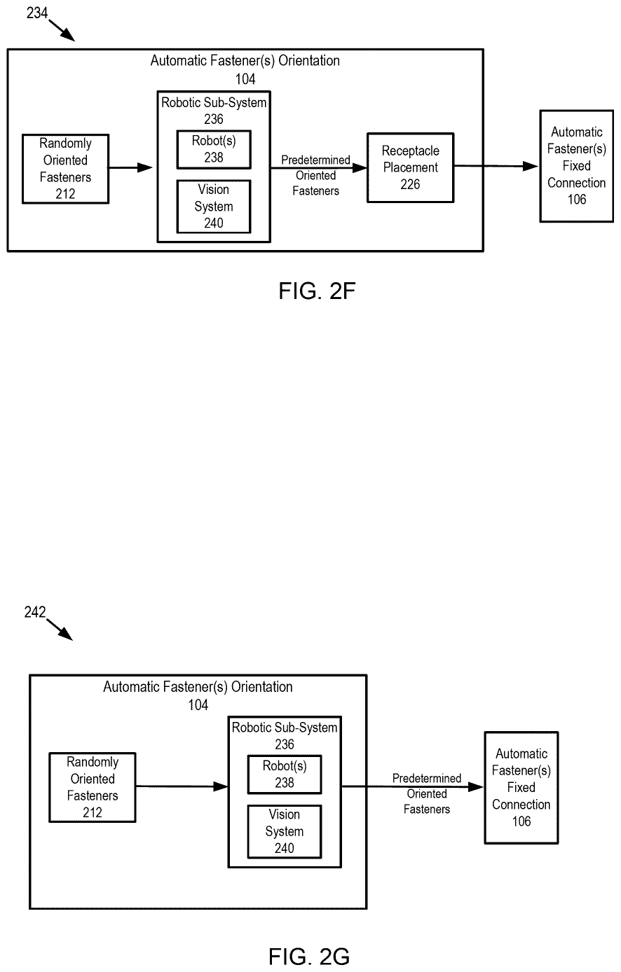

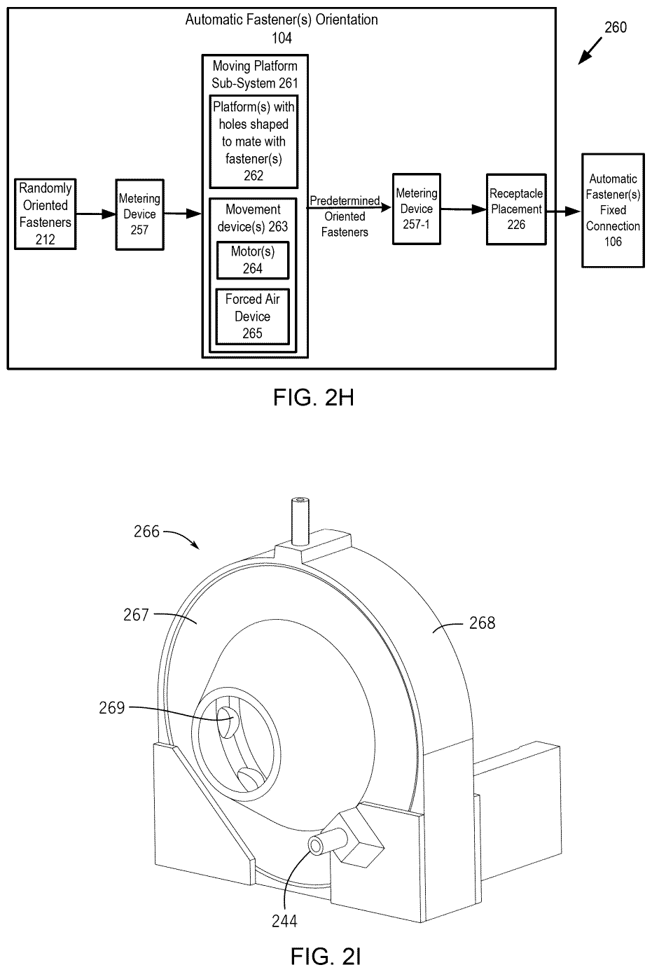

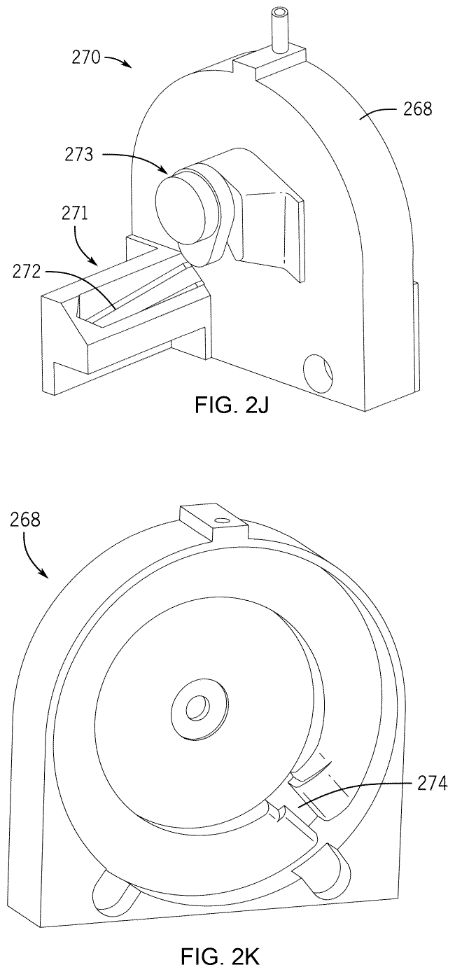

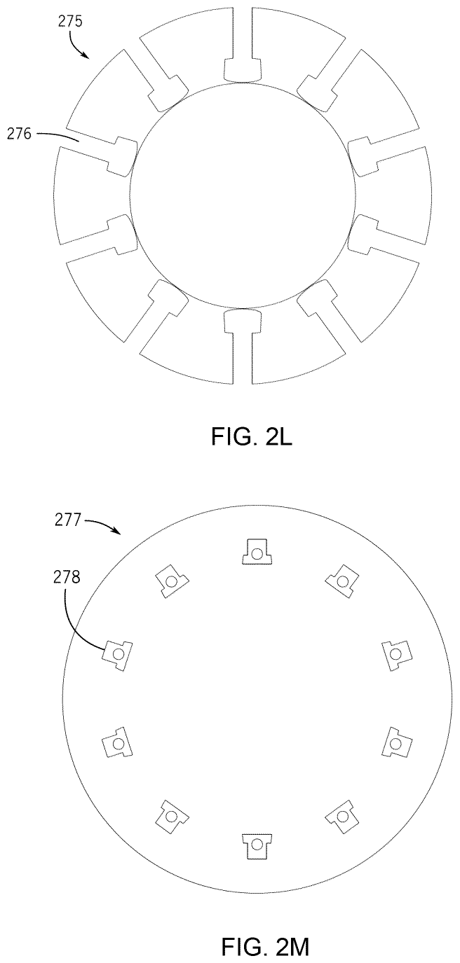

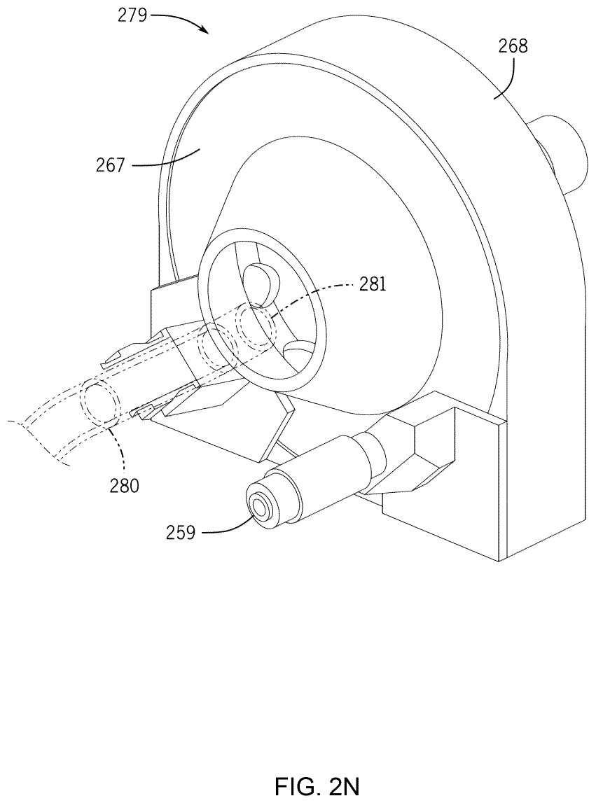

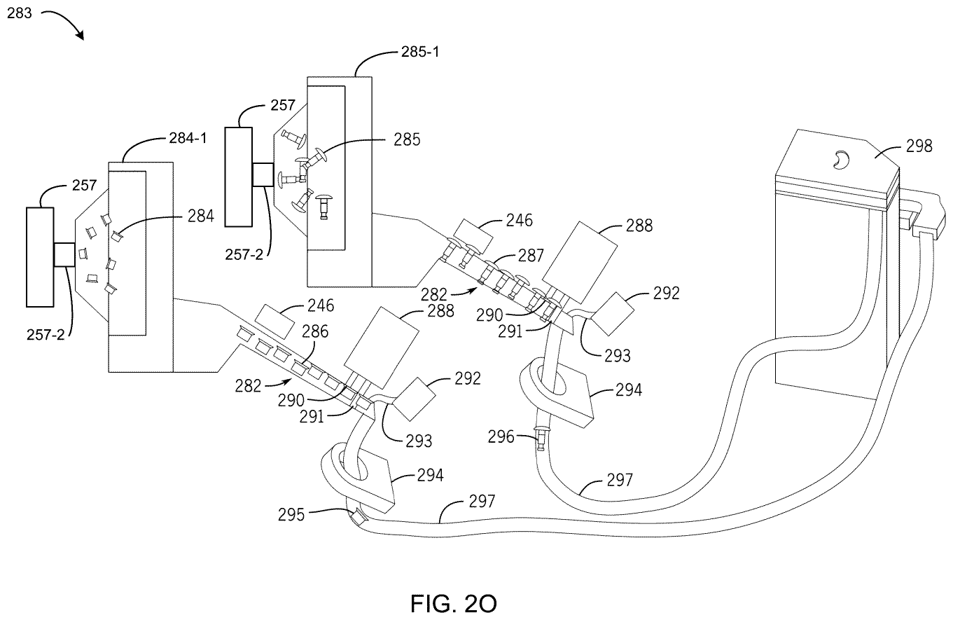

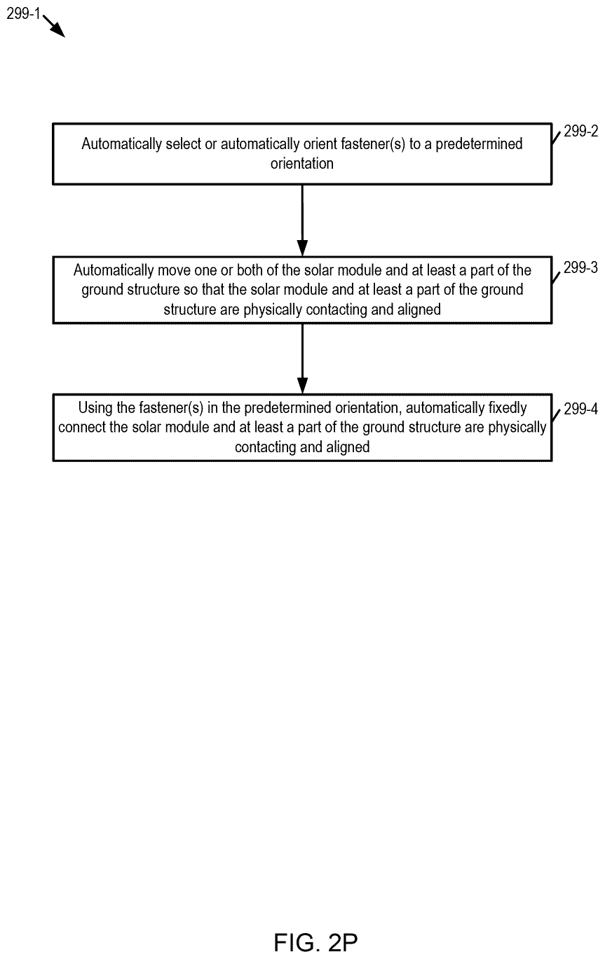

There are one or more triggers to position or place the fastener(s) into the predetermined orientation. In one or some embodiments, the trigger may be based on a number of fasteners that are in the predetermined orientation. For example, the fastener orientation device may have an output (e.g., an escapement) in which the fasteners in the predetermined orientation are stored (such as in a tube, an example of which is illustrated in FIG. 2O, or in a receptacle). Responsive to determining that the number of the fasteners in the predetermined orientation is less than a predetermined number (e.g., a sensor in the tube indicating the number of fasteners in the predetermined orientation; a sensor indicating the number of receptacles filled with fasteners in the predetermined orientation), the fastener orientation device may be triggered to produce more fasteners in the predetermined orientation.

As discussed herein, inserting the fastener may be difficult, particularly due to clearance space in the solar module. In this regard, automatic fastening, triggered by an indication that the solar module has been placed in alignment on the ground structure, may automatically route the fastener in a non-linear manner (e.g., along a curved path using 2D or 3D space data indicative of aligned holes on the solar module and the ground structure). The route of the fastener may thus follow a predetermined path (e.g., by analyzing indicia of the solar module and selecting, based on the indicia of the solar module, the predetermined path from a plurality of pre-stored predetermined paths; or by dynamically or in real-time analyzing clearance of the solar module in order to dynamically determine the predetermined path).

Thus, in one or some embodiments, the movement of the fastener(s) may be any one, any combination, or all of: rotational; vertical; lateral; or vibrational. Further, one or more structures may be used in order to work in conjunction with the movement of the fastener(s) to thereby result in the predetermined orientation of the fastener(s). As one example, the fastener(s) and/or a structure may be rotated in order to position the fastener(s) into the predetermined orientation. As another example, the fastener(s) and/or a structure may be subject to vibration or lateral movement in order to position the fastener(s) into the predetermined orientation.

Moreover, one example structure may include a respective hole that is shaped to mate with a respective fastener so that the respective fastener is at least partly inserted within, is entirely inserted within, or entirely passes through the respective hole. In particular, in one or some embodiments, one or more structures may be used for positioning or placing the fastener(s) into the predetermined orientation, including one or both of: non-movable structure(s) that include at least one hole (e.g., slot, crevice, or the like) shaped so that the respective fastener is at least partly inserted within, is entirely inserted within, or entirely passes through the respective hole; or movable structure(s) that include at least one hole shaped so that the respective fastener is at least partly inserted within, is entirely inserted within, or entirely passes through the respective hole. For example, the structures may comprise a drum (that is rotated) and a drum holder (that is stationary). The fastener(s) may be placed within the drum, and may rotate as the drum is rotated. In the rotational movement, a respective fastener is moved, and as part of the movement, is inserted within a respective slot or crevice in the drum so that the respective fastener, at least partly held within the slot or crevice, is in a predetermined orientation. Further, as the drum is rotated, the respective slot will come into alignment with a respective exit slot in the drum holder. As such, when a respective slot in the drum moves to and is aligned with the respective exit slot in the drum holder with the respective exit slot in the drum holder effectively mating with the respective slot on the rotating drum), the respective fastener (held in the predetermined orientation within the respective slot in the drum) may exit the respective slot in the drum and through the respective exit slot in the drum holder (and in turn conveying the predetermined oriented fasteners to the automatic insertion mechanism, such as either directly or into a receptacle).

Furthermore, in one or some embodiments, after positioning the fasteners into the predetermined orientation, the fasteners are then conveyed or fed to the automatic insertion mechanism. Various ways of conveying the fasteners in the predetermined orientation are contemplated, such as one or both of: feeding the predetermined-oriented fasteners directly to the automatic insertion mechanism (e.g., via a tube, pipe, chain, conveyor belt, bench or the like); or compiling a plurality of predetermined-oriented fasteners into a receptacle and conveying the receptacle to the automatic insertion mechanism (e.g., inserting the predetermined-oriented fasteners into a magazine, and conveying the magazine to the automatic insertion mechanism).

As discussed above, the solar module and the ground structure (e.g., the clamps/brackets) may be brought into alignment prior to insertion of fasteners. In one or some embodiments, automatically moving one or both of the solar module or a part of the ground structure so that the solar module and the part of the ground structure are physically contacting/aligned may comprise any one, any combination, or all of: (i) selecting a respective solar module from a stack or collection of solar modules (e.g., a stack of solar modules in a cradle, discussed further below); (ii) using vision (such as computer vision and/or mechanical vision) to identify one or more aspects of the solar modules or the ground structure (interchangeably termed supporting structure); or (iii) moving one or both of the respective solar module and the respective ground structure relative to one another (e.g., an intermediate supporting structure, discussed further below) so that the respective solar module and the respective ground structure are at least partly in alignment (e.g., one or more holes on the respective solar module is aligned with corresponding one or more holes on the respective ground structure). In one or some embodiments, the automatically moving is performed after connecting the respective ground structure with additional structures connected to the ground (e.g., connecting clamps, rails, or other ground structure to torque tubes) so that the automatic movement comprises placement of the respective solar module in its final position.

In one or some embodiments, automatically fixedly connecting the solar module and the part of the ground structure together may comprise (after alignment) mechanically connecting the respective solar module and the respective ground structure together (e.g., using one or more fasteners and/or performing one or more actions in order to perform the mechanical connection of the respective solar module and the respective ground structure, such as inserting at least one fastener into aligned holes of the respective solar module and the respective ground structure);

Various hardware and software are contemplated to perform any one, any combination, or all of: the automatic predetermined orientation of the fasteners; the automatic movement for physical contact/alignment of the solar module/ground structure; or the automatic fixed attachment of the solar module/ground structure. As discussed above, in one or some embodiments, automatic predetermined orientation of the fasteners system may be performed by a movement device, such as a rotational drum, a vibration device, or the like and/or a robotic device, as discussed further below. In one or some embodiments, automatic fixed attachment of the solar module/ground structure may be performed by one or more robotic devices, as discussed further below.

In one or some embodiments, the automatic movement for physical contact/alignment of the solar module/ground structure may be performed by a solar module movement system, which may be configured to move one or both of the respective solar module and the respective ground structure to physically contact one another. The solar module movement system may be manifested in several ways, and may comprise one or more devices, such as any one, any combination, or all of: robotic system(s); motor(s); controller(s); perception system (such as visual perception system in order to provide positional information to the controller(s)); or the like. As discussed in more detail below, perception system(s) may include vision system(s), such as camera(s), sensor(s), LIDAR system(s), or the like. In this regard, any discussion herein regarding vision systems or cameras may be generally applied to any type of perception system. Further, the respective solar module and the respective ground structure may be mechanically connected at one or more times or stages in the process including any one, any combination, or all of: (1) when the respective solar module is selected from the cradle (but still proximate to the cradle (e.g., structure on the cradle is used for the mechanical connection)); (2) after the respective solar module is selected from the cradle and is withdrawn from the cradle (e.g., structure not associated with the cradle is used for the mechanical connection); or (3) after the respective solar module is physically placed on the respective ground structure (which is already mechanically connected to the additional structures (e.g., the clamps, as the ground structure, are already mechanically connected to the torque tubes, which are connected to the piles inserted into the ground)). Thus, depending on when the mechanical connection is performed, such as whether at (1), (2), or (3), the steps of (i)-(iii) may be in a different order, may be combined, and/or may be skipped.

As one example, for (1) in which the mechanical connection to the respective ground structure is performed when the respective solar module is selected from the cradle, the sequence may comprise: (i) selecting a respective solar module from the stack; (ii) moving one or both of the respective solar module and the respective ground structure relative to one another for alignment; (iii) after alignment, mechanically connecting the respective solar module and the respective ground structure together; (v) placing the respective solar module (with the respective ground structure) in its final position; and (iv) connecting the respective ground structure with the additional structures connected to ground (e.g., the clamp, already connected to the solar module, is then connected to the torque tubes).

As another example, for (3) in which the respective solar module is first placed on top of the respective ground structure (which is already connected to the underlying structure), the sequence may comprise: (iv) connecting the respective ground structure (e.g., the clamps) with the additional structures connected to the ground (e.g., the torque tubes); (i) selecting the respective solar module from a stack (e.g., a stack of solar modules in the cradle); (v) placing/aligning the respective solar module onto the ground structure; and (iii) mechanically connecting the respective solar module and the respective ground structure together.

In this regard, the tooling may be flexible in one or more ways, including any one, any combination, or all of: the type(s) of installations; the type(s) of hardware being installed (e.g., different types of fasteners; different types of ground structure (e.g., clamps, rails, skeletons, sun-tracking structure, non-sun-tracking structure); different orientations of fasteners; the types of solar modules being installed (e.g., the amount of clearance in the frame of the solar module that may be used to guide the fastener into the aligned hole)); or the automatic and/or manual nature of installation.

As one example, the tooling to perform the solar module installation may be configurable for one or more types of installations, including (1), (2), or (3), and may likewise be configurable for different sequences to accommodate the one or more types of installations. Merely by way of example, the tooling may be applied to the following first scenario: the site team may install all structures before beginning the solar module installation, which may mean working from the ground upward. In a second scenario, solar module installation may be performed in the context of a pop-up factory, wherein a factory facility is set up on-site and whereby module installation is performed. In such a scenario, the site team need only install the lowest level structure (e.g., the piles), and the pop-up factory may assemble the mid-level (e.g., the torque tubes and clamps/rails) and solar modules. In one particular implementation, the pop-up factory may install the clamps/rails onto the torque tube, then the solar modules onto the clamps/rails, and thereafter drive or connect the torque tube (with several solar modules already attached thereto) to the lower-level structure (e.g., the piles). Further, the tooling may be sufficiently flexible for installation with different types of structures, such as sun-tracking structures or fixed structures (e.g., those structures that do not track the sun).

As another example, the tooling to perform the solar module installation may be configurable for fully automatic operation or partial automatic/partial manual operation. In particular, in one or some embodiments, the process of installing the solar modules may be entirely automatically performed. For example, all of steps discussed above may be automatically performed. Alternatively, the process of installing the solar modules may be at least partly automatically performed and at least partly manually performed. Merely by way of example (and discussed further below), the ground structure and the solar module may be mechanically connected in one of several ways, such as by using one or more fasteners (e.g., pin(s) and collar(s), rivets, bolts, nuts, etc.) and/or performing one or more operations (e.g., performing any one, any combination, or all of: inserting a respective rivet or pin into an aligned hole; attaching a respective collar to the respective pin that is in the aligned hole; torquing the respective rivet or swaging the respective pin in the aligned hole; or swaging the respective collar after attachment to the respective pin). In one particular example, the pin(s) or rivet(s), as the first fastener, may be fed or inserted into aligned hole(s) of the ground structure and solar module (e.g., holes on the solar module aligned with slots on the ground structure) so that the fastener(s) are entirely seated within the aligned hole(s). After which, another action (e.g., swaging and/or connecting collar(s); torquing) may be performed in order to permanently affix the fastener. As one example, the collar(s), as the second fastener, may be automatically contacted to the pin(s) so that the fastener(s) are fixedly connected by one or both of: the collar(s) being screwed onto the inserted pin(s); or the collar(s) being swaged after being screwed onto the inserted pin(s). As another example, the rivet may be torqued after insertion as the action to affix the rivet.

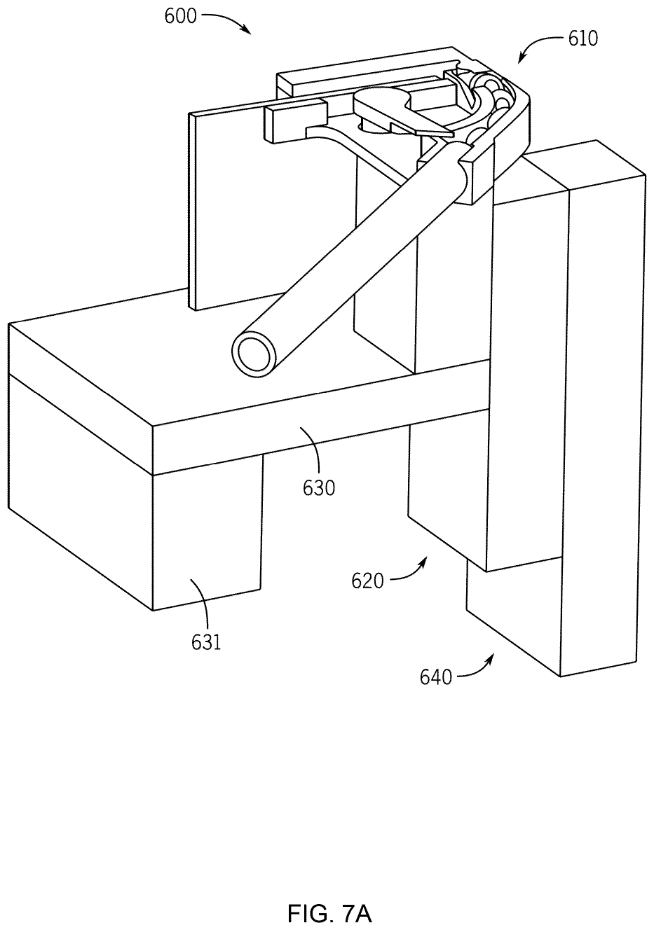

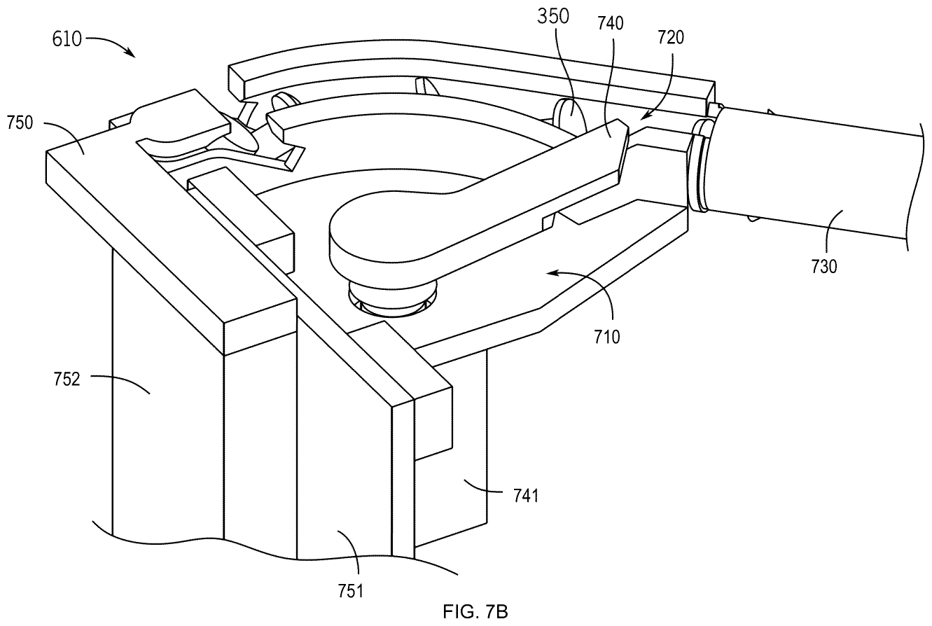

In one or some embodiments, the pins may be inserted downward, with the collar(s) contacting and/or swaging being performed from below. This is illustrated, for example, in FIGS. 7A-B and 8A-B. As discussed in more detail below, the solar module may have limited clearance to insert the fastener from above. To accommodate this, the tool(s) to insert the fastener from above may work within the limited clearance (e.g., within a C-shaped space in the frame of the solar module). Alternatively, the pins may be inserted upward with the collar(s) contacting and/or swaging being performed from above. In this regard, the tool(s) for inserting the collar and/or swaging likewise may move in a confined space or limited clearance within the frame of the solar module.

Alternatively, rivets, such as blind rivets, may be used as fasteners, and installed by using riveting tool(s). For example, the riveting tool(s) may insert the rivet into aligned holes/slots and pull the mandrel (e.g., using a tool to apply a clamping force), which may expand the body and snaps the stem (e.g., thereby creating a permanent joint from one side). In one or some embodiments, the rivets may be inserted from below (effectively inserted upward). Conversely, the rivet(s) may be inserted from above. When inserted from above, similar to inserting pins or collars from above, the riveting tool(s) may move in a confined space or limited clearance within the frame of the solar module.

In one or some embodiments, prior to use of the fasteners to connect the solar module to the ground structure, a predicate step of aligning one, some, or all of the fasteners may be performed. By way of example, prior to inserting the respective pin into the aligned hole and/or prior to using the respective collar to connect to the respective pin, the respective pin and/or respective collar may be mechanically positioned into the predetermined orientation, as discussed above. In another particular example, the rivet(s), as the only fastener, may be fed or inserted into the aligned hole(s) of the ground structure and solar module.

In one or some embodiments, the entire process, including insertions of all of the fasteners, such as all rivets into the aligned holes, all pin(s) into the aligned holes, all collar(s) being screwed onto the inserted pin(s), and all swaging of the screwed collar(s), is automatically performed. Alternatively, one or more operations for mechanically connecting the pin(s)/collar(s) and/or swaging may be manually performed. As one example, part or all of the functions performed by the fastener(s) orientation/installation 154 (such as fastener installation 178) may be manifested in a hand-held tool. In particular, the operator may position the hand-held tool at the aligned holes and activate button(s) in order to fasten the solar module to the ground structure (e.g., insert the pin, attach the collar, and/or swage; insert the rivet and pull the mandrel). As such, in one or some embodiments, the hand-held tool may be positioned and/or triggered manually. Still alternatively, or in addition, within a respective operation, part of the operation may be automatically performed and the other part of the operation may be manually performed. Again, by way of example, an entire operation (e.g., swaging) may be manually performed. Alternatively, part of an operation (e.g., swaging only some collar(s); inserting one or more pins/connecting one or more collars) is automatically performed, and the remaining part of the operation (e.g., swaging the remainder of the collars; inserting the remaining pins/connecting remaining collars) is manually performed. Thus, in one or some embodiments, the automatic tooling may perform the automatic operations, and then automatically move away for personnel to later perform the manual actions.

As still another example, the tooling may be configurable for different type(s) of hardware being installed. In particular, various types and various numbers of mechanical connectors or mechanical fasteners are contemplated. As one example, discussed further below, the mechanical fastener may comprise pins/collars. Moreover, various types of mechanical connecting action(s) may be performed (e.g., swaging, torquing, etc.). Thus, in one or some embodiments, different numbers of mechanical connectors to connect the ground structure to the solar module are contemplated (e.g., only 1 pin/collar combination; at least two pin/collar combinations; etc.). Thus, the tooling may be configurable in one or more ways.

As discussed above, one or both of vision of or alignment of the solar module and/or the ground structure (e.g., the intermediate support structure) may be performed. In particular, in one or some embodiments, one or more types of vision of aspect(s) of the solar module and/or the ground structure may be performed. Various aspects are contemplated including one or both of: a position (e.g., absolute position in 2D space or 3D space; relative position in 2D space or 3D space); or one or more features (e.g., hole(s) on the intermediate support structure or on the solar module).

In a first embodiment, vision may comprise computer vision, which may comprise acquiring sensor data (e.g., camera data) and analyzing the sensor data in order to determine the aspect(s) of the solar module and/or the ground structure. In a second embodiment, vision may comprise mechanical vision in which a mechanical structure may be used to determine the aspect(s) of the solar module and/or the ground structure. In a third embodiment, vision may comprise multiple types of vision working in combination. As one example, computer vision and mechanical vision may work in combination in order to determine the aspect(s) of the solar module and/or the ground structure. In a particular example, computer vision may first be performed; after which, and based on the analysis of the computer vision, the mechanical vision may be performed. As discussed in more detail below, the computer vision may provide at least a first predetermined specificity of the aspect(s) of the solar module and/or the ground structure (e.g., at least within a first predetermined distance; at least a first predetermined percentage accuracy; etc.). After which, and using the first predetermined specificity of the aspect(s) with the computer vision, the mechanical vision may provide at least a second predetermined specificity of the aspect(s) of the solar module and/or the ground structure, with the second predetermined specificity being greater or more accurate than the first predetermined specificity. In this regard, the two-stage vision process may improve the accuracy identifying the aspect(s) of the solar module and/or the ground structure.

As discussed above, the computer vision may comprise analyzing camera data (or the like) in order to determine the aspect(s) of the solar module and/or the ground structure. In one or some embodiments, the mechanical vision may use one or more mechanical structures to physically contact the solar module and/or the ground structure in order to identify the aspect(s) of the solar module and/or the ground structure. As one example, the mechanical structure may physically contact the ground structure, thereby providing positioning data for the supporting structure.

Various types of physical contact (in which the mechanical structure(s) physically contact the solar module or the ground structure) are contemplated. As a general matter, the mechanical structure(s) and the solar module or the ground structure move relative to one another resulting in the physical contact (e.g., the solar module or the ground structure is stationary and the mechanical structure(s) move to make the physical contact; the mechanical structure(s) remain stationary and the solar module or the ground structure move to make the physical contact; or both the mechanical structure(s) and the solar module or the ground structure move to make the physical contact). Separate from the relative movement, in making the physical contact, one or both of the mechanical structure(s) or the solar module/ground structure may move. As one example, in making the physical contact, one of the mechanical structure(s) or the solar module/ground structure are rigid, and the other of the mechanical structure(s) or the solar module/ground structure are movable. In one particular example, the ground structure is rigid and immovable. The mechanical structure(s) may move toward and physically contact the support structure, and may be flexible enough to move in any dimension (x-dimension, y-dimension, z-dimension, and/or rotationally) so that upon physical contact, the mechanical structure(s) physically contact the rigid ground structure. In another particular example, the solar module, being held by a device which may move in one or more dimensions, may move responsive to the mechanical structure(s) physically contacting the solar module. Effectively, the solar module moves to conform to the position of the mechanical structure(s) upon contact. As another example, in making the physical contact, both the mechanical structure(s) and the solar module/ground structure are movable. Again, the physical contact of the mechanical structure(s) with the solar module and/or the ground structure identifies one or more aspect(s).

In one or some embodiments, vision may work in combination with alignment. As one example, vision may be a predicate step for a later alignment of the solar module with the ground structure. In one or some embodiments, vision and alignment are separate from each other (e.g., vision is first performed; after which, alignment is performed). For example, computer vision may first be performed, identifying one or both of the solar module or the ground structure in 3D space. After which, and using the 3D space information of one or both of the solar module or the ground structure, the solar module and the ground structure may physically contact in alignment. Alternatively, vision and alignment are at least partly interrelated (e.g., interrelated in space and/or in time). As one example, vision and alignment may be at least partly interrelated in space in that the same mechanical structure(s) may be used to perform vision as to perform the alignment. As another example, vision and alignment may be at least partly related in time in that vision and alignment are performed at least partly simultaneously (e.g., using the same mechanical structure(s)). In one particular example, the mechanical structure may be used to interface with the ground structure (thereby providing position information for the ground structure). This position information may thereafter be used in order to position (in alignment) the solar module onto the ground structure. In another particular example, the mechanical structure, in physically interacting with the solar module, may be used to at least partly simultaneously identify the position of and align the position of the solar module, as discussed in more detail below.

Regardless of the automatic movement for physical contact of the solar module and the at least a part of the ground structure, the controlled movement results in the physical contact that aligns the solar module and the at least a part of the ground structure (e.g., aligns respective holes on the frame of the solar module and the intermediate support structure). After alignment, the solar module and the ground structure may be automatically connected to one another, such as by inserting at least one fastener (e.g., a pin, a rivet, or the like) into the aligned holes. However, insertion may be difficult, particularly with: (A) solar modules that have limited clearance so that the at least one fastener cannot simply be vertically dropped into the aligned hole; and (B) the fasteners may need to be positioned into the predetermined orientation prior to insertion into the aligned hole. As such, the at least one fastener may first be aligned into the predetermined orientation. After which, the at least one fastener may be inserted.

In one or some embodiments, the fastener may be inserted at least partly at an angle (e.g., such that the at least one fastener follows an at least partly horizontal trajectory and an at least vertical trajectory, which falls within the limited clearance of the solar module). In this regard, the fastener may follow a predetermined trajectory. In one or some embodiments, the predetermined trajectory may be determined based on one or more aspects of the solar module subject to installation. As one example, indicia for the solar module (e.g., make and model; serial number; etc.) may be scanned (such as automatically scanned) in order to access in a look-up table the predetermined trajectory correlated to the indicia. Alternatively, the predetermined trajectory may be determined based on dynamic scanning of at least a part of the solar module subject to installation. As one example, the clearance of the solar module may be scanned in order to dynamically determine the predetermined trajectory of the fastener in order to accommodate the clearance.

In order for the fastener to follow the predetermined trajectory, at least one mechanical structure and at least one motive force (under control of a controller) may work in combination to insert the fastener into the aligned hole. More specifically, the insertion fastener system may include: at least one mechanical structure configured to physically contact the fastener at least partly along a path from a fastener receptacle to insertion of the fastener into the aligned holes; at least one automatically controlled motive force device configured to automatically apply force on the fastener at least partly along the path; and at least one controller.

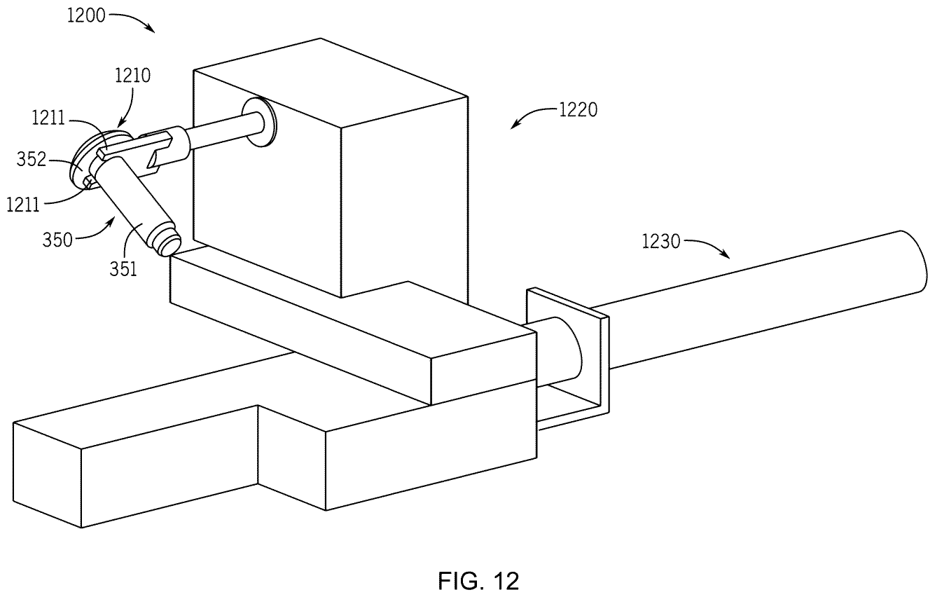

Various types of mechanical structures are contemplated. In one or some embodiments, a fixed or non-movable mechanical structure may be used (e.g., a tube, track, or the like, discussed further below). Alternatively, or in addition, a movable mechanical structure may be used (e.g., a gripper). See FIG. 12. Further, various types of motive force are contemplated. As one example, at least one robotic system may be used in combination with the mechanical structure (e.g., the gripper) in order to automatically move the fastener. As another example, at least one electric motive device (e.g., an electric motor), at least one pneumatic motive device (e.g., a pneumatic motor) and/or at least one hydraulic motive device (e.g., a hydraulic motor) may be used. In this way, the fastener may be guided into at least a part of the ground structure (e.g., aligned holes of the solar module/ground structure) even in limited space (e.g., within the C-shaped frame of the solar module).

Regardless, the automatically controlled motive force device configured to automatically apply force on the fastener at least partly along the path of the fastener. In one particular example, the path of the fastener may comprise any one, any combination, or all of: (i) removal of the fastener from a fastener receptacle (e.g., a magazine of predetermined oriented fasteners, a strip of predetermined oriented fasteners, or the like); after removal; (ii) movement of the fastener up until insertion in the aligned holes; or (iii) insertion of the fastener in the aligned holes (e.g., partial insertion into the aligned holes and/or complete insertion into the aligned holes.

In embodiments using a fixed or non-movable mechanical structure (e.g., a tube, track, etc.), the force applied may comprise any one, any combination, or all of: (A) a force applied to remove the fastener from the fastener receptacle; (B) a force applied in order to insert the fastener into the fixed or non-movable mechanical structure (e.g., into one end of the tube or track); or (C) a force in order to partially or fully insert the fastener into the aligned hole (e.g., gravity and/or a previously applied force in inserting the fastener into the tube or track may be used to partially insert the fastener into the aligned hole, after which, a separately applied force fully inserts the fastener entirely into the aligned hole; one or more forces are applied in order to partially and/or fully insert the fastener into the aligned hole). In one or some embodiments, each of (A), (B), and (C) may be performed by the same device. Alternatively, any one or any two of (A), (B), or (C) may be performed by different devices. Still alternatively, separate forces may perform each of (A), (B), and (C). Or, alternatively, a single force applied may accomplish any two or all three of (A), (B), or (C) (e.g., a single force may be used to remove the fastener from the fastener receptacle and insert the fastener into the tube or track).

In embodiments using a movable mechanical structure (e.g., a gripper, a cam), the force applied may comprise any one, any combination, or all of: (D) a force applied to remove the fastener from the fastener receptacle; (E) a force applied in order to move the fastener proximate to (e.g., a predetermined distance from) the aligned holes or contacting the aligned holes: or (F) a force in order to partially or fully insert the fastener into the aligned hole (e.g., the gripper may release the fastener so that gravity results in the fastener being inserted partially or entirely into the aligned holes; the gripper, in combination with the at least one robotic system, applies force in order to insert the fastener at least partially or entirely into the aligned hole). In one or some embodiments, each of (D), (E), and (F) may be performed by the same device. For example, the at least one robotic system in combination with the gripper may perform each of (D), (E), and (F). Alternatively, any one or any two of (D), (E), or (F) may be performed by different devices. Still alternatively, separate forces may perform each of (D), (E), and (F). Or, alternatively, a single force applied may accomplish any two or all three of (D), (E), or (F).

Thus, in one or some embodiments, the mechanical structure and the automatically controlled motive force, under control of the controller, may result in the fastener following a single predetermined trajectory or a single predetermined motion profile (alternatively termed a motion control profile) (e.g., that is at least partly horizontal and at least partly vertical). Alternatively, depending on one or more factors, the mechanical structure and the automatically controlled motive force, under control of the controller, may result in the fastener following one predetermined trajectory (that is selected from a plurality of potential predetermined trajectories) or one predetermined motion profile (that is selected from a plurality of potential predetermined motion profiles). As such, based on the one or more factors, the controller may select the predetermined trajectory/motion profile from the plurality available. Merely by way of example, different solar modules may have different amount of clearance in which to guide the fastener therein to the aligned hole. As such, one type of solar module that has less clearance may have a different predetermined trajectory/motion profile than another type of solar module with greater clearance. In either instance, the predetermined trajectory/motion profile may follow a predetermined path or trajectory in 2D or 3D space (e.g., depending on the frame profile of the solar module). In one example, the predetermined trajectory/motion profile may have two distinct motions including: an entirely horizontal motion to move the pin over the aligned hole; and followed by an entirely vertical motion to insert the pin into the aligned holes. In another example, where the clearance of the pin within the solar module is less, the predetermined trajectory/motion profile may have either discrete horizontal and vertical movements or may follow a curve whereby the motion begins with a greater horizontal motion versus vertical motion and transitions to a greater vertical motion versus horizontal motion until the pin is inserted into the aligned holes.

In one or some embodiments, the controller may determine an indication of clearance of the fastener into the aligned hole, and select, based on the indication of clearance of the fastener into the aligned hole, a respective predetermined trajectory/predetermined motion profile (from a plurality of potentially available). For example, the frame of a solar module may be C-shaped, with clearance defined by the C-shape. Various indications of clearance are contemplated. As one example, the indication of clearance may comprise a make and/or a model of the solar module subject to installation. In practice, a user may input the make and/or model of the solar module, based on the make and/or model, the controller may select the respective motion profile for installation (e.g., a look-up table may correlate makes and/or models with respective motion profiles). As another example, a user or an operator may input, via a touchscreen, the indication of clearance. Again, based on the indication of the amount of clearance, the controller may use a look-up table that correlates the amount of clearance with respective motion profiles. As still another example, the perception system, such as the vision system, discussed herein, may automatically analyze the amount of clearance. Regardless, in one or some embodiments, a determination of the indication of clearance may be performed, and based on such determination, a selection of the respective motion profile may be made. In this regard, the ability to have different predetermined trajectories/motion profiles enables the tooling to be flexible for different types of solar modules installed.

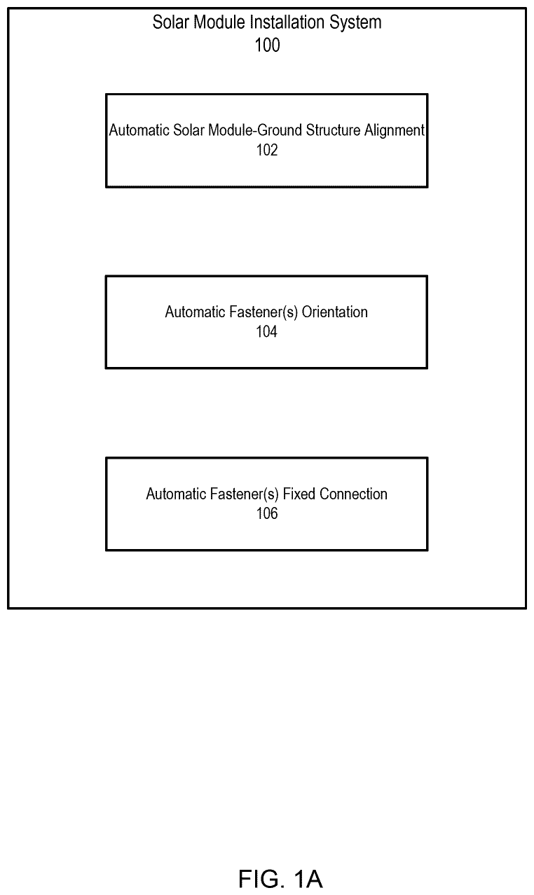

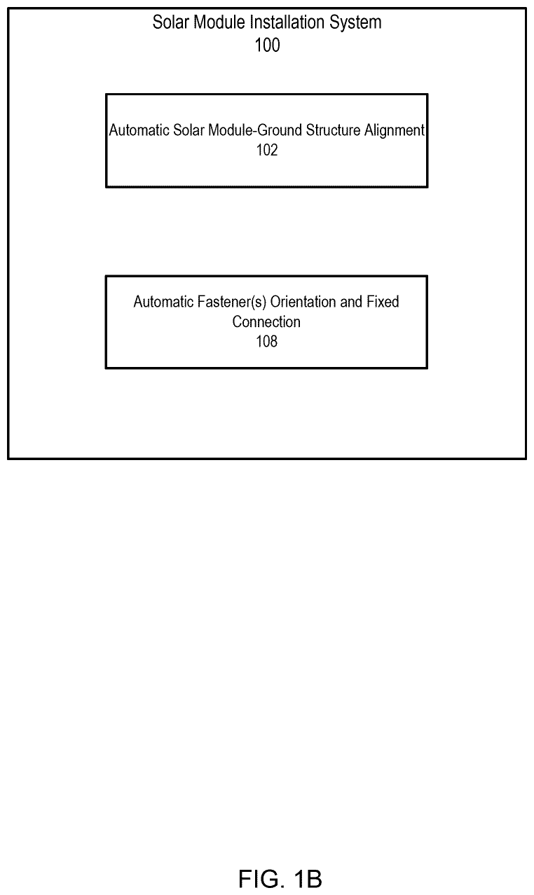

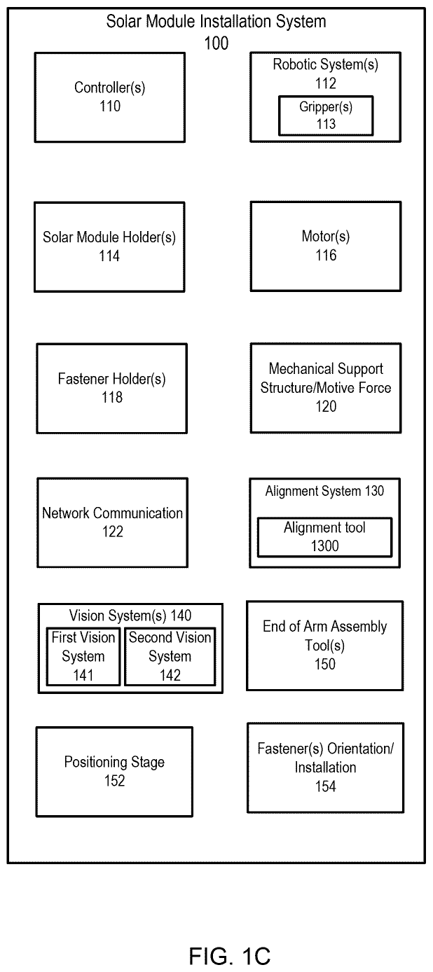

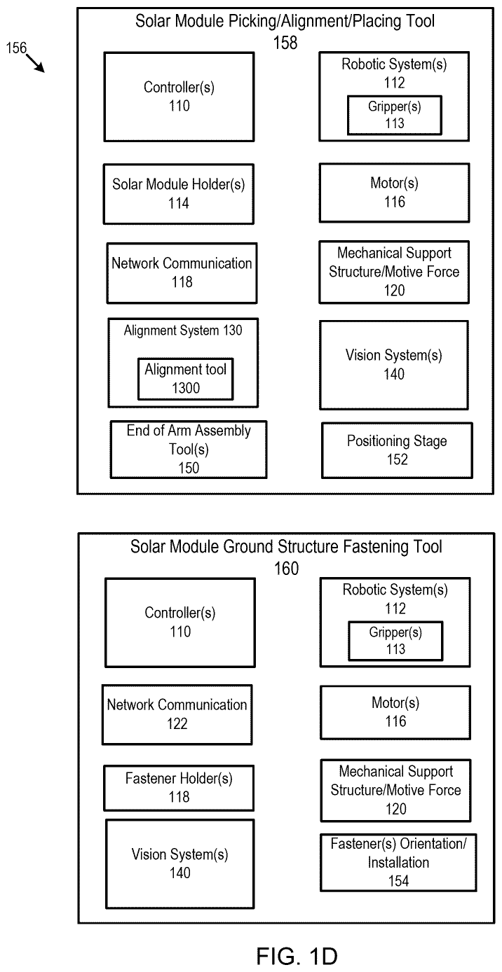

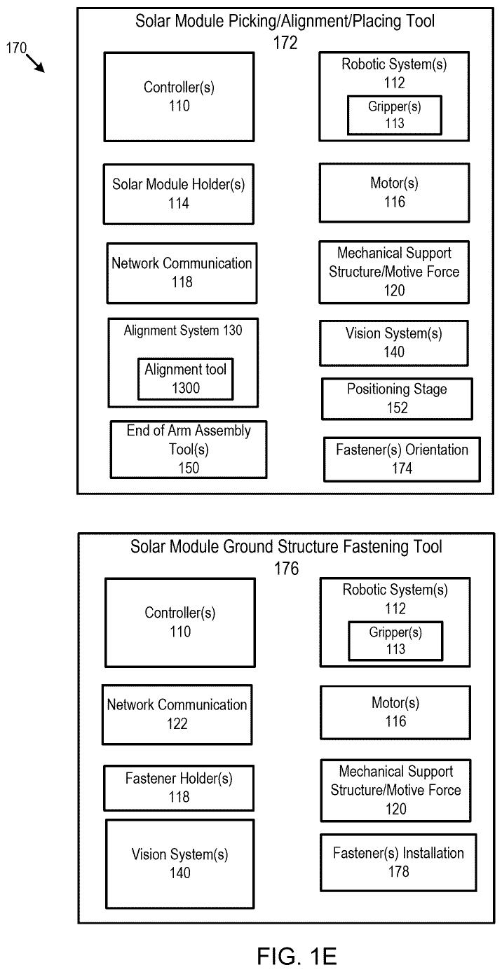

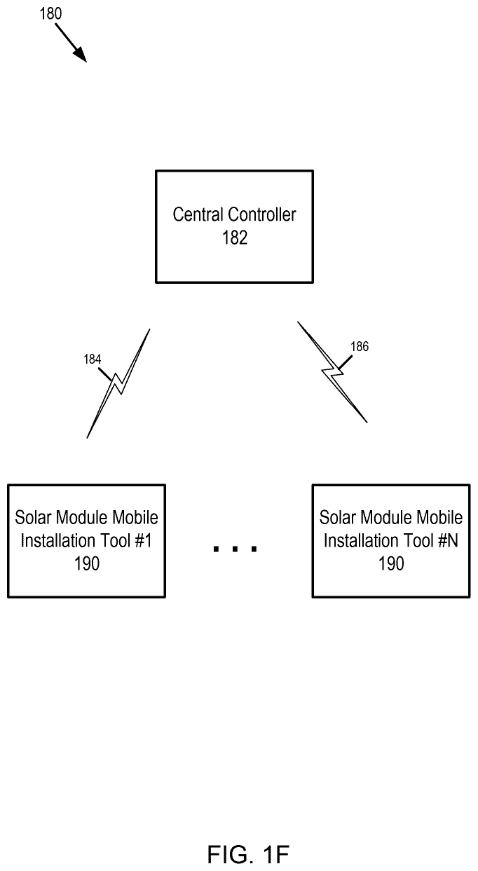

Referring to the figures, FIG. 1A is a first example block diagram of the solar module installation system 100 (alternatively termed a solar module installation tool). The solar module installation system 100 may include functionality configured to perform any one, any combination, or all of the following: automatic solar module-ground structure alignment 102; automatic fastener(s) orientation 104; or automatic fastener(s) fixed connection 106. In one or some embodiments, automatic solar module-ground structure alignment 102 may comprise any one, any combination, or all of: hardware configured to move one or both of the solar module 310 and the ground structure into physical contact/alignment (e.g., robotic system(s) 112; positioning stage 152); vision system(s) configured to provide position information for such movement (e.g., first vision system 960 as an example of a perception system); or control electronics for controlling the hardware.

In one or some embodiments, automatic fastener(s) orientation 104 may comprise any one, any combination, or all of: a fastener orientation tool (e.g., fastener(s) orientation tool 214, such as any one, any combination, or all of a vibrating system, a robotic system, or a moving platform system, see FIGS. 2D-O); or hardware to house and/or convey the predetermine oriented fastener(s) (e.g., magazine, conveyors, etc.); or control electronics for controlling the hardware.

In one or some embodiments, automatic fastener(s) fixed connection 106 may comprise one or both of the following sub-functionalities, including: insertion of fastener(s) into the aligned solar module/ground structure (e.g., an aligned hole of the solar module and at least a part of the ground structure); and automatically contacting the inserted fastener(s) for fixed connection (e.g., with fasteners comprising two fasteners that engage one another, automatically contacting the first fastener with a second fastener, such as a collar, automatically swaging the fastener, etc.). Further, automatic fastener(s) fixed connection 106 may comprise any one, any combination, or all of: hardware configured to perform one or both of the sub-functionalities (e.g., fastener insertion tool (e.g., fastener insertion module 400) and/or fastener automatic contact tool (e.g., tool 600)); vision system(s) configured to provide position information for such movement (e.g., second vision system 964 as another example of a perception system); or control electronics for controlling the hardware.

As discussed in more detail below, the solar module installation system 100 may comprise a mobile system (see solar module mobile installation tool 190) and a stationary system (see central station 210). In one or some embodiments, the functionality of automatic solar module-ground structure alignment 102, automatic fastener(s) orientation 104, and automatic fastener(s) fixed connection 106 may be divided amongst the mobile system and the stationary system. See FIGS. 2A-B. Alternatively, the functionality of automatic solar module-ground structure alignment 102, automatic fastener(s) orientation 104, and automatic fastener(s) fixed connection 106 may solely reside within the mobile system.

Further, the solar module installation system 100 may combine one or more of the functionalities illustrated in FIG. 1A. As one example, automatic fastener(s) orientation 104 and automatic fastener(s) fixed connection 106 may be combined as automatic fastener(s) orientation and fixed connection 108 (e.g., robotic system configured to perform automatic fastener(s) orientation 104 may also be configured to perform at least part of automatic fastener(s) fixed connection 106), as illustrated in FIG. 1B.

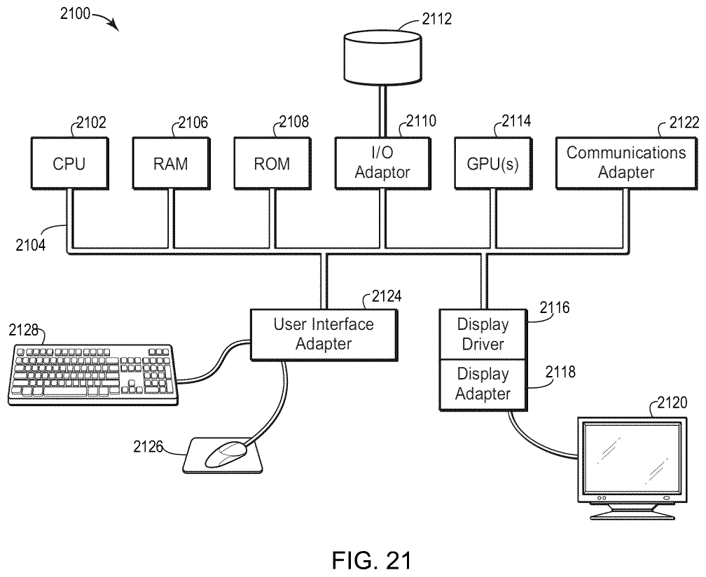

FIG. 1C is a third block diagram of the solar module installation system 100, which may include any one, any combination, or all of: controller(s) 110; robotic system(s) 112; solar module holder(s) 114; motor(s) 116; fastener holder(s) 118; mechanical support structure/motive force 120; network communication 122; alignment system 130; vision system(s) 140; end of arm assembly tool(s) 150; positioning stage 152; and fastener orientation/installation 154. Controller(s) 110 may comprise any type of computational functionality (discussed further below with regard to FIG. 21). Further, controller(s) 110 may comprise a single controller configured to control all of solar module installation system 100. Alternatively, multiple controllers may control different parts of solar module installation system 100.

In one or some embodiments, robotic system(s) 112 may comprise (or consist of) a single robotic system for solar module installation system 100, with the single robotic system configured to perform the disclosed robotic actions, including any one, any combination, or all of: selecting a respective solar module from a cradle; moving the respective solar module and/or the respective ground structure; or performing the mechanical fastening of the respective solar module with the respective ground structure. Alternatively, robotic system(s) 112 may comprise at least a first robotic system configured to perform the selection of the respective solar module from the cradle and the movement of the respective solar module and/or the respective ground structure, and a second robotic system configured to perform the mechanical fastening of the respective solar module with the respective ground structure.

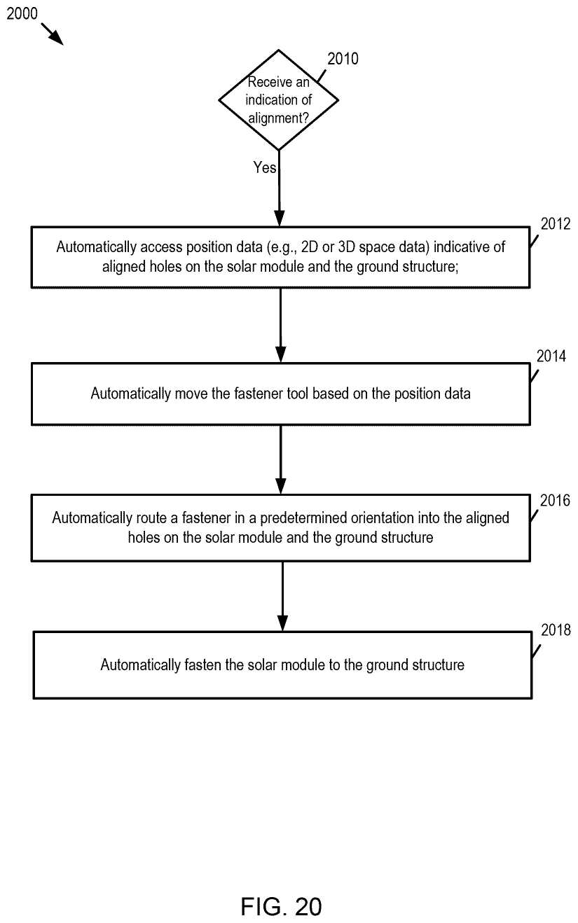

Solar module holder(s) 114 may comprise one or more mechanical structures configured to hold a plurality of solar modules therein. As discussed in more detail below, one example of a solar module holder 114 comprises a cradle 930. Further, one or more motor(s) 116 may be used for the solar module installation system 100, such as in support of robotic system(s) 112 and/or mechanical support structure/motive force 120 and/or moving a part of the fastening tool toward the ground structure (e.g., see FIG. 20). Further, the solar module installation system 100 may include fastener holder(s) 118, which may be configured to house or hold the various fasteners (e.g., receptacle for pins, collars, rivets, bolts, nuts, etc.). Finally, the solar module installation system 100 may include mechanical support structure/motive force 120, which may include the ground structure for the solar module installation system 100 and the means by which the solar module installation system 100 moves. Network communication 122 may comprise wired and/or wireless communication with external electronic devices, such as a central server and/or other solar module installation system(s) 100.

Further, solar module installation system(s) 100 may include vision system(s) 140, which may comprise one or more vision systems (illustrated in FIG. 1C as first vision system 141 and second vision system 142), discussed further below. As one example, perception system may comprise vision system(s) 140, which may include a machine vision system and/or an AI system, and may include one or more sensors (e.g., one or more cameras configured to obtain an image, such as a digital image) configured to sense or detect a position of the ground structure. For example, one or more cameras may capture image(s) of the intermediate support structure 320. In turn, one or more computer systems may process and analyze the image(s) to determine various aspects, such as any one, any combination, or all of: a position of the intermediate support structure 320 (e.g., an absolute position of the intermediate support structure 320; a relative position of the intermediate support structure 320 relative to another object, such as the solar module 310); a position of the solar module 310 (e.g., an absolute position of the solar module 310; a relative position of the solar module 310 relative to another object, such as the intermediate support structure 320); the position of the intermediate support structure 320 relative to the solar module 310 (or vice versa); one or more features of the intermediate support structure 320 (e.g., slots(s) on the intermediate support structure 320); or one or more features of the solar module 310 (e.g., hole(s) on the solar module 310).

Thus, in one or some embodiments, one or more sensors (e.g., lidar sensors, capacitive sensors, cameras or the like) may generate sensor data, such as indicative of one or both of the ground structure or the solar module 310. As one example, cameras alone may generate the sensor data. Alternatively, cameras in combination with other types of sensors, such as one or both of lidar sensors or capacitive sensors, may generate the sensor data. Still alternatively, only other types of sensors may be used to generate the sensor data. Regardless, one or more computer systems, such as controller 110, may process and analyze the sensor data to determine various aspect(s) of the ground and/or the solar module 310.

In particular, the vision system(s) 140 may generate sensor data in order to determine various aspect(s) of the ground structure and/or the solar module 310. The various aspect(s) of the ground structure and/or the solar module 310 may then be input to controller(s) 110 in order to control any one, any combination, or all of robotic system(s) 112, alignment system 130, or positioning stage 152 in order to align the solar module 310 with at least a part of the ground structure. In this regard, vision system(s) 140 may be configured to perform computer vision and/or AI vision, which may include any one, any combination, or all of scene reconstruction, object detection, event detection, activity recognition, video tracking, object recognition, 3D pose estimation, learning, indexing, motion estimation, visual serving, 3D scene modeling, or image restoration.

In one or some embodiments, end of arm assembly tool(s) 150 may be configured, under control of controller(s) 110, to perform any one, any combination, or all of: automatically picking a respective solar module 310 from solar module holder(s) 114; automatically transport the respective solar module 310 toward the ground structure; automatically align (alone or in combination with other mechanical systems), such as positioned the respective solar module 310 in predetermined relation to the ground structure; or automatically place the respective solar module 310 onto the ground structure. In one or some embodiments, end of arm assembly tool(s) 150 may include robot(s), which may be part of robotic system(s) 112. As such, in one or some embodiments, solar module installation system(s) 100 may include robotic system(s) 112 solely as part of end of arm assembly tool(s) 150. Alternatively, solar module installation system(s) 100 may include robotic system(s) 112 separately from end of arm assembly tool(s) 150.

Fastener orientation/installation 154 may comprise the hardware and/or software for performing one or both of: (i) positioning the fastener(s) (whether in a single-part fastener system, such as a rivet, or in a multi-part fastener, such as a pin/collar) in a predetermined orientation; or (ii) installing the fastener(s) (e.g., inserting fastener(s) into aligned holes/slots and permanently affixing the fastener, such as by swaging, attaching a mating fastener, deforming the fastener, etc.). As discussed in more detail below, various types of devices for fastener orientation/installation 154 are contemplated, such as illustrated, for example, in FIGS. 2A-G, 6, 7A-B, and 8A-B.

FIG. 1D is an example block diagram 156 of the solar module installation system 100, in which the functionality is divided amongst multiple autonomous devices (e.g., multiple autonomous vehicles), such as between a solar module picking/alignment/placing tool 158 and a solar module ground structure fastening tool 160. As discussed above, installation of the solar module may comprise performing picking, transporting, aligning, placing, and fastening. In one or some embodiments, such functions may be performed by a single autonomous vehicle. Alternatively, the functions may be segmented or subdivided between separate autonomous vehicles. In this regard, any one, any combination, or all of picking, transporting, aligning, placing, and fastening may be segmented or subdivided between separate autonomous vehicles, an example of which is illustrated in FIG. 1D. In particular, solar module picking/alignment/placing tool 158 is configured to perform the picking, transporting, aligning, and placing, and the solar module ground structure fastening tool 160 is configured to perform the fastening. In one or some embodiments, the fastening tool 160 is entirely autonomous in moving toward the aligned holes, in inserting the fastener, and in fastening the fastener. Alternatively, the fastening tool 160 is handheld and configured to be manually moved toward the aligned holes. Thus, the various functions may be divided amongst different autonomous vehicles. As illustrated in FIG. 1D, fastening orientation and installation (as shown by fastener(s) orientation/installation 154) is resident on solar module ground structure fastening tool 160. In this regard, fastener orientation may be performed on the autonomous vehicle(s). See FIG. 2C. Alternatively, fastener orientation is performed on the trailer or at the central station (such as illustrated in FIGS. 2A-B, discussed below). Still alternatively, the functions of fastening, including orientation and installation, may be segmented between different autonomous vehicles, such as illustrated in FIG. 1E, which shows a block diagram 170 in which the solar module picking/alignment/placing tool 172 and the solar module ground structure fastening tool 176 include fastener(s) orientation 174 and fastener(s) installation 178, respectively. As discussed further below, after the fasteners are properly oriented into a predetermined orientation, the properly oriented fasteners may be fed directly to the fastener device (see FIG. 2O) or may be inserted into a magazine, cartridge or the like, which is then fed to the fastener device for dispensing. In the instance where the solar module picking/alignment/placing tool 172 performs the fastener orientation, the solar module picking/alignment/placing tool 172 may insert the properly oriented fasteners into the magazine/cartridge, which may then be transferred (e.g., via a robot from robotic system(s) 112 resident on one or both of the solar module picking/alignment/placing tool 172 or the solar module ground structure fastening tool 176) to the solar module ground structure fastening tool 176 for fastening.

Further, as discussed further below, the perception system (e.g., vision system(s) 140) of solar module ground structure fastening tool 160, 176, resident on an autonomous vehicle separate from solar module picking/aligning/placing tool 158, 172, may generate data, such as perception data, that may be used by the solar module picking/aligning/placing tool 158, 172 to perform any one, any combination, or all of: automatically moving the solar module into predetermined relation with the ground structure; automatically moving the solar module into alignment with the ground structure; or automatically placing the solar module onto the ground structure.

FIG. 1F is a block diagram 180 of a plurality of solar module installation systems 100 (including solar module mobile installation tool #1 190 to solar module mobile installation tool #N 190, where N is 2 or greater) wirelessly communicating with a central controller 182. As shown, central controller 182 may send commands to and/or receive data from the plurality of solar module mobile installation tools 190 wirelessly (as illustrated by 184, 186). As discussed above, the solar module installation system 100 may comprise a single autonomous vehicle (see FIG. 1C) or multiple autonomous vehicles (with functions divided amongst the multiple autonomous vehicles). See FIGS. 1D-E. Thus, solar module mobile installation tool 190 may comprise one or multiple autonomous vehicles.

FIGS. 2A-C are block diagrams 200, 202, 204 of different sequences of inputting predetermined oriented fasteners into automatic fastener(s) fixed connection 106. As discussed above, in one or some embodiments, the fastener(s) used for fixed connection may be randomly oriented. As one example, pins used to insert into the aligned holes may be in a box or the like without any type of order. In such an instance, the fasteners may be automatically placed into a predetermined orientation for later use by automatic fastener(s) fixed connection 106. Alternatively, fasteners that are already in a predetermined orientation obviate the need to place them in the predetermined orientation.

Performing the predetermined orientation may occur in one of several places within the system, as illustrated in FIGS. 2A-C. As one example, the predetermined orientation may be performed at a central location, such as central station 210, which may comprise a stationary device. As shown, central station 210 includes automatic fastener(s) orientation 104, which may comprise any one, any combination, or all of: randomly oriented fasteners 212 (e.g., a box of unordered fasteners); fastener(s) orientation tool 214 (e.g., discussed subsequently as a vibration tool, robotic system, mechanical system, or the like); or predetermined oriented fasteners placed in receptacle 216 (e.g., a magazine). It is noted that placement in a receptacle or the like may not be needed, such as illustrated in FIG. 2G.

The predetermined oriented fasteners placed in receptacle 216 (e.g., the magazine with the predetermined oriented fasteners therein) may be transported to solar module mobile installation tool 190 via a mobile device, such as trailer 220, which is configured to shuttle between the central station 210 and solar module mobile installation tool 190 (e.g., magazines loaded with the predetermined oriented fasteners therein are shuttled by trailer 220 to solar module mobile installation tool 190; empty fastener receptacles 218 (such as empty magazines) are transported from solar module mobile installation tool 190 to central station 210 via trailer 220). See FIGS. 2A-B. In such a configuration, predetermined oriented fasteners placed in receptacle 216 may be input to automatic fastener(s) fixed connection 106. By way of example, the magazine with the predetermined oriented fasteners therein may be loaded into a tool, such as tool 600, for insertion/fixed connection.

Alternatively, the predetermined orientation may be performed at a mobile location, such as trailer 220. As shown, trailer 220 receives the randomly oriented fasteners 212 from central station 210, generates the predetermined oriented fastener (via fastener(s) orientation tool 214, resident on trailer 220), and transmits the predetermined oriented fasteners placed in receptacle 216 (e.g., a magazine) to solar module mobile installation tool 190. In one embodiment, the empty fastener receptacle 218 may be sent back to central station 210 via trailer 220 returning to central station (such as in the event that the central station 210 performs the fastener orientation (see FIG. 2A) or in the event that the central station 210 distributes empty fastener receptacles 218 to trailers 220 to perform the fastener orientation (see FIG. 2B). Alternatively, the empty fastener receptacle 218 may be sent to trailer 220 (see FIG. 2B with empty fastener receptacle 218 in dashed lines) in order for the trailer to perform the fastener orientation (see FIG. 2B).

Still alternatively, the predetermined orientation may be performed at solar module mobile installation tool 190. As shown, trailer 220 transports the randomly oriented fasteners 212 from central station 210 to the solar module mobile installation tool 190. In turn, solar module mobile installation tool 190 generates the predetermined oriented fastener (via fastener(s) orientation tool 214), and transmits the predetermined oriented fasteners placed in receptacle 216 (e.g., a magazine) to automatic fastener(s) fixed connection 106 within solar module mobile installation tool 190. In the embodiment where the solar module mobile installation tool 190 performs automatic fastener(s) orientation 104, the empty fastener receptacle 218 may be routed from automatic fastener(s) fixed connection 106 to back to automatic fastener(s) orientation 104 (see FIG. 2C).

As discussed above, solar module mobile installation tool 190 may comprise one or multiple autonomous vehicles. Thus, in the instance where the solar module mobile installation tool 190 performs the automatic fastener(s) orientation 104, such function may be performed on the same autonomous vehicle that also performs the automatic fastener(s) fixed connection 106. Alternatively, different autonomous vehicles may perform the automatic fastener(s) orientation 104 and the automatic fastener(s) fixed connection 106. As discussed above, a first respective autonomous vehicle may perform automatic fastener(s) orientation 104 and automatic solar module-ground structure alignment 102 and a second respective autonomous vehicle may perform the automatic fastener(s) fixed connection 106. See solar module picking/alignment/placing tool 172 and solar module ground structure fastening tool 176, respectively, in FIG. 1E.

FIGS. 2D-H are block diagrams 222, 228, 234, 242, 260, of different implementations of the automatic fastener(s) alignment. In particular, various types of automatic fastener alignment devices are contemplated, examples of which are vibratory-based (see FIGS. 2D-E), robotic-based (see FIGS. 2F-G), or moving platform-based (see FIGS. 2H-O). Other types of automatic fastener alignment devices are contemplated.

Specifically, FIG. 2D illustrates one example of the predetermined orientation of the fastener via vibration. As shown, randomly oriented fasteners 212 are input to vibration sub-system 230, which may comprise use of vibratory feeders (alternatively termed a vibrating feeder) that help position the fasteners in the predetermined orientation. For example, an electromagnetic vibratory feeder may comprise any one, any combination, or all of: a base; a coil; flat springs; a magnet; and a tray. The flat springs may connect the tray to the base, allowing them to move in relation to each other, facilitating fastener feeding. The coil may act as an electromagnet, wrapped in copper wire and fixed to the base. The magnet may be attached to the feeder tray. When the coil pulls the magnet toward it and then releases it, the base and tray may move in opposite directions. In this way, the components may work together in a system that combines the coil, magnet and springs into one unit. Thus, the electromagnetic vibrating feeder, using its components, may shake its tray to move the fasteners, such as those fasteners in a predetermined orientation moving in a certain direction whereas other fasteners potentially being fed back, as illustrated in FIG. 2D. Thus, those fasteners in the predetermined orientation may be fed to receptacle placement 226, which may convey or feed the predetermined oriented fasteners into a magazine or the like for subsequent use by automatic fastener(s) fixed connection 106.

The vibration sub-system 230 in FIG. 2E is similar to the vibration sub-system 224 FIG. 2D, except for the addition of leveling device 232. In certain instances, the vibration sub-system may operate on a moving platform, such as on trailer 220 or on solar module mobile installation tool 190. See FIGS. 2B-C. In such instances, the moving platform may travel on uneven terrain, so that the moving platform (and in turn the vibration sub-system) may not be level. In one or some embodiments, in order for the vibration sub-system to operate properly, leveling device 232 may be used in order to level vibration sub-system 230 regardless of unevenness of the moving platform.

FIGS. 2F-G illustrate robotic-based fastener alignment tools, as illustrated by robotic sub-system 236. As shown, robotic sub-system 236 may comprise robot(s) 238 that may work in combination with vision system 240. In one or some embodiments, vision system 240 may scan or analyze part or all of the randomly oriented fasteners 212 for input to robot(s) 238. In practice, the scan may identify pins with the box of randomly oriented fasteners that have certain characteristics, such as already being in the predetermined orientation. In turn, robot(s) 238 may select the fasteners that are already in the predetermined orientation. Alternatively, robot(s) 238 may randomly select the fasteners and move the fastener into the predetermined orientation. Regardless, based on the vision system 240, the robot(s) may perform the picking and/or the orienting of the fastener.

In one or some embodiments, after the robot sub-system 236 has the fastener in the predetermined orientation (either by placing the fastener in the predetermined orientation or by selecting a fastener with the predetermined orientation), the robot sub-system 236 may route the fastener to receptacle placement 226, which may comprise the robot sub-system 236 placing the fastener in the predetermined orientation into a magazine or the like, as shown in FIG. 2F. In turn, the receptacle may be routed to automatic fastener(s) fixed connection 106. Alternatively, after the robot sub-system 236 has the fastener in the predetermined orientation, the fastener in the predetermined orientation may be routed, such as via conveyor belt or the like, to automatic fastener(s) fixed connection 106 without the intermediate step of placement in a receptacle, as shown in FIG. 2G.

In one or some embodiments, a single robot may perform any one, any combination, or all of: the picking; the orienting; the insertion in the magazine; and the insertion of the fastener into the aligned hole (as discussed further below). Alternatively, multiple robots may be used, such as a first robot to perform any one, any combination, or all of the picking, the orienting, and the insertion in the magazine, and a second robot for the insertion of the fastener into the aligned hole.

As discussed above, one or more structures may be used in order to perform the fastener alignment. One example structure may include a respective hole that is shaped to mate with a respective fastener so that the respective fastener is at least partly inserted within, is entirely inserted within, or entirely passes through the respective hole. In one or some embodiments, the structure(s) for alignment may be one or both of: non-movable structure(s) that include at least one hole shaped so that the respective fastener is at least partly inserted within, is entirely inserted within, or entirely passes through the respective hole; or movable structure(s) that include at least one hole shaped so that the respective fastener is at least partly inserted within, is entirely inserted within, or entirely passes through the respective hole. In particular, in a first embodiment, movable structure(s) may work in combination with non-movable structures. For example, a rotating drum may work in combination with a non-moving drum holder to perform the fastener alignment, discussed further below. Alternatively, only movable structures may be used to perform the fastener alignment. For example, a rotating drum may be used to trap the fasteners in a predetermined orientation within the shaped holes. After which, the fasteners in the predetermined orientation may be removed (such as by at least one robot) for insertion into a receptacle or for direct insertion into the aligned holes.

Merely by way of example, the moveable structure may comprise a platform, a drum, a support structure, or the like that is moved (such as rotated) in order to perform the fastener alignment. An example of this is illustrated in FIG. 2H, which is a block diagram 260 of the automatic fastener(s) alignment with a moving platform sub-system 261. As a predicate step, the randomly oriented fasteners 212 may be fed into a metering device 257 in order to meter the rate at which the randomly oriented fasteners 212 are fed to the moving platform sub-system 261. Various metering devices 257 are contemplated. As one example, metering device 257 may comprise a conveyor in combination with a mechanical barrier, which may be moved in order to adjust the number of or rate at which randomly oriented fasteners 212 are fed to the moving platform sub-system 261. Alternatively, pipe(s), hoppers, or the like may guide the randomly oriented fasteners 212 to the moving platform sub-system 261. Moreover, metering device 257 may operate either as an open loop system or a closed loop system (with feedback).

Further, the moving platform sub-system 261 may take one or more forms. As one example discussed in more detail below (see FIGS. 2L-M), a platform or drum may be shaped so that the fastener(s) may be at least partly slotted or inserted therein. In order to facilitate the slotting or insertion therein, the platform or drum may be moved, such as rotated. In this regard, in one or some embodiments, the platform or drum may include holes shaped to mate with the fastener(s) 262, and movement device(s) 263 may be configured to move one or both of: (i) the platform itself (e.g., by rotating the platform); or (ii) the fastener(s) (e.g., fasteners inserted within the platform may rotate as the platform itself rotates; air pushing the fasteners into the slots of the platform). As such, the movement device(s) 263 may comprise motor(s) 264 and/or forced air device(s) 265.

Also, by way of example, the non-moveable structure may likewise comprise a platform, a drum holder, a support structure, or the like that is stationary. In practice, the movable structure (e.g., the drum) may move, thereby aligning fastener(s) within the movable structure's respective holes or slots. Further, as the movable structure moves, its respective holes or slots will come into alignment with respective exit holes or slots of the non-movable structure (e.g., the drum holder). So that, when a respective slot in the drum moves to and is aligned with the respective exit slot in the drum holder, the respective fastener (held in the predetermined orientation within the respective slot in the drum) may exit the respective slot in the drum and through the respective exit slot in the drum holder (and in turn conveying the predetermined oriented fasteners to the automatic insertion mechanism, such as either directly or into a receptacle).

As shown in FIG. 2H, metering device 257-1 may likewise be placed at the output of moving platform sub-system 261, being fed the predetermined oriented fasteners. Similar to metering device 257, metering device 257-1 may adjust the number of or the rate at which the predetermined oriented fasteners are fed to receptacle placement 226. Similar to feeding the randomly oriented fasteners 212 to the moving platform sub-system 261, the predetermined oriented fasteners may be guided from the moving platform sub-system 261 in one of several ways, such as via pipe(s), hopper(s), conveyor(s), cartridge(s), or the like. In this regard, metering devices may be included in one or both of the input to or output from the moving platform sub-system 261.

FIGS. 2I-J are a front perspective view 266 and a rear perspective view 270 of the moving platform sub-system. FIG. 2I shows drum 267 and drum holder 268, with drum 267 having a plurality of holes 269. FIG. 2I further shows air inlet 244, into which air may be blown. In particular, as discussed below, air inlet 244 may be connected to an air blowing system via air inlet connector 259. In this way, air may be forced within drum 267 in order to push aligned pins out of drum 267 and drum holder 268. As discussed in more detail with regard to FIGS. 2L-M, different drums may be differently shaped holes or slots in order to accommodate different types of fasteners therein (e.g., pins or collars). FIG. 2J illustrates a motor 273 that is configured to rotate the drum 267. In practice, fasteners will be inserted within respective holes 269 in the drum 267. As the drum 267 rotates, a respective hole 269 in the drum 267 will align with the respective exit hole 274 (shown in FIG. 2K) of the drum holder 268, so that the fastener, aligned in the predetermined orientation, moves through the respective exit hole 274 of the drum holder 268 to a channel 272 of an exit structure 271. Thus, the fastener, seated in the channel 272, is in the predetermined orientation.

In one or some embodiments, channel 272 may be removed from exit structure 271 and may serve as the receptacle for the aligned fasteners. In this regard, exit structure 271 remains connected to drum 267. Alternatively, exit structure 271, with a channel 272 filled with aligned fasteners, may be removed from drum 267 and inserted into another device (e.g., automatic fastener(s) fixed connection 106), with the exit structure 271 and channel 272 acting as the receptacle. After which, another exit structure 271, with a channel 272 that is empty, may be attached to drum 267. Still alternatively, exit structure 271 (with channel 272) may be part of a device (e.g., automatic fastener(s) fixed connection 106). In practice, the entire device may be connected to drum 267, with exit structure 271 (with channel 272) in contact with drum 267. After the channel 272 is filled with aligned fasteners, the entire device (with the channel 272 filled with aligned fasteners) may be disconnected from drum 267.

As discussed above, different drums are contemplated for different types of fasteners. For example, FIGS. 2L-M are different implementations of drums 275, 277 for different fastener alignment of the moving platform sub-system. In particular, drum 275 may include holes or slots 276 shaped for pins, whereas drum 277 may include holes or slots 278 shaped for collars.

FIG. 2N is a perspective view 279 of the moving platform sub-system with conduits into and/or out of the moving platform sub-system. In one or some embodiments, fasteners may be guided into the drum 277 via a conduit system. In one or some embodiments, the conduit system comprises a hose 280 connected to an inlet 281 to drum 277. In one or some embodiments, the fastener is deposited into the hose 280 and guided (such as by gravity and/or by an air blowing sub-system, which may include any one, any combination, or all of: motor(s); rotor(s); or fan blades). Moreover in one or some embodiments, an air-blowing sub-system may guide the aligned fasteners out of drum 275 or drum 277. As shown in FIG. 2N, air inlet connector 259 may connect with air inlet 244 and may thus act as an air conduit in which an air-blowing subsystem may blow air into drum 275 or drum 277. The air-blowing subsystem may include any one, any combination, or all of motor(s), rotor(s), or fan blades, and may blow air into the drum, such as drum 275 or drum 277. In this way, aligned fasteners, whether pins or collars, may effectively be air-blown out of the drum 275 or drum 277. In particular, when an aligned fastener of the drum 267, such as the drum 275 or drum 277, is aligned with exit hole 274 of drum holder 268, air blow via air inlet connector 259 may effectively push the aligned fastener through the exit hole 274.

As discussed above, the fasteners may comprise pins and collars, which may both be aligned prior to use in fastening the solar module to the ground structure. This is illustrated in FIG. 2O, which is a view 283 of the moving platform sub-system sorting two different types of fasteners, such as pins and collars, that are fed to an automatic fastener fixed connection system 298. As shown, unsorted collars 284 and unsorted pins 285 may be metered for sorting using metering device 257, which may meter, via tube 257-2 or the like, respective unsorted collars 284 and unsorted pins 285 to respective collar sorting device 284-1 and pin sorting device 285-1. After which, respective collar sorting device 284-1 and pin sorting device 285-1 may sort unsorted collars 284 and unsorted pins 285 (see sorted collars 286 and sorted pins 296 in respective channels 282). As discussed above with regard to FIG. 2H, metering device 257-1 may be used to meter the predetermined oriented fasteners. An example of this is shown in FIG. 2O using one or more gates 290, 291 in device 288, wherein, by inserting and removing the respective gates 290, 291 into the respective channels 282, the respective sorted collars 286 and sorted pins 287 may be introduced into respective hoses 297, thereby traversing as sorted collars 295 and sorted pins 296. Moreover, one or more sensors, such as sensors 246, may be used to determine whether the respective channels 282 are entirely filled with sorted collars 286 and sorted pins 296. As discussed below, sensors 246 may be used as a trigger to control the fastener orientation device, such as whether to introduce fasteners into the mechanical structure (e.g., the drum) for sorting or whether to control a robotic arm to orient the fastener. Further, sensors 294, such as respective counting devices, may be positioned to count the respective sorted collars 286 and sorted pins 296 through respective hoses 297.

Further, to propel the respective sorted collars 295 and sorted pins 296 through the respective hoses 297, an air flow system 292 that is configured to blow air via hose 293 into the respective channel 282. In addition, one or more sensors may be positioned to determine whether (and potentially how many) of the respective sorted fasteners are routed, such as via the respective hoses 297. For example, sensors 294 for each of the respective hoses 297 may count the number of respective sorted collars 295 and respective sorted pins 296 transmitted to automatic fastener fixed connection system 298.

FIG. 2P is a flow chart 299-1 for a computer-implemented method of automatically aligning the fastener(s), automatically aligning the solar module and at least a part of the ground structure, and automatically fixedly connecting the solar module and at least a part of the ground structure. At 299-2, automatically select with or automatically orient fastener(s) to predetermined orientation. At 299-3, automatically move one or both of the solar module and at least a part of the ground structure so that the solar module and at least a part of the ground structure are physically contacting and aligned. In one or some embodiments, 299-2 is performed prior to 299-3. Alternatively, 299-3 is performed prior to 299-2. After which, at 299-4, using the fastener(s) in the predetermined orientation, automatically fixedly connect the solar module and at least a part of the ground structure are physically contacting and aligned.

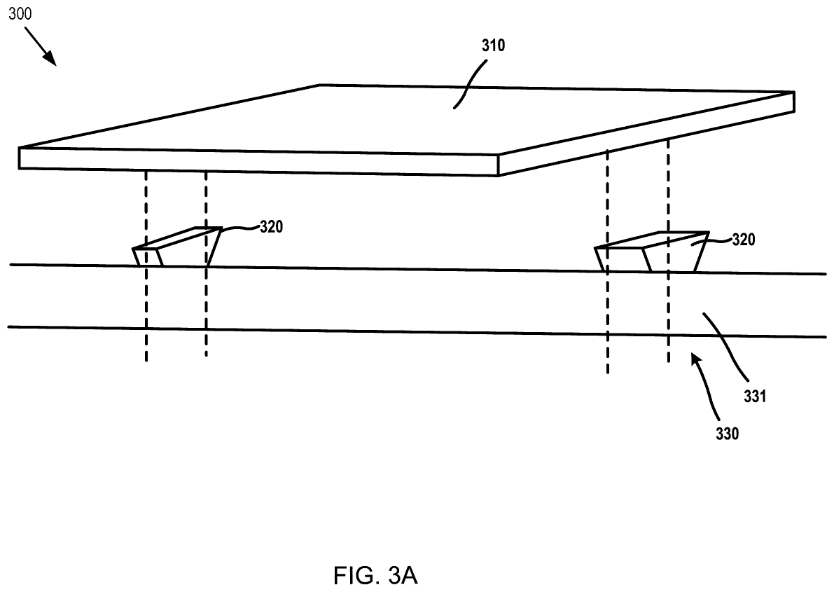

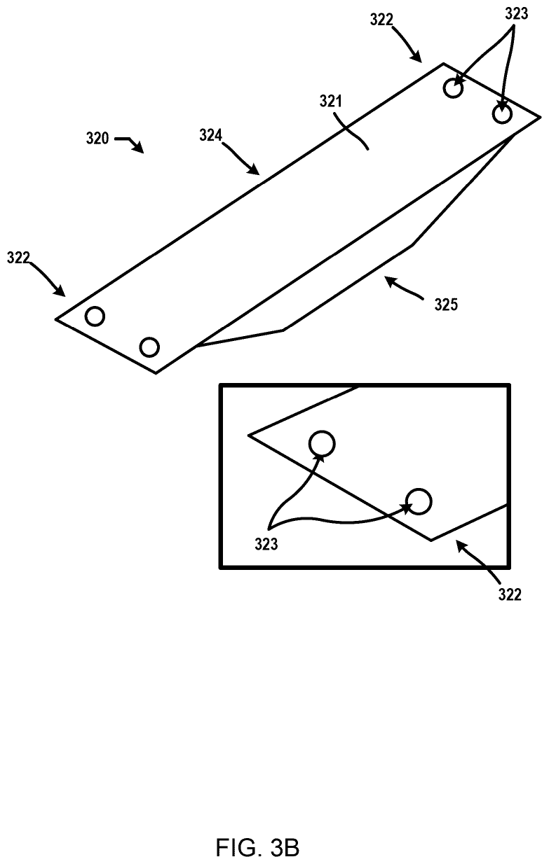

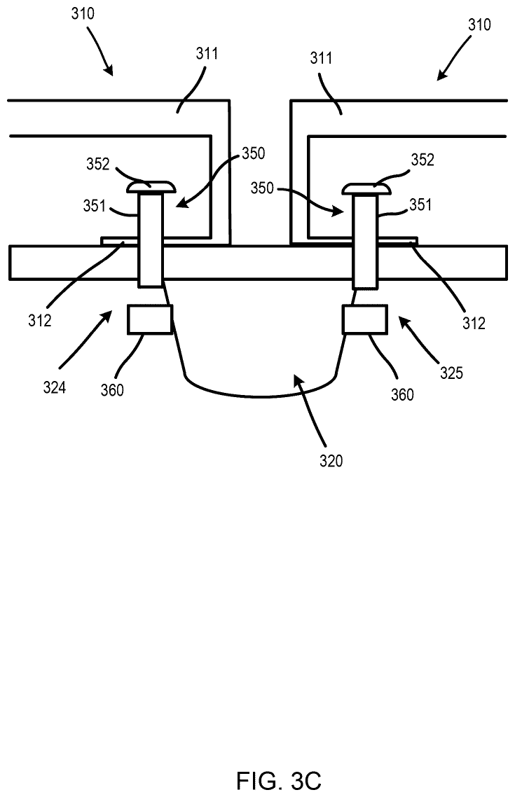

As discussed above, the solar module installation system 100 may be tailored or configured for any one, any combination, or all of: one or more types of the type(s) of installations; one or more type(s) of hardware being installed (e.g., different types of fasteners and/or different types of ground structure; or the automatic and/or manual nature of installation. FIGS. 3A-3C are merely examples of such different tailoring of the solar module installation system 100. For example, FIGS. 3A-C illustrate examples of the racking structure, which may include any one, any combination, or all of a rail or intermediate support structure 320, underlying structure 330 (which may comprise torque tubes or the like, and piles).

Specifically, FIG. 3A is a diagram 300 illustrating alignment of a solar module 310 and a rail or intermediate support structure 320. As shown in FIG. 3A, the intermediate support structure 320 may couple the solar module 310 to underlying structure 330 configured to support the solar module 310. In one or some embodiments, the underlying structure 330 may include a torque tube 331 and one or more legs extending between the torque tube 331 and a supporting surface such as a pile. In one or some embodiments, the intermediate support structure 320 may fixedly couple the solar module 310 to the underlying structure 330, for example, the torque tube 331, such that, as the torque tube 331 rotates, the solar module 310 rotates with the torque tube 331, enabling the solar module 310 to track the sun.

In one or some embodiments, as shown in FIG. 3A, the intermediate support structure 320 may already be coupled to the underlying structure 330 when the solar module 310 and intermediate support structure 320 are aligned and/or installed. For example, in the context of (3), discussed above in which the respective solar module is first placed on top of at least a part of the ground structure (which is already connected to the underlying structure), a plurality of intermediate support structures 320 may be coupled to the underlying structure 330 at positions corresponding to installation positions of the solar modules 310 relative to the underlying structure 330. In one or some embodiments, in the context of (1) or (2) discussed above, the solar module 310 and the intermediate support structure 320 may be installed before the intermediate support structure 320 is coupled to the underlying structure 330. For example, in the context of (1) in which the mechanical connection to the respective ground structure is performed when the respective solar module is selected from the cradle, the solar module 310 and the intermediate support structure 320 may be installed at a receptacle or cradle storing a plurality of solar modules 310. In one or some embodiments, in the context of (2) after the respective solar module is selected from the cradle and is withdrawn from the cradle, the solar module 310 and the intermediate support structure 320 may be installed as the solar module moves away from a cradle storing a plurality of panels, for example, as the solar module is being moved toward an underlying structure 330 configured to support the solar module 310.

As discussed above, various types of ground structures are contemplated. FIG. 3B illustrates one such example of the rail or intermediate support structure 320 of FIG. 3A. As shown in FIG. 3B, the intermediate support structure 320 may include a body 321 having a first end and a second end opposite the first end. The body 321 may further include a flange 322 disposed at the first end and the second end. Each flange 322 of the intermediate support structure 320 may be configured to abut and/or support one or more solar modules 310. The intermediate support structure 320 may further include one or more holes 323 (e.g., rail holes) extending through the body 321 configured to receive a holes fastener for installing the solar module 310 and the intermediate support structure 320. In accordance with some examples, each flange 322 may include one or more holes 323 extending therethrough. For example, as shown in FIG. 3B, each flange 322 may include two holes 323.

FIG. 3C illustrating an act of installing a solar module 310 and an intermediate support structure 320. Referring generally to FIGS. 3B-C, each intermediate support structure 320 may be configured to abut and/or support multiple solar modules 310. For example, the intermediate support structure 320 may be configured to support a pair of adjacent solar modules 310. In some examples, a first side 324 of the intermediate support structure 320 may be configured to abut and/or support a first solar module and an opposite, second side 325 of the intermediate support structure 320 may be configured to abut and/or support a second solar module 310. In one or some embodiments, each flange 322 of the rail may include two holes 323. In one or some embodiments, a first one of the holes 323 may be disposed on a first side 324 of the intermediate support structure 320 and may be configured to receive a fastener for coupling the first solar module to the first side 324 of the intermediate support structure 320. A second one of the holes 323 may be disposed on the second side 325 of the intermediate support structure 320 and may be configured to receive a fastener for coupling a second solar module to the second side 325 of the intermediate support structure 320.

FIG. 3C illustrates an act of installing a solar module 310 and an intermediate support structure 320. Various types of fasteners are contemplated to connect the solar module 310 to the intermediate support structure 320. One example type fastener comprises at least two fastener parts, with a first fastener (interchangeably termed first fastener part) mating or connecting to a second fastener (interchangeably termed second fastener part). In practice, one or more automatic actions may be performed in order to fixedly connect the first fastener with the second fastener (e.g., automatically turning the coupling and/or swaging the coupling), as discussed further below. Another example type fastener comprises or consists of a single fastener (interchangeably termed a single fastener part), which may be automatically threaded through aligned holes of the solar module 310 to the intermediate support structure 320. As discussed above, the aligned holes may be at least partly (or entirely) aligned. As one example, a geometric center of the hole on the solar module is coaxial with the geometric center of the hole of the ground structure. As another example, the geometric center of the hole on the solar module may be no greater than a predetermined distance away with the geometric center of the hole of the ground structure. As still another example, at least partly aligned may comprise at least a predetermined common overlapping/aligned area between the hole on the solar module and the hole of the ground structure so that predetermined common overlapping/aligned area is at least large enough for a respective pin to be inserted therein. Again, in practice, one or more automatic actions may be performed in order to fixedly connect the single fastener to both the solar module 310 and to the intermediate support structure 320. In this regard, the fasteners may comprise one or more fasteners or fastener parts, and may fixedly connect the solar module 310 to the intermediate support structure 320 with one or more automatic actions.

For example, in one or some embodiments, as shown in FIG. 3C, a plurality of fasteners 350 and a plurality of threaded couplings 360 may be used to install the solar module 310 and the intermediate support structure 320. In some examples, each solar module 310 may include a frame 311 configured to support a plurality of solar or photovoltaic cells included in the solar module 310. Additionally, as shown in FIG. 3C, the frame 311 may couple the solar module 310 to the intermediate support structure 320. For example, as shown in FIG. 3C, the frame 311 may include a flange 312 disposed behind or below the plurality of solar modules 310. The flange 312 may include one or more holes (e.g., frame holes) configured to receive a fastener 350 for coupling the frame 311 to the intermediate support structure 320. In one or some embodiments, the solar module 310 and the intermediate support structure 320 may be placed in physical contact with one another such that respective holes of the solar module 310 and the intermediate support structure 320 are aligned. A fastener 350 may then be inserted through the aligned holes for mechanically connecting or installing the solar module 310 and the intermediate support structure 320. Thus, various types of fasteners 350 are contemplated, such as any of a threaded pin, a bolt, a nut, a screw, a rivet, a nail, or the like.

As shown in FIG. 3C, the fastener 350 may include a body 351 and a head 352 disposed at one end of the body 351. The body 351 of the fastener 350 may be inserted into aligned holes of the solar module 310 and the intermediate support structure 320, such that the body 351 extends through the hole of the solar module 310 and the hole 323 of the intermediate support structure 320. According to some examples, the head 352 of the fastener 350 may abut the frame 311 preventing the fastener 350 from being pulled all the way through the aligned holes of the solar module 310 and the intermediate support structure 320. Additionally, one or more threaded couplings 360 for example, a collar, nut, or the like may be coupled to a distal end of the body 351 of the fastener 350 after the body 351 has been inserted through the aligned holes of the solar module 310 and the intermediate support structure 320.

In one or some embodiments, a fastener 350 and a threaded coupling 360 may be collectively referred to as a two-part fastener pair. Specifically, the two-part fastener pair may include a first fastener (e.g., the fastener 350), and a second fastener (e.g., the threaded coupling 360).

Alternatively, a single fastener may be used, as discussed above. As one example, a rivet, such as a blind rivet, may be used as a single fastener to mechanically and/or fixedly couple the solar module 310 and the intermediate support structure 320. In one or some embodiments, the blind rivet may be installed from a single side of the solar module 310 and the intermediate support structure 320. The blind rivet may include a body or shell having a hollow cylindrical shape and a mandrel or stem extending through the rivet body. While placed at an installation position, for example, between aligned holes of the solar module 310 and the intermediate support structure 320, the mandrel of the blind rivet may be pulled (e.g., by a rivet gun), such that the body of the rivet deforms, tightens, or bulges, forming a bulb on the blind or unaccessed side mechanically and/or fixedly coupling the solar module 310 and the intermediate support structure 320.

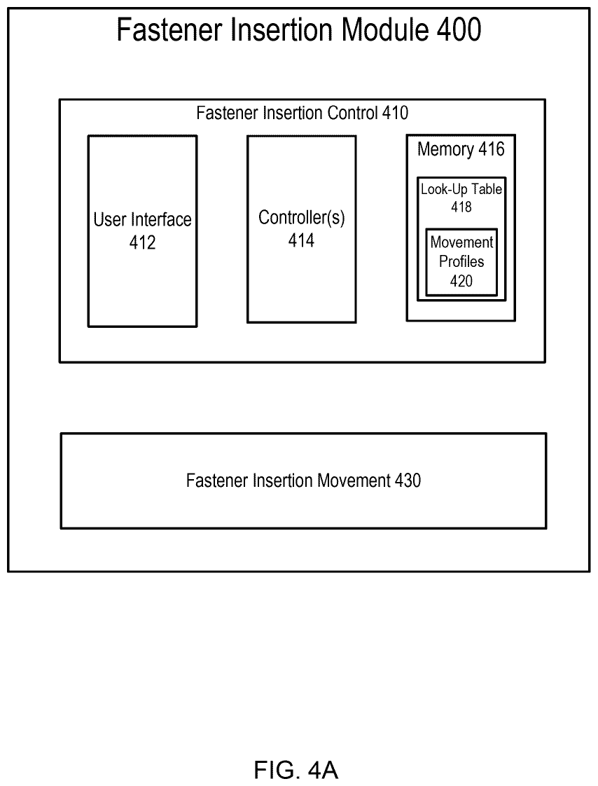

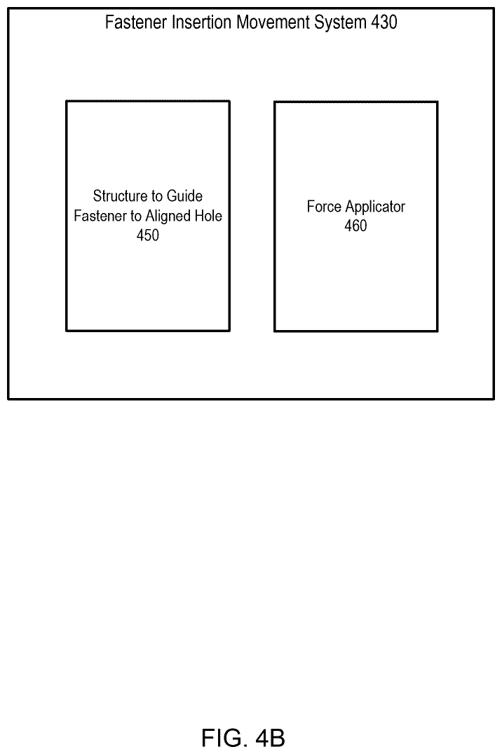

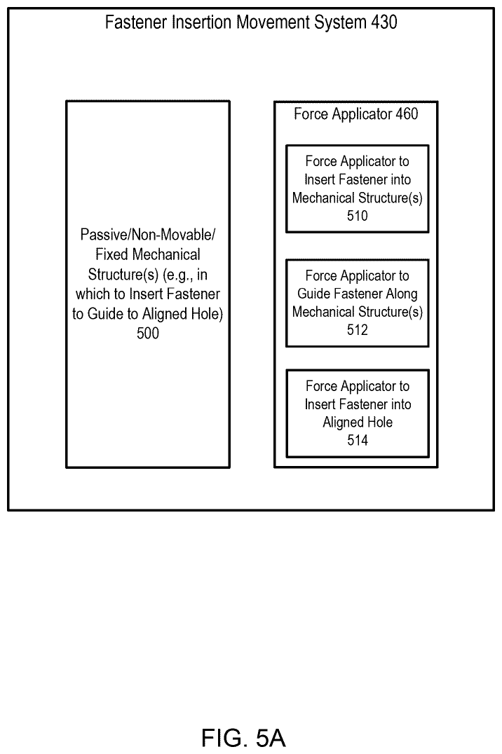

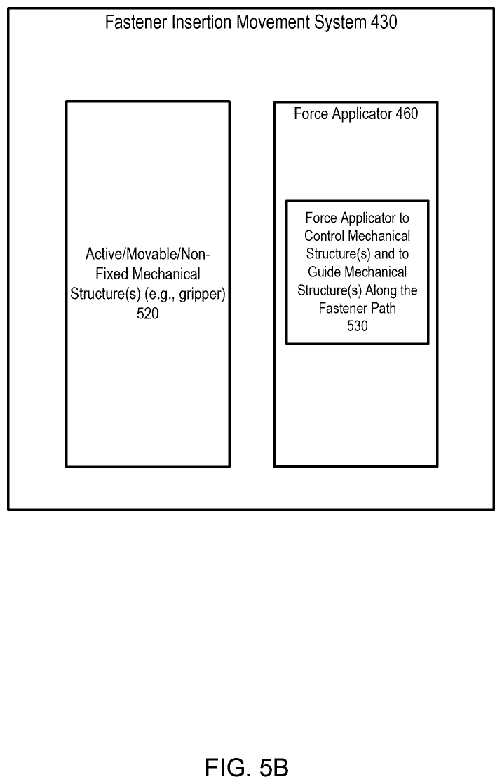

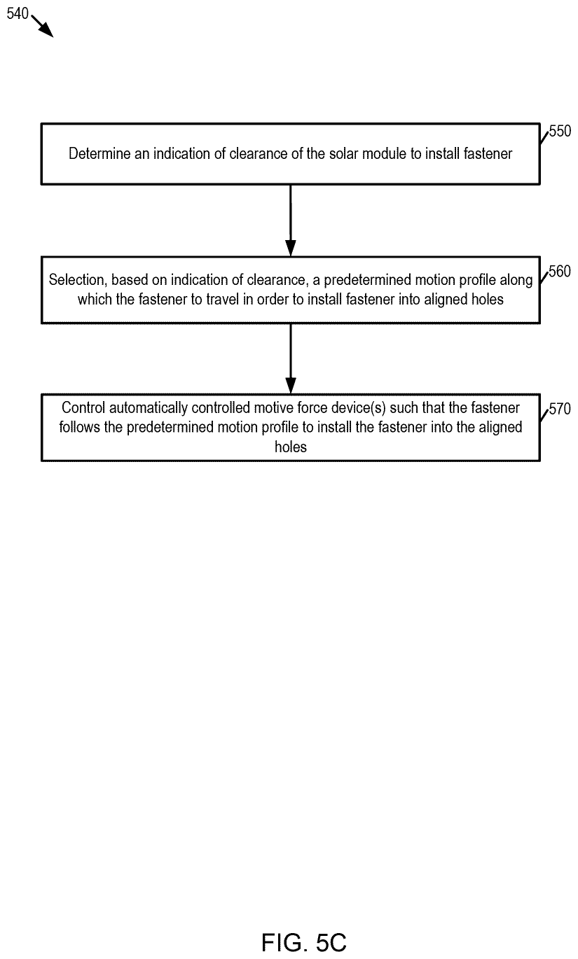

As discussed above, at least one fastener may be automatically moved into the aligned holes of the solar module 310 and at least a part of the ground structure (such as the intermediate support structure 320). After insertion, the at least one fastener may be fixedly connected by at least one automatic contact (e.g., by automatically connecting a collar). As one example, the at least one fastener (in one embodiment, the at least one fastener consists of a single fastener; alternatively, the at least one fastener comprises one fastener of an at least two fastener system) may be automatically moved along a path to and/or within the aligned holes including: (i) removal the fastener (such as a predetermined oriented fastener) from a fastener receptacle (e.g., fastener holder(s) 118); (ii) moving the fastener away from the fastener receptacle toward and/or physically contacting the aligned holes; or (iii) insertion of the fastener at least partly or entirely into the aligned holes. Various systems are contemplated in order to perform such automatic movement, an example of which is illustrated in the block diagram of FIG. 4A showing fastener insertion module 400. Specifically, fastener insertion module 400 may include fastener insertion control 410 and fastener insertion movement 430. Fastener insertion control 410 may be configured to control movement of the fastener along the fastener's path including any one, any combination, or all of (i), (ii), or (iii) described above. In particular, fastener insertion control 410 may include a user interface 412, controller(s) 414, and memory 416. User interface 412 may comprise a touchscreen or the like, such as display device 2020, discussed further below. User interface 412 may be used to input the indication of clearance of the solar module, as discussed in FIG. 5C. Controller(s) 414 may comprise computational functionality, such as discussed with regard to controller(s) 110, and configure to control the fastener insertion movement 430, as discussed further below. Memory 416 may comprise any type of computer storage device, such as RAM 2006 and/or ROM 2008, and may include data and/or files for access by controller(s) 414 in order to control the fastener insertion movement 430. As one example, memory 416 may include look-up table(s) 418 used for control of the fastener insertion movement 430. In particular, look-up table(s) 418 may correlate the indication of clearance of the solar module with movement profiles 420, as discussed further with regard to FIG. 5C. Alternatively, or in addition, look-up table(s) 418 may correlate the solar module identifying information with movement profiles 420, as discussed further with regard to FIG. 20.

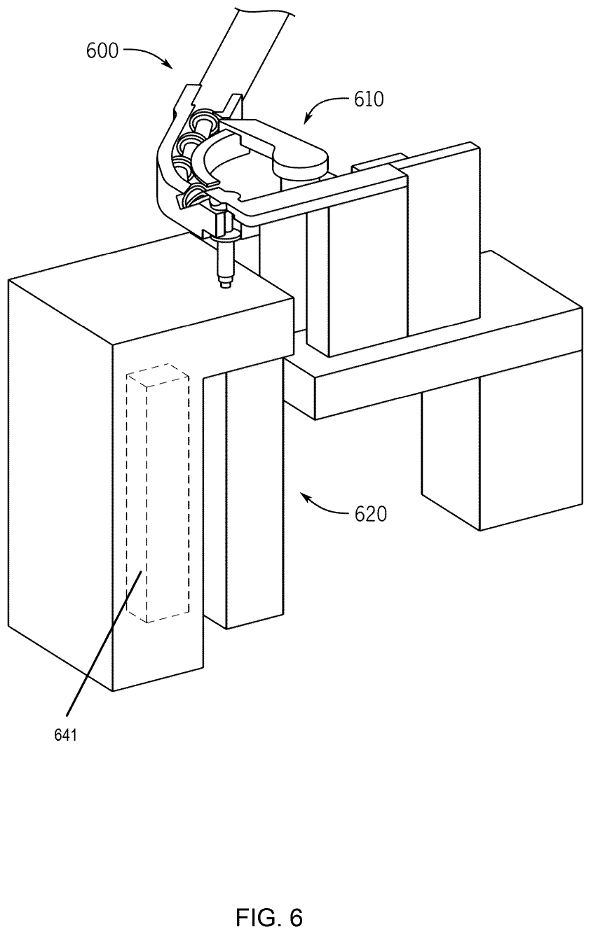

FIG. 4A further illustrates fastener insertion movement 430, an expanded block diagram of which is illustrated in FIG. 4B. In particular, fastener insertion movement 430 may include structure to guide fastener to aligned hole 450 and force applicator 460. Generally speaking, structure is used in order to guide the fastener to the aligned hole (with the structure identified in FIG. 4B as structure to guide fastener to aligned hole 450). Such structure may take one or more forms. As one example, the structure may comprise passive and/or non-movable and/or fixed structure, example of which are track 720 and/or tube 730 illustrated in FIGS. 6 and 7A-B. As discussed in more detail below, the fastener may be inserted into track 720 and/or tube 730, thereby providing the conduit in which the fastener may travel at least partly along its path from the fastener receptacle to the aligned holes. In one or some embodiments, an end of the track 720 may be nonlinear or curved in order to guide the pin into the aligned holes. In particular, the tool illustrated in FIG. 7B may be moved so that an outlet of the track may be positioned above the aligned holes. After which, the pin may move (e.g., guided, such as by fastener motion arm 740, see FIG. 7B) along track 720. As discussed below, the hardware illustrated in FIG. 7B may accommodate the clearance of a respective solar module. In this regard, the hardware may be tailored to different clearances, such as by replacing the hardware to accommodate the clearance for the respective solar module. As another example, the structure may comprise active and/or movable and/or non-fixed structure, an example of which is gripper 113. As discussed herein, gripper 113, which may be part of or work in conjunction with robotic system(s) 112, may be moved in order to grip the fastener. As such, the gripper 113 may comprise the structure that physically contacts the fastener along at least a part (or along the entire) path of the fastener from the fastener receptacle to the aligned holes. Alternatively, a track and/or tube, such as track 720 and/or tube 730 with certain modifications, may comprise an active and/or movable and/or non-fixed structure. As discussed herein, clearance as defined, for example, by frame of the solar module 310, may dictate the movement profile of the fastener. As such, a track and/or tube, such as track 720 and/or tube 730, may be dynamically tilted dependent on the movement profile desired. In particular, greater clearance may allow for track 720 and/or tube 730 to be tilted upward (resulting in the fastener moving through the tube at a steeper angle), whereas less clearance results in the tube being tilted downward (resulting in the fastener moving through the tube at a less steep angle). In this regard, the structure to guide fastener to aligned hole 450 may comprise structure, whether active or passive, non-movable or movable, and/or fixed or non-fixed, that physically contacts the fastener along its path partly or entirely from the fastener receptacle to the aligned holes.

Force applicator 460 may work in conjunction with structure to guide fastener to aligned hole 450, and may generate one or more forces for moving the fastener along its path partly or entirely from the fastener receptacle to the aligned holes. Force applicator 460 may be configured to generate one or more types of forces, such as any one, any combination, or all of: a pneumatic force; a hydraulic force; a mechanical force; a magnetic force; an air force; or the like. Further, force applicator 460 may come in one or more forms, such as including: one or more motors (e.g., electric motor, pneumatic motor, hydraulic motor, or the like); one or more robotic systems; etc. In this regard, force applicator 460 may be manifested in one of several ways, such as illustrated in FIGS. 5A-B. Finally, the force generated by force applicator 460 may comprise a pushing force, a pulling force, or a combination of pushing forces and pulling forces.

In particular, FIG. 5A is a first expanded block diagram of the fastener insertion movement 430 of FIG. 4B. As shown in FIG. 5A, fastener insertion movement 430 includes passive/non-movable/fixed mechanical structure(s), such as track 720 and/or tube 730 in which the fastener may be inserted in order to guide the fastener partly (or entirely) from the fastener receptacle to the aligned hole. Further, FIG. 5A illustrates force applicator 460, which may be configured to generate or apply a force on the fastener along at least a part of its path from the fastener receptacle to the aligned hole. In particular, force applicator 460 may include any one, any combination, or all of: force applicator to insert fastener into the mechanical structure(s) 510 (e.g., a pushing and/or pulling force in order to remove the fastener from the fastener receptacle and insert the fastener into the track 720 and/or tube 730); force applicator to guide fastener along mechanical structure(s) 512 (e.g., a pushing and/or pulling force in order to move the fastener within track 720 and/or tube 730; in one embodiment, no exterior force is applied after the fastener is placed or pushed into track 720 and/or tube 730; alternatively, an exterior force, such as a force generated by a puff of air, may push the fastener through track 720 and/or tube 730); or force applicator to insert fastener into aligned hole 514 (e.g., fastener plunger 750, discussed below). In this regard, one or more forces, generated by force applicator 460, may be applied to passive/non-movable/fixed mechanical structure(s) 500.

FIG. 5B is a second expanded block diagram of the fastener insertion movement 430 in FIG. 4B. As shown in FIG. 5B, fastener insertion movement 430 includes active/movable/non-fixed mechanical structure(s) 520, such as gripper 113. Further, FIG. 5B illustrates force applicator 460, which may be configured to generate or apply a force on the fastener along at least a part of its path from the fastener receptacle to the aligned hole. In particular, force applicator 460 may generate one or more forces to control and/or guide mechanical structures (such as active/movable/non-fixed mechanical structure(s) 520) as the mechanical structures move along part or the entire path from the fastener receptacle to the aligned hole. As one example, force applicator 460 may comprise robotic system(s) 112 that works with a mechanical structure (such as gripper 113) in order to: remove the fastener from the fastener receptacle, move the fastener to and/or into the aligned holes, and apply a force in order for the fastener to be fully inserted into the aligned holes. Thus, in one or some embodiments, robotic system(s) 112 working with gripper 113 may solely be used to move the fastener from the fastener receptacle until the fastener is fully inserted into the aligned holes. Alternatively, robotic system(s) 112/113 may work with at least other external device(s), such as fastener plunger 750, in order to apply the force(s) along the fastener's path from the fastener receptacle to full insertion within the aligned holes. In this regard, one or more forces, generated by force applicator 460, may be applied to active/movable/non-fixed mechanical structure(s) 520.

As discussed above, different types of solar modules may have different clearances in which to guide the fastener into the aligned holes. FIG. 5C is a flow chart 540 for a computer-implemented method of determining a motion profile for the fastener and controlling movement of the fastener into the aligned holes according to the motion profile. At 550, controller(s) 414 determine the indication of clearance of the solar module in order to install the fastener. This determination may be made in one of several ways. In one way, an indication of a model and/or a type of solar module subject to installation may be input. The indication may be manually input, such as via an operator using user interface 412. Alternatively, or in addition, the indication may be automatically input, such as by using vision system(s) 140 to scan at least a part of solar module 310 to automatically identify the model or type of solar module 310 and/or to scan the amount of clearance of the solar module.

Regardless, at 560, the controller(s) 414 select, based on the indication of clearance, a predetermined motion profile along which the fastener is to travel in order to install the fastener into the aligned holes. The predetermined motion profile may be selected from a plurality of potential motion profiles that may be tailored to different types of solar modules. The predetermined motion profile may define controlled movements, in order to move the fastener into the aligned hole at a precise velocity and/or along a predetermined path that accounts for the clearance of the solar module (e.g., the C-shape of the frame of the solar module). The predetermined motion profile may thus provide the physical motion information and may graphically depict how the fastener insertion movement 430 may operate during the movement (e.g., in terms of any one, any combination, or all of position (e.g., in 2D space or 3D space), velocity, or acceleration) and may be used by the controller(s) 414 to determine what commands to send to the fastener insertion movement 430.

At 570, the controller(s) 414 automatically control the automatically controlled motive force device(s) such that the fastener follows the predetermined motion profile to install the fastener into the aligned holes.

FIG. 6 illustrates a perspective view of one example of a part of the solar module installation system, referenced as 600, for inserting a fastener (e.g., a first fastener or a first fastener part) through aligned holes of the solar module 310 and intermediate support structure 320 and for automatically coupling a threaded coupling 360 (e.g., a second fastener or a second fastener part) to the fastener 350. FIG. 7A illustrates another perspective view of the tool 600 of FIG. 6. In one or some embodiments, the tool 600 (for automatically inserting a fastener 350 through aligned holes of a solar module 310 and an intermediate support structure 320 and for automatically coupling a threaded coupling 360 to the fastener 350) may include a fastener insertion subassembly 610 and a fastener coupling subassembly 620. As described hereinafter in greater detail, the fastener insertion subassembly 610 may be configured to convey and place a fastener 350 in an installation position. In one or some embodiments, the installation position may be a position in which the body 351 of a fastener 350 extends through a hole of a solar module 310 and a hole 323 of the intermediate support structure 320. A head 352 of the fastener 350 may abut the flange 312 of the solar module 310 when the fastener 350 is in the installation position. Additionally, as described hereinafter in greater detail, the fastener coupling subassembly 620 may be configured to position a threaded coupling 360, for example, a collar, such that the threaded coupling 360 engages (e.g., abuts) the fastener 350 and rotates the threaded coupling 360, such that the threaded coupling 360 threadedly engages the fastener 350.

Referring to FIG. 7B a fastener insertion subassembly 610 is illustrated in accordance with one example of the present disclosure. As described above, the fastener insertion subassembly 610 may be configured to transport or convey a fastener 350, for example, a threaded pin, a bolt, a screw, a rivet, a nail, or the like, from a (e.g., fastener) receptacle, storing a plurality of fasteners 350, to an installation position. For example, the fastener insertion subassembly 610 may be configured to transport or convey a fastener 350 from the receptacle and position or place the fastener in an installation position. As noted above, the installation position may be a position in which the fastener extends through aligned holes of the solar module 310 and the intermediate support structure 320. For example, the fastener 350 may extend through a hole (e.g., a frame hole) disposed in the frame 311 of a solar module 10 and a hole (e.g., hole 323) disposed in the flange 322 of the intermediate support structure 320.

In accordance with some examples, as illustrated in FIG. 7B, the fastener insertion subassembly 610 may include a base 710 including a fastener delivery track 720, a fastener delivery tube 730, a fastener motion arm 740, and a fastener plunger 750. The base 710 of the fastener insertion subassembly 610 may include a fastener delivery track 720 along which fasteners 350 may be transported or conveyed to or toward their respective installation positions.

In accordance with some examples, as shown in FIG. 7B, the fastener insertion subassembly 610 may further include a fastener delivery tube 730 in communication with the fastener delivery track 720. The fastener delivery tube 730 may be configured to supply or provide fasteners 350 to the fastener delivery track 720. In accordance with some examples of the present disclosure, air pressure may be used to convey one or more fasteners 350 through the fastener delivery tube 730 (e.g., to the fastener delivery track). For example, air supplied to the fastener delivery tube 730 by a compressor or another device may be used to propel one or more fasteners 350 through the fastener delivery tube 730.

In one or some embodiments, the fastener insertion subassembly 610 may further include a receptacle (e.g., a fastener receptacle) configured to store a plurality of fasteners 350. In accordance with some examples, the fastener delivery tube 730 may extend between the receptacle and the fastener delivery track 720. Specifically, the fastener delivery tube 730 may be configured to transport or convey fasteners 350 from the receptacle to the fastener delivery track 720, for example, using compressed air.

In one or some embodiments, the fastener insertion subassembly 610 may be configured to receive a magazine storing a plurality of fasteners 350. The magazine may be configured to feed or supply the plurality of fasteners 350 to an installation position, for example, in which the fastener 350 extends through respective aligned holes of the solar module 310 and the intermediate support structure 320. In accordance with yet other examples of the present disclosure, the fastener insertion subassembly 610 may be configured to receive a belt storing a plurality of fasteners 350. The fastener insertion subassembly 610 may be configured to move the belt, moving a fastener 350 into position for insertion into respective aligned holes of the solar module 310 and the intermediate support structure 320.

In one or some embodiments, the fastener delivery track 720 and the fastener delivery tube 730 may collectively define a pathway along which a fastener 350 (e.g., first fastener), for example, a pin is moved or transported from a receptacle storing a plurality of fasteners 350 to an installation position (e.g., within respective holes of the solar module and the intermediate structure which are aligned).

In one or some embodiments, the fastener insertion subassembly 610 may further include a fastener motion arm 740 configured to push or slide one or more fasteners 350 along the fastener delivery track 720. Specifically, the fastener motion arm 740 may be configured to rotate from a first position (e.g., proximate to a first end of the fastener delivery track 720) to a second position (e.g., proximate to a second end of the fastener delivery track 720). According to the present disclosure, the fastener motion arm 740 may abut or contact a fastener 350, pushing or sliding the fastener 350 along the fastener delivery track 720 as the fastener motion arm 740 moves from the first position to the second position. According to some examples, the fastener installation subassembly may further include a pneumatic rotary actuator 741 configured to actuate or rotate the fastener motion arm 740.

In one or some embodiments, the fastener insertion subassembly 610 may further include a fastener plunger 750. The fastener plunger 750 may be disposed at or near a downstream end of the fastener delivery track 720. According to some examples, the fastener insertion subassembly 610 may include a cylinder mounting bracket 751 coupled to the base 710. The fastener plunger 750 may be coupled to the cylinder mounting bracket 751. The fastener plunger 750 may be configured to push a fastener 350 into an installation position. According to some examples, as illustrated in FIG. 7B, the fastener plunger 750 may be disposed at or near a downstream end of the fastener delivery track 720. According to some examples of the present disclosure, the fastener plunger 750 may be configured to move and push a fastener along an axis perpendicular to plane along which the fastener motion arm 740 moves. According to some examples, the fastener insertion subassembly 610 may further include a pneumatic cylinder 752 configured to move or actuate the fastener plunger 750. In this regard, the fastener 350 may be inserted into the aligned respective holes of the solar module 310 and the support structure via a plurality of pushing motions, such as at least a first pushing motion of the fastener 350 laterally using a fastener motion arm (e.g., fastener motion arm 740) in order to push the fastener closer to the aligned respective holes and at least a second pushing motion downward using a fastener plunger (e.g., fastener plunger 750) in order to push the fastener 350 so that the fastener 350 is entirely seated in the aligned respective holes.

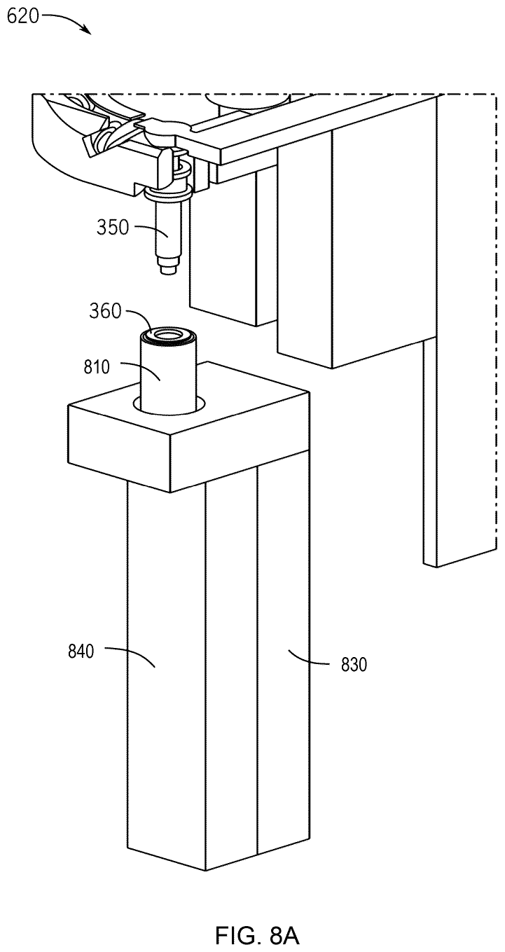

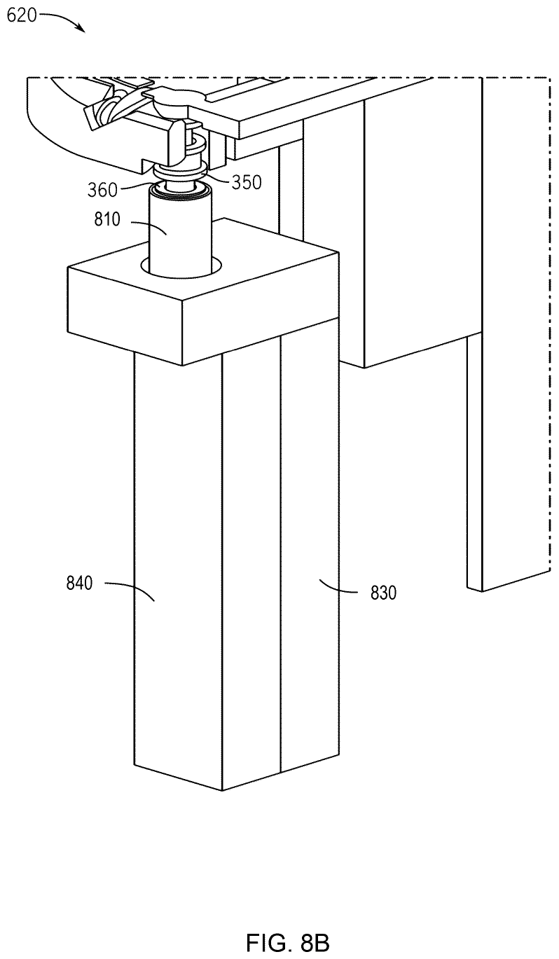

Referring to FIG. 8A, a fastener coupling subassembly 620 is illustrated in accordance with one example of the present disclosure. Specifically, FIG. 8A illustrates a fastener coupling subassembly 620 in a first position in accordance with one example of the present disclosure. As described above, the fastener coupling subassembly 620 may be configured to bring a threaded coupling 360 (e.g., second fastener) in contact with a fastener disposed in the installation position and couple or connect the fastener 350 and the threaded coupling 360.

In accordance with some examples of the present disclosure, the fastener coupling subassembly 620, specifically a socket 810 of the fastener coupling subassembly 620 may receive a threaded coupling 360 (e.g., a second fastener), for example, a threaded collar when the fastener coupling subassembly 620 is in the first position illustrated in FIG. 8A. According to some examples, a threaded coupling 360 may be provided to and placed in the socket 810 using one or more channels or pathways and a pneumatic system.

After receiving the threaded coupling 360, a linear slide 830 included in the fastener coupling subassembly 620 may move the socket 810 and the threaded coupling 360, such that the fastener coupling subassembly 620 is in the second position illustrated in FIG. 8B. The fastener coupling subassembly 620 may further include a pneumatic system configured to actuate the linear slide 830. While the solar module 310 and the intermediate support structure 320 have been omitted from FIGS. 8A-B to more clearly illustrate operation of the fastener coupling subassembly 620, the fastener 350, as illustrated in FIGS. 8A-B, is disposed in an installation position in which the fastener 350 extends through aligned holes of the solar module 310 and the intermediate support structure 320.

Specifically, as shown in FIG. 8B, in the second position, the threaded coupling 360 may contact or abut the fastener 350 disposed in an installation position. The fastener coupling subassembly 620 may further be configured to couple the fastener 350 and the threaded coupling 360. According to some examples, the fastener coupling subassembly 620 may further include a motor 840 configured to rotate the socket and the threaded coupling 360 relative to the fastener 350, threadedly coupling the fastener 350 and the threaded coupling 360. In accordance with some examples, the motor 840 may be an air gear motor (e.g., connected to a pneumatic system) for friction torquing the threaded coupling 360 to the fastener 350. In accordance with other examples, the motor 840 may be an electronic motor configured to rotate the socket 810 and threaded coupling 360.

Referring generally to FIGS. 6 and 7A, in accordance with some examples of the present disclosure, the tool 600 for inserting a fastener 350 (e.g., a first fastener) through aligned holes of the solar module 310 and intermediate support structure 320 and for automatically coupling a threaded coupling 360 (e.g., a second fastener) to the fastener 350 may further include a swaging gun or swaging assembly 640, a nut gun, or a rivet tool configured to deform or tighten the fastener 350 and/or the threaded coupling 360 preventing the fastener 350 and the threaded coupling 360 from being separated or de-couple from one another. Further, a channel 641, which may be present in the fastener coupling subassembly 620 or in the swaging gun or swaging assembly 640, may be configured to guide the threaded coupling 360 so that the threaded coupling 360 automatically contacts the fastener 350.

In accordance with some examples of the present disclosure, the fastener coupling subassembly 620 may include a rivet gun configured to grab the mandrel or stem of a blind rivet and pull the mandrel causing the body of the blind rivet to deform or tighten into a bulb, connecting the solar module 310 and the intermediate support structure 320.

In one or some embodiments, the tool 600 for inserting a fastener 350 (e.g., a first fastener) through aligned holes of the solar module 310 and the intermediate support structure 320 and for automatically coupling a threaded coupling 360 (e.g., a second fastener) to the fastener 350 may be implemented as an end of arm assembly tool for a robotic system. According to some examples, as illustrated in FIG. 7A, a connecting structure 630 may connect fastener insertion subassembly 610 and the fastener coupling subassembly 620. The connecting structure 630 may further include an arm mounting 631 for coupling the tool 600 to a robotic system, for example, as an end of arm assembly tool.

In accordance with other examples of the present disclosure, the tool 600 may be implemented as a handheld tool for inserting a fastener 350 (e.g., a first fastener) through aligned holes of a solar module 310 and an intermediate support structure 320 and automatically coupling the solar module 310 and the intermediate support structure 320. For example, a user may manually align the tool with aligned holes of a solar module 310 and an intermediate support structure 320 and actuate a user input device (e.g., button, trigger, or the like) causing the tool 600 to automatically insert a fastener 350 (e.g., first fastener) through the aligned holes and contact the fastener 350 automatically coupling the solar module 310 and the intermediate support structure 320.

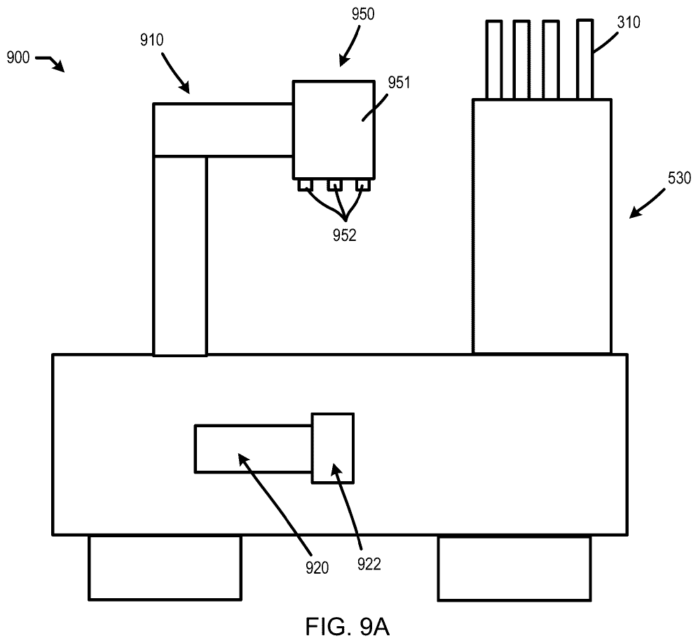

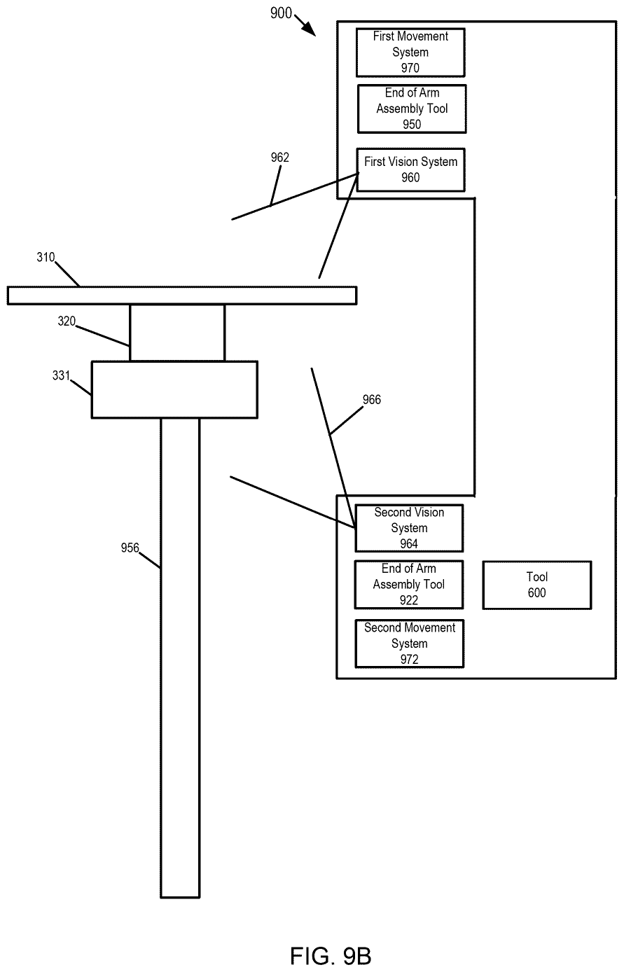

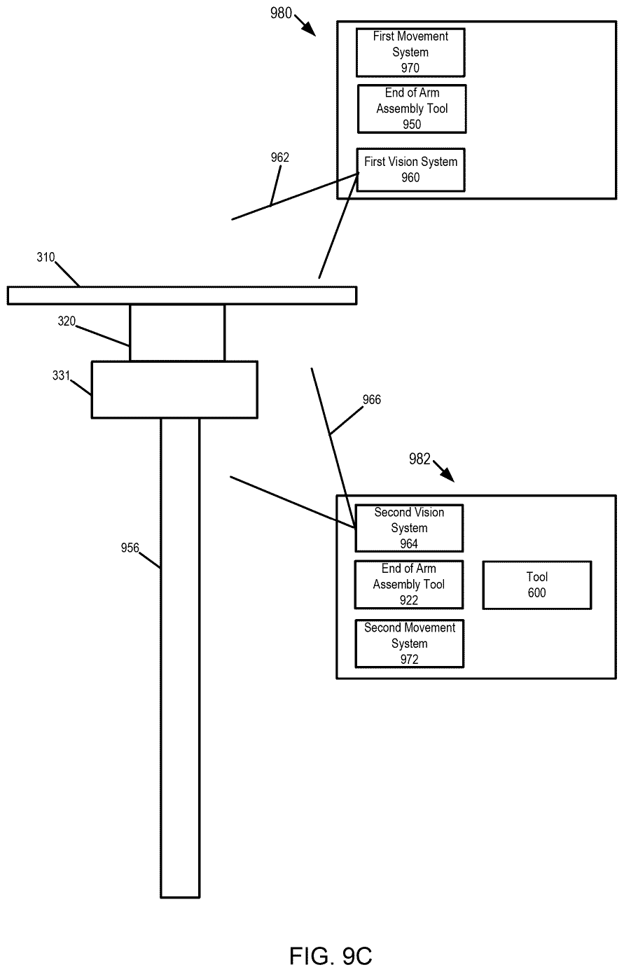

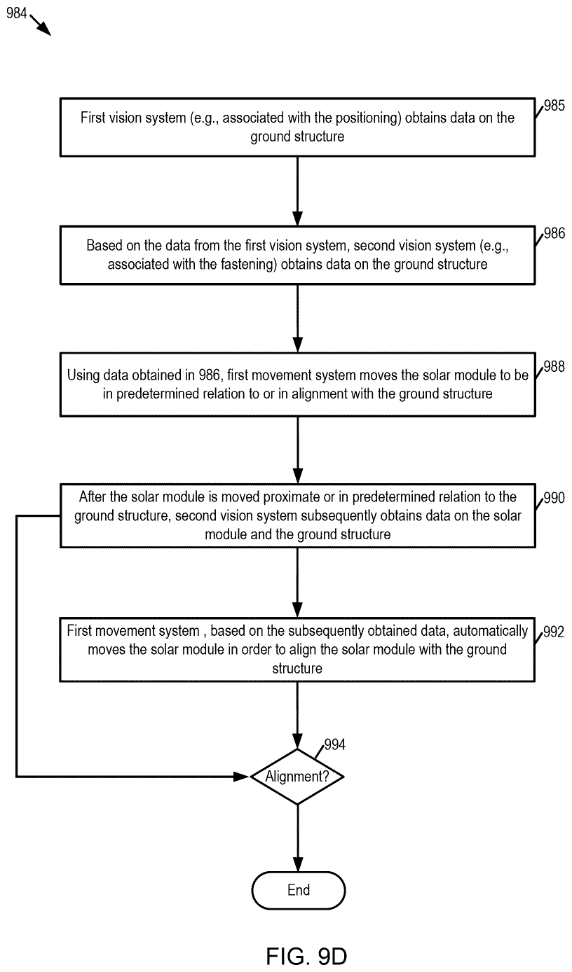

FIG. 9A illustrates a system 900 for automatically installing the solar module 310 and the intermediate support structure 320. In one particular example, the installation may be performed in two steps: (1) responsive to first vision system output of the position of one or both of the solar module 310 and the intermediate support structure 320, aligning/physically contacting the solar module 310 with the intermediate support structure 320; and (2) responsive to second vision system output of aligned holes of the solar module 310 and the intermediate support structure 320, fixedly connecting the solar module 310 with the intermediate support structure 320 (e.g., inserting a fastener into the aligned holes of the solar module 310 and the intermediate support structure 320; automatically contacting the fastener (e.g., with a collar and/or swaging; or swaging fastener).

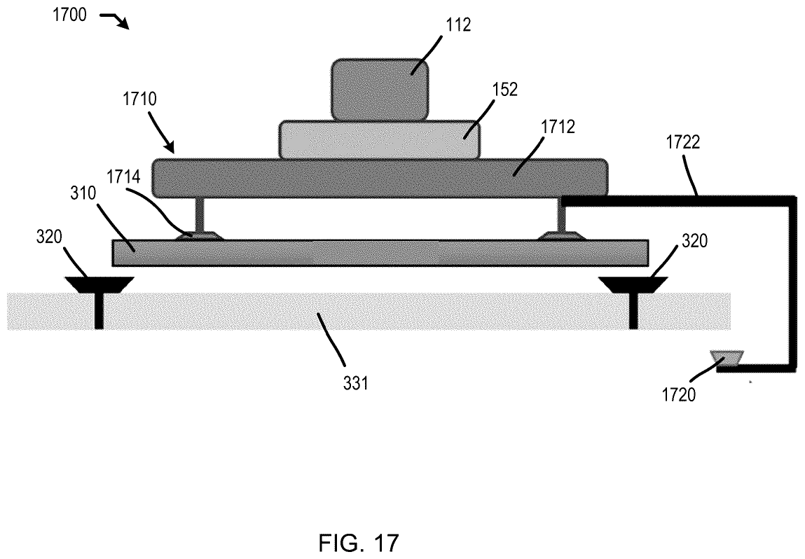

In order to perform (1) and (2), the system 900 may include two movement systems. In one or some embodiments, each movement system may comprise a respective robotic system. In particular, in one or some embodiments, first robotic system 910 may be configured to perform at least a part (or all) of (1). As one example, first robotic system 910 may be configured to perform all of the moving/aligning/physically contacting the solar module 310 with the ground structure (e.g., the intermediate support structure 320). Alternatively, first robotic system 910 may be configured to work in conjunction with another device (e.g., positioning stage 152, discussed further with regard to FIG. 17) in order to align the solar module 310 with the intermediate support structure 320. In one or some embodiments, second robotic system 920 may be configured to assist in performing (2), specifically to move a tool (such as tool 600) into predetermined position relative to the aligned holes. In turn, tool (such as tool 600) may fixedly connect the solar module 310 with the intermediate support structure 320. System 900 may further include a receptacle or cradle 930 configured to store a plurality of solar modules 310, from which first robotic system 910 is configured to take a solar module 310.

Further, each movement system (e.g., illustrated in FIG. 9B as first movement system 970 and second movement system 972, which may comprise, respectively, first robotic system 910 on its own or in combination with another system (such as positioning stage 152) and second robotic system 920) may work in conjunction with a respective vision system. As one example, first vision system 960 (illustrated in more detail in FIG. 9B) may provide the first vision system output of the position of one or both of the solar module 310 and the intermediate support structure 320. Using the first vision system output, first robotic system 910 (either alone or in combination with another device) may be used to align and/or physically contact the solar module 310 with the intermediate support structure 320. As another example, second vision system 964 (illustrated in more detail in FIG. 9B) may provide the second vision system output of the position of the aligned holes the solar module 310 and the intermediate support structure 320 (which may be supported by pile 956). Using the second vision system output, second robotic system 920 may move tool (such as tool 600) into a predetermined position relative to the aligned holes in order for tool to perform (2) (e.g., insert fastener into aligned holes and fixedly connect fastener to the solar module 310 and the intermediate support structure 320).

In one or some embodiments, the first robotic system 910 may include an end of arm assembly tool 1710, which may couple, attach, or temporarily connect to individual solar modules 310, so that the first robotic system 910 may move individual solar modules 310 from the cradle 930 to respective installation positions relative to an intermediate support structure 320, whereby the intermediate support structure 320 configured to couple the solar module 310 to a ground structure, as discussed above. The end of arm assembly tool 1710 may include a frame 1712 and one or more attachment devices 1714 (e.g., grippers and/or suction cups) coupled to the frame 1712.

Example attachment devices 1714 may include suction cups or other structures that may be releasably attached to the surface of the solar module 310 and, at least in the aggregate, maintain attachment during manipulation of the solar module 310 by the end of arm assembly tool 1710. The frame 1712 may comprise (or consist of) one or more trusses for providing structural strength and stability to the frame 1712. The frame 1712 may also function as a base for the solar module assembly tool 600 and other related components of the solar module handling system disclosed herein.

The attachment devices 1714 are configured to reliably attach to a planar surface such as, for example, a surface of a solar module 310, such as by using vacuum. In a suction cup embodiment, the suction cups may be actuated by pushing the cup against the planar surface, thereby pushing out the air from the cup and creating a vacuum seal with the planar surface. As a consequence, the planar surface may adhere to the suction cup with an adhesion strength that is dependent on the size of the suction cup and the integrity of the seal with the planar surface. In some examples, an air inlet provides air onto the planar surface when the planar surface is sealed to the suction cup so as to deactivate the vacuum and release the planar surface from the suction cup.

In one or some embodiments, the tool 600 for inserting a fastener 350 (e.g., a first fastener) through aligned holes of the solar module 310 and the intermediate support structure 320 and for automatically coupling a threaded coupling 360 (e.g., a second fastener) to the fastener 350 may be implemented as an end of arm assembly tool 922 for the second robotic system 920. Responsive to input from the second vision system 964 (see FIG. 9B), the second robotic system 920 may be configured to move the end of arm assembly tool 922 into position for connecting the solar module 310 and the intermediate support structure 320 (e.g., inserting pin(s) into aligned holes and attaching collar(s) to the pins; inserting rivet(s) and torquing).

As shown in FIG. 9A, the system 900 for automatically installing the solar module 310 and the intermediate support structure 320 may further include a receptacle or a cradle 930 configured to store a plurality of solar modules 310. In accordance with some examples, the cradle 930 may be configured to hold a plurality of solar modules 310 disposed in a vertical orientation. Further, the system 900 may include end of arm assembly tool 950, which may comprise housing 951 and holding structure 952 (e.g., suction cups and/or clamps and/or grippers).

FIG. 9B illustrates part of system 900. As shown, first movement system 970, end of arm assembly tool 1710 and first vision system 960 are positioned in the part of system 900 to be positioned above solar module 310 and intermediate support structure 320. In this way, first vision system 960, using beams 962 or the like, may view one or both of solar module 310 and intermediate support structure 320 from above in order to generate first vision system output. In turn, first movement system 970 may move the solar module, such as by manipulating end of arm assembly tool 1710 (which holds solar module 310), may likewise operate from above both of solar module 310 and intermediate support structure 320 in order to place solar module 310 onto intermediate support structure 320 (FIG. 9B shows solar module 310 after placement onto intermediate support structure 320).

FIG. 9B further illustrates second movement system 972, end of arm assembly tool 922, tool 600, and second vision system 964. In contrast to first vision system, 960, second vision system 964, using beams 966 or the like, operates from below both solar module 310 and intermediate support structure 320 from above in order to generate second vision system output. In turn, second movement system 972, manipulating end of arm assembly tool 922 (which holds tool 600), may likewise operate from below both of solar module 310 and intermediate support structure 320 in order to fixedly connect solar module 310 to intermediate support structure 320 (e.g., insert fastener into aligned holes of solar module 310 to intermediate support structure 320). In one or some embodiments, second movement system 972 may be configured to support one or multiple tools 600 (e.g., each respective tool 600 positioned at opposite ends of a bracket).

In contrast to FIG. 9B, FIG. 9C illustrates the different elements illustrated in FIG. 9B segmented in different autonomous vehicles 980, 982 (with first movement system 970, end of arm assembly tool 950, and first vision system 960 resident in autonomous vehicle 980 and second movement system 972, end of arm assembly tool 922, second vision system 964, and tool 600 resident in autonomous vehicle 982).

Thus, as illustrated in FIGS. 9B-C, multiple perception systems may be used, whether on a single autonomous vehicle (see FIG. 9B) or on multiple autonomous vehicles (see FIG. 9C). Regardless, in one or some embodiments, the multiple perception systems may operate independently regarding performing a respective task. As one example, in automatically picking the solar module 310 from the solar module holder(s) 114, the perception system associated with the positioning robot may act alone (and without any input from another perception system, such as the perception system associated with the fastening robot) to generate the sensor data used to automatically pick the solar module 310. As another example, in automatically performing any one, any combination, or all of positioning relative to, aligning with, or placing the solar module 310 on the ground structure, a single perception system (such as the perception system associated with the fastening robot may act alone (and without any input from another perception system) to generate the sensor data used to automatically position relative to, align with, and/or place the solar module 310 on the ground structure.

Alternatively, the multiple perception systems may act in combination in automatically performing the respective task. As one example, in automatically performing any one, any combination, or all of positioning relative to, aligning with, or placing the solar module 310 on the ground structure, multiple perception systems may act in combination. In one particular example, a first perception system associated with the positioning system and a second perception system associated with the fastening system may work in combination (e.g., the first perception system may obtain an image of the ground structure in order to identify, in a coarse manner, one or more aspects of the ground structure; the second perception system, using the image obtained by the first perception system, may obtain more finely identify the one or more aspects of the ground structure, as discussed further below). In this regard, in one or some embodiments, all of positioning relative to, aligning with, or placing the solar module 310 may be performed in combination using the multiple perception systems (e.g., the first perception system associated with the positioning system and the second perception system associated with the fastening system). Alternatively, all of positioning relative to, aligning with, or placing the solar module 310 may be performed using only a single perception system (e.g., a first perception system associated with the positioning system or a second perception system associated with the fastening system). Still alternatively, one or some of the actions of positioning relative to, aligning with, or placing the solar module 310 may be performed in combination using the multiple perception systems and a remainder may be performed using only a single perception system (e.g., positioning the solar module 310 relative to the ground structure is performed using the multiple perception systems whereas aligning is performed using only the second perception system associated with the fastening system).

Thus, in one or some embodiments, a respective task (e.g., positioning the solar module relative to or in alignment with the ground structure) may be performed in a coarse/fine manner. As one example, positioning the solar module relative to the ground structure may comprise a coarse determination of the aspect(s) of the ground structure (using the first perception system) followed by a finer determination (using the second perception system) of the aspect(s) of the ground structure. Alternatively, or in addition, performing across respective tasks may be in a coarse/fine manner. As one example, positioning the solar module relative to the ground structure may comprise a coarse determination. After which, aligning the solar module with the ground structure may comprise a fine determination.

Further, in one or some embodiments, the perception systems and/or the autonomous vehicles 980, 982 may coordinate with one another in order to act in combination. One particular example of which is illustrated in flow chart 984 in FIG. 9D. At 985, the first vision system 960 may obtain data on the ground structure (e.g., intermediate support structure 320). In particular, the first vision system 960 may generate data (e.g., an image) of the ground structure, which may be analyzed in order to identify (e.g., in 2D or 3D space) one or more aspects of the ground structure (e.g., an identification of a part, such as the intermediate support structure 320, a clamp, a rail, or the like; and/or an identification of an aspect of the part, such as holes or slots on the part). After which, this analysis and/or identification of aspect(s) of the ground structure may be used by the second vision system 964. For example, at 986, based on the data from the first vision system 960, the second vision system 964 may obtain data on the ground structure (e.g., intermediate support structure 320), such as a location of part or all of the ground structure in 2D or 3D space. In particular, the identification in 2D or 3D space by the first vision system may enable the second vision system 964 to focus its data collection on the 2D or 3D space (so that the data obtained by the second vision system 964 on the ground structure is more detailed or focused) and thereby improve the identification of the part(s) and/or the aspect(s) of the part(s)). Alternatively, the second vision system 964 may obtain data on the ground structure and identify (e.g., in 2D or 3D space) part(s) and/or aspect(s) of the part(s) of the ground structure without input from the first vision system 960.

At 988, such identification (e.g., the 2D or 3D space location) may then be used by first movement system 970 to move the solar module 310 to be in predetermined relation to or in alignment with the ground structure (e.g., the data on the ground structure may be processed by second vision system 964 to generate in 2D or 3D space data indicative of the holes on intermediate support structure 320 and transmitted to autonomous vehicle 980 for control of first movement system 970; alternatively, the data on the ground structure may be transmitted to autonomous vehicle 980 in order for first vision system 960 to process the data in order to generate in 2D or 3D space data indicative of the holes on intermediate support structure 320 for use by first movement system 970). In one or some embodiments, 986 may be performed prior to or after first vision system 960 obtaining data regarding solar modules in solar module holder(s) 114 in order for first movement system 970 to automatically pick the solar module. Further, in one or some embodiments, after 988 (whereby solar module is aligned with the ground structure), fastening, such as automatic fastening, may occur.

Thus, in one embodiment, the solar module 310 is moved immediately into alignment with the ground structure. Alternatively, the solar module 310 is moved close to or in near alignment with the ground structure. After which, the solar module 310 is moved into alignment (such as iteratively moving closer into alignment). This is illustrated in FIG. 9D in which, at 990, after the solar module 310 is moved proximate or in predetermined relation to the ground structure, second vision system 964 may subsequently obtain data on the solar module 310 and the ground structure (such as an image that includes both part or all of the solar module 310, such as the holes on the solar module, and part or all of the ground structure, such as holes (e.g., slots) on the intermediate support structure 320). In turn, at 992, first movement system 970, based on the subsequently obtained data, may move the solar module in order to align the solar module with the ground structure. At 994, it is determined whether alignment has occurred. If not, flow chart 984 loops back to 990 in order to iteratively perform alignment. If so, flow chart 984 ends in order to then perform the fastening, such as automatic fastening. Thus, using second vision system 964 may be iteratively performed, such as in iterative steps of coarse movement(s) and fine movement(s) (e.g., (1) from the solar module holder(s) 114 to coarsely move in predetermined relation to the ground structure; and refining to be in alignment; or (2) from the solar module holder(s) 114 to being coarsely in alignment with the ground structure; and refining to be in better alignment).

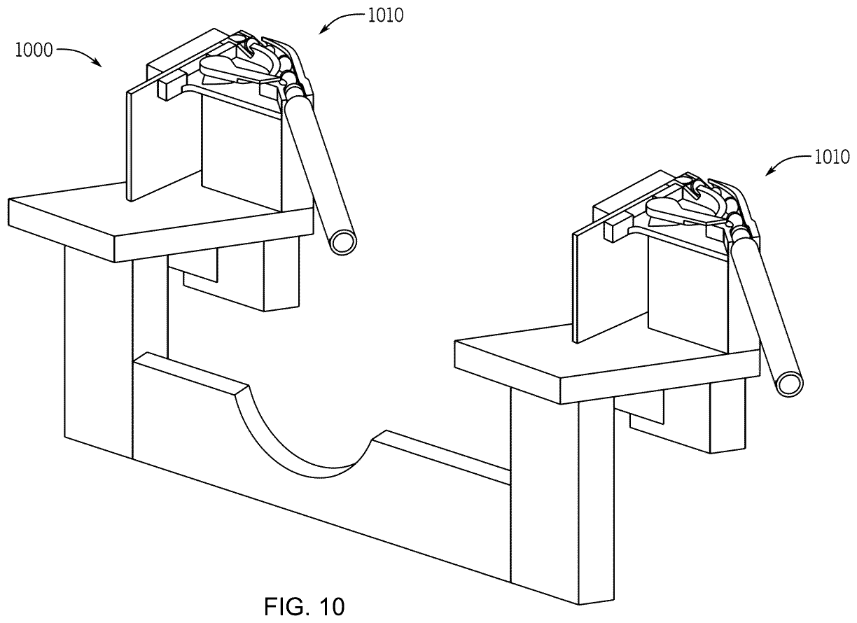

FIG. 10 illustrates an end of arm assembly tool 1000, which may include two tools 1010 for inserting a fastener (e.g., a first fastener) through aligned holes of the solar module 310 and intermediate support structure 320 and for automatically coupling a threaded coupling 360 (e.g., a second fastener) to the fastener 350.The end of arm assembly tool 1000 of FIG. 10 may simultaneously, automatically insert fasteners 350 through two different sets of aligned holes of the solar module 310 and the intermediate support structure 320 and simultaneously couple threaded couplings 360 to the pair of fasteners 350 extending through the two sets of aligned holes of the solar module 310 and the intermediate support structure 320.

Accordingly, the end of arm assembly tool 1000 may simultaneously perform parallel insertion of fasteners 350 through respective ones of a pair of aligned solar module 310 and intermediate support structure 320 holes. Accordingly, the end of arm assembly tool 1000 may reduce the required number of movements of a robotic system (e.g., second robotic system 920) configured to insert fasteners 350 through two sets of aligned holes of the solar module 310 and the intermediate support structure 320.

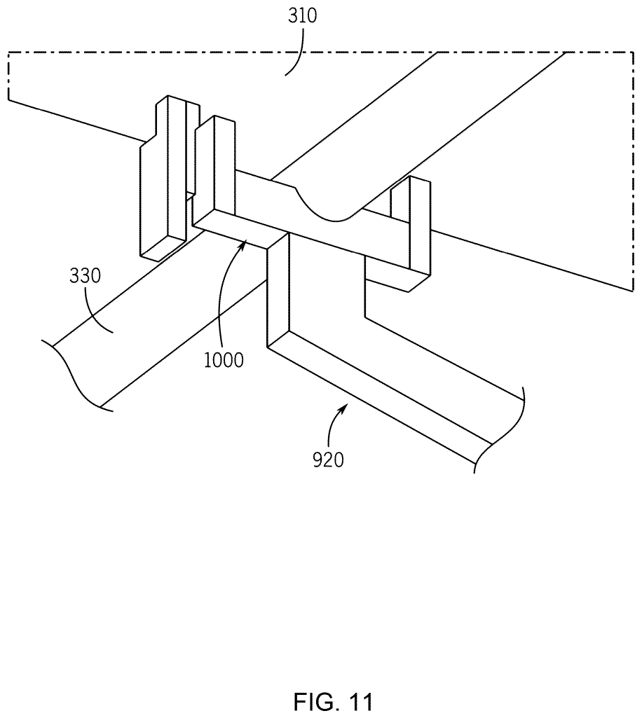

Referring to FIG. 11, an operation of installing a solar module 310 and an intermediate support structure 320 using a system 900 for automatically installing a solar module 310 and an intermediate support structure 320 and the end of arm assembly tool 1000 is illustrated in accordance with one example of the present disclosure.

In accordance with some examples of the present disclosure, as shown in FIG. 11, the intermediate support structure 320 may be installed on the underlying structure 330, for example, torque tube 331, when the solar module 310 and the intermediate support structure 320 are installed. For example, one or more intermediate support structures 320 may be coupled to the torque tube 331 at positions corresponding to final installation positions of one or more solar modules 310.

In one or some embodiments, the solar module 310 and the intermediate support structure 320 may be installed before the intermediate support structure 320 is coupled to the underlying structure 330. For example, the end of arm assembly tool 1710 may grab or couple to a solar module 310 stored in the cradle 930 and the solar module 310 and the intermediate support structure 320 may be installed at or near the cradle 930. For example, one or more tools 600 may insert a fastener 350 (e.g., a first fastener) through aligned holes of the solar module 310 and the intermediate support structure 320 and automatically couple a threaded coupling 360 (e.g., a second fastener) to the fastener 350.

In one or some embodiments, the solar module 310 and the intermediate support structure 320 may be installed as the solar module is moving away from a cradle storing a plurality of panels, for example, as the solar module is being moved toward an underlying structure 330 configured to support the solar module 310.

Referring to FIG. 12, a fastener insertion subassembly 1200 is illustrated in accordance with another example of the present disclosure. In one or more examples, the fastener insertion subassembly 1200 may include a picker 1210 configured to engage or grab a fastener 350 and move the fastener 350 to an installation position. Specifically, as shown in FIG. 12, the picker 1210 may include a pair of forks 1211 defining a cavity or recess configured to receive a body 351 of the fastener 350. Additionally, the pair of forks 1211 may be configured to engage or contact a head 352 of the fastener 350, lifting the fastener 350. In one or more examples, the picker 1210 may be configured to rotate so as to change an orientation of a fastener 350 held by the picker 1210. For example, the picker 1210 may rotate the fastener 350, such that the body 351 of the fastener 350 is horizontal or substantially horizontal, allowing the picker 1210 to place the fastener 350 in an installation position, for example, within respective aligned holes of a solar module 310 and an intermediate support structure 320, even when there is little space (e.g., space constraints in a vertical direction) for placement of the fastener 350. In this regard, the picker 1210 may follow a predetermined trajectory, such as discussed above, in order to move the fastener within the clearance of the solar module 310.

In one or some embodiments, the fastener insertion subassembly 1200 may include a vertical slide 1220 (configured to move the picker 1210 along a vertical axis) and/or a horizontal slide (configured to move the picker 1210 along a horizontal axis, such as a first horizontal axis). In one or some embodiments, the fastener insertion subassembly 1200 may include an additional horizontal slide configured to move the picker about an additional horizontal axis, for example, a second horizontal axis perpendicular to the first horizontal axis. In this way, the fastener 350 may be inserted into aligned holes of the solar module 310 and at least a part of the ground structure 1230.

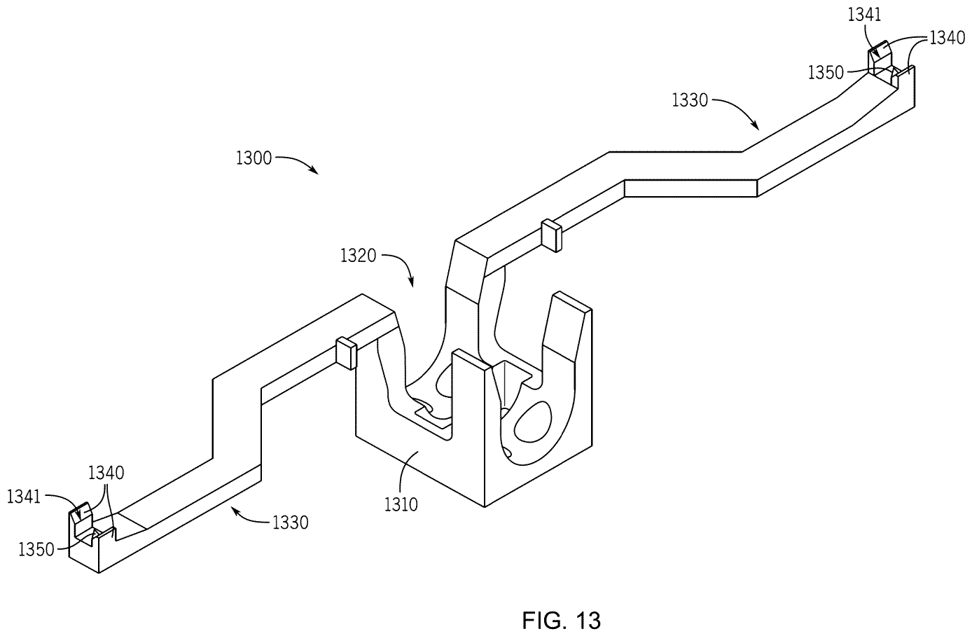

As discussed herein, one or more mechanical systems may be used in order to align the solar module with at least a part of the ground structure (e.g., the intermediate support structure 320). Examples may include any one, any combination, or all of the robotic system(s) 112, alignment system 130 (discussed further in FIG. 13), or positioning stage 152. Other mechanical structures are contemplated. As one example, robotic system(s) 112 may solely perform the alignment of the solar module to the ground structure. As another example, robotic system(s) 112 and positioning stage 152 may perform, in combination, the alignment of the solar module to the ground structure (e.g., robotic system(s) 112 may perform the coarse alignment and positioning stage 152 may perform the fine alignment). As still another example, robotic system(s) 112 and alignment system 130 may perform, in combination, the alignment of the solar module to the ground structure (e.g., robotic system(s) 112 may perform the coarse alignment and alignment system 130 may perform the fine alignment). In one or some embodiments, the mechanical alignment system(s) may work in combination with vision system(s) 140, such as one or more vision systems (e.g., in a closed-loop system), in order to perform the alignment of the solar module to the ground structure.

In this regard, in one or some embodiments, the solar module installation system 100 may include an alignment system 130. The alignment system 130 may be configured to perform alignment of the solar module 310 and the ground structure (e.g., so that respective holes on the solar module 310 and slots on the intermediate support structure 320 are aligned for insertion of a fastener therein). In one or some embodiments, the alignment system 130 may include mechanical vision/alignment 132 (an example of which is mechanical alignment tool 1300), with the alignment system configured to facilitate alignment of the solar module 310 and the intermediate support structure 320.

For example, FIG. 13 illustrates one example of the mechanical vision/alignment 132 as mechanical alignment tool 1300. The mechanical alignment tool 1300 may be configured to engage at least a part of a structure configured to support one or more solar modules 310. For example, the mechanical alignment tool 1300 may be configured to engage at least a part of the ground structure, such as the torque tube and/or the intermediate support structure 320. As discussed above, the intermediate support structure 320 may be coupled to the torque tube.

As shown in FIG. 13, the mechanical alignment tool 1300 may include a body 1310 including a cavity 1320. The cavity 1320 may be configured to engage the ground structure configured to support one or more solar modules 310. For example, the cavity 1320 may be configured to receive a torque tube of a ground structure for supporting one or more solar modules 310 and/or an intermediate support structure 320. In this regard, the cavity 1320, physically interfacing with (and receiving) the torque tube and/or an intermediate support structure 320, may be used as structure for the mechanical vision.

Additionally, as shown in FIG. 13, the mechanical alignment tool 1300 may include one or more arms, such as a pair of arms 1330. As discussed in more detail below, one or more structures on the arms 1330 may be used to perform one or both of: mechanical vision of the solar module 310; or alignment (with the intermediate support structure 320) of the solar module 310. The arms 1330 may extend from opposite sides of the body 1310. In one or some embodiments, a pair of tabs 1340 and a protrusion 1350 may extend from a top surface of each of the pair of arms 1330 at or near a distal end of the respective arm 1330. As discussed in more detail below, the tabs 1340 and/or the protrusion 1350 may be used for one or both of mechanical vision or alignment.

In one or more examples, the pair of tabs 1340 extending from a respective arm 1330 may face each one another so as to define an aperture 1341. The aperture 1341 may be configured to receive a frame 311 of the solar module 310. In one or some embodiments, an inner side of one or both of the pair of tabs 1340 facing the other of the pair of tabs 1340 may have an inclined or oblique surface such that an area of a mouth or top opening of the aperture 1341 is larger than an area at the aperture 1341 at the top surface of the arm 1330.

In one or some embodiments, each arm 1330 may further include a protrusion 1350 extending (e.g., upward) from a top surface of the arm 1330. In one or some embodiments, the protrusion 1350 may extend from a top surface of the arm 1330 between the pair of tabs 1340. In accordance with some examples of the present disclosure, the protrusion 1350 may be inserted into a corresponding opening disposed in an opposing part, such as the intermediate support structure 320 or the frame 311 of the solar module 310. In one or more examples, the protrusion 1350 may have a triangular or other shape such that a distal end of the protrusion 1350 (opposite the arm) is narrower or smaller than a proximal end of the protrusion 1350 at the top surface of the arm 1330. Accordingly, as a hole in a mating structure (whether the frame 311 or the intermediate support structure 320) receives the protrusion 1350, one or both of the protrusion 1350 or the hole may center itself, effectively causing alignment (e.g., the protrusion 1350 centers itself as it engages the hole; the hole (and mating structure in general) may center itself as it engages the protrusion 1350; or both the protrusion 1350 and the hole center themselves when engaging).

Thus, the mechanical alignment tool 1300 may mechanically contact with an opposing structure, such as one or both of a part of the solar module 310 (e.g., the frame 311 of the solar module 310) and/or the ground structure (e.g., the intermediate support structure 320). In one or some embodiments, the mechanical alignment tool 1300 is moved to physically contact the ground structure. In practice, the ground structure, such as the intermediate support structure 320, is already physically connected, and is effectively immovable (or has no appreciable movement) when physically contacted by the mechanical alignment tool 1300, such as the arms 1330 of the mechanical alignment tool 1300. In this regard, instead of the intermediate support structure 320 moving upon physical contact with the mechanical alignment tool 1300, the mechanical alignment tool 1300 moves or is guided by the aperture 1341. In practice, the mechanical alignment tool 1300 is moved by one or more motors (e.g., one or more robots moved by the one or more motors). The mechanical alignment tool 1300, under control of the one or more motors, may have, built in, sufficient slip or give so that when physically contacting the intermediate support structure 320, it is the mechanical alignment tool 1300 (such as the arms 1330) that is moved in one or more dimensions (e.g., in any one, any combination, or all of the x-dimension, y-dimension, z-dimension, or rotationally) so that the mechanical alignment tool 1300 physically contacts the intermediate support structure 320.

Alternatively, or in addition, the mechanical alignment tool 1300 and the solar module 310 are moved relative to one another to physically contact (e.g., the solar module 310 is moved to physically contact the frame 311 of the solar module 310 with the mechanical alignment tool 1300). In one or some embodiments, the solar module 310 may be movable (such as upon physical contact with the mechanical alignment tool 1300). In this regard, as the solar module 310 and the mechanical alignment tool 1300 makes physical contact with one another, the physical force of the mechanical alignment tool 1300 (in physically contacting the solar module 310) moves the solar module 310 (so that the solar module 310 effectively gives to or becomes aligned with the mechanical alignment tool 1300). For example, as the aperture 1341 receives the frame 311 of a solar module 310, the frame 311 may be moved or funneled to a center of the aperture 1341. Alternatively, the physical force of the mechanical alignment tool 1300 (in physical contacting the solar module 310) moves the mechanical alignment tool 1300 (so that the mechanical alignment tool 1300 effectively gives to the solar module 310). Still alternatively, the physical force of the mechanical alignment tool 1300 moves both the mechanical alignment tool 1300 and the solar module 310 (so that there is give in one or more dimensions for both the mechanical alignment tool 1300 and the solar module 310).

Thus, responsive to the mechanical alignment tool 1300 mechanically contacting the opposing structure (whether the intermediate support structure 320 or the frame 311 of the solar module 310), the controller 110 may determine the position and/or aspect information of the opposing structure (e.g., the position of the intermediate support structure 320; the position of the frame 311; the hole(s) on the intermediate support structure 320; the hole(s) on the frame 311). In this regard, the mechanical alignment tool 1300 may enable determination of position and/or aspect information in 2-D or 3-D space. Alternatively, or in addition, responsive to the mechanical alignment tool 1300 mechanically contacting the opposing structure, alignment of one or both of the intermediate support structure 320 or the solar module 310 may occur.

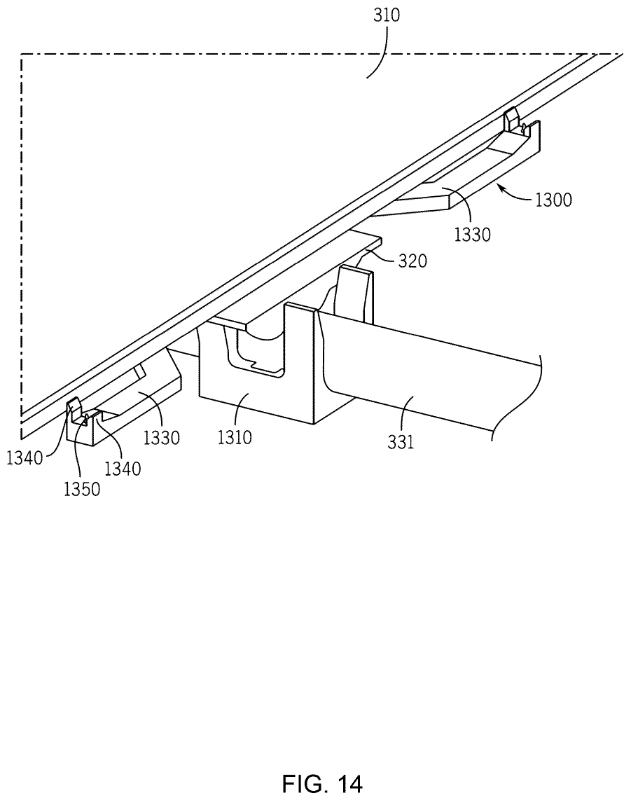

FIG. 14 illustrates the mechanical alignment tool 1300 engaging a support structure for one or more solar modules 310. As shown in FIG. 14, the cavity 1320 in the body 1310 of the mechanical alignment tool 1300 may be configured to receive the intermediate support structure 320 and the torque tube 331 of an underlying structure 330. In one or some embodiments, the body 1310 of the mechanical alignment tool 1300 may abut the intermediate support structure 320 positioning the arms 1330, and specifically, the apertures 1341 of the mechanical alignment tool 1300 in a correct position to receive the frame 311 of a solar module, such that respective holes in the intermediate support structure 320 and the solar module 310 are aligned.

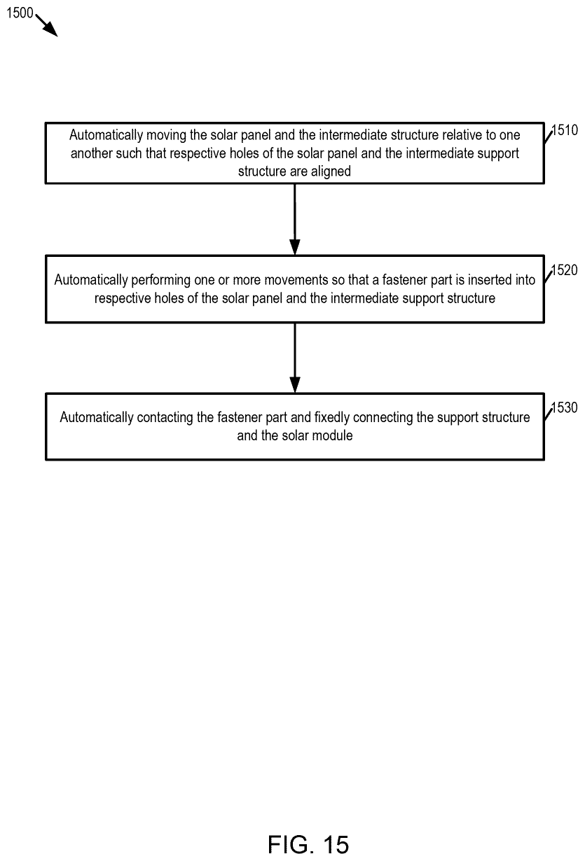

FIG. 15 is a flow chart 1500 for a computer-implemented method of automatically installing a solar module 310 and an intermediate support structure 320. Flow chart 1500 may be used, for example, with the system 900 for automatically installing a solar module 310 and an intermediate support structure 320. Additional, different, or fewer acts may be provided.

At 1510, a solar module 310 and an intermediate support structure 320 are automatically moved relative to one another so that the solar module 310 and the intermediate support structure 320 are in physical contact (e.g., only the solar module 310 is moved, only the intermediate support structure 320 is moved, or both the solar module 310 and the intermediate support structure 320 are moved).

Specifically, the solar module 310 and the intermediate support structure 320 may be brought into physical contact such that at least one pair of respective holes of the solar module 310 and the intermediate support structure 320 are aligned. In accordance with some examples, the solar module 310 may be moved relative to the intermediate support structure 320. For example, the end of arm assembly tool 1710 of the first robotic system 910 may grab and move the solar module 310 relative to the intermediate support structure 320, such that at least one pair of respective holes of the solar module 310 and the intermediate structure are aligned.

In accordance with other examples, the intermediate support structure 320 may be moved relative to the solar module 310 such that at least one pair of respective holes of the solar module 310 and the intermediate support structure 320 are aligned. In accordance with yet other examples, both the solar module 310 and the intermediate support structure 320 may be moved such that at least one pair of respective holes of the solar module 310 and the intermediate support structure 320 are aligned.

As discussed above, in one or some embodiments, a predicate step of alignment may comprise using vision, such as one or both of computer vision or mechanical vision. As one example, computer vision may be used to determine positions of one or both of the intermediate support structure 320 or the solar module 310. Based on the determined positions, automatically controlled robotics may move one or both of the intermediate support structure 320 or the solar module 310 (such as only the solar module 310) into alignment. As another example, computer vision may be used to determine positions of one or both of the intermediate support structure 320 or the solar module 310. Mechanical vision/alignment, using the determined positions from computer vision, may thereafter be used to perform one or both of more refined positions and perform the alignment of the intermediate support structure 320 and the solar module 310.

In one or some embodiments, the end of arm assembly tool 1710 of the first robotic system 910 may grab a solar module 310 from a cradle 930 and another robotic system may move the intermediate support structure 320 toward the solar module 310. The end of arm assembly tool 922 of the second robotic system 920 may then install the solar module 310 and the intermediate support structure 320 at or proximate to the cradle 930. In accordance with yet other examples, the solar module 310 and the intermediate support structure 320 may be installed as the solar module 310 and the intermediate support structure 320 are being moved, for example, toward an underlying structure 330.

At 1520, one or more movements are automatically performed so that at least one fastener is inserted into aligned holes of the solar module 310 and the intermediate support structure 320 (e.g., a first fastener, for example, fastener 350 is inserted into respective holes of the solar module 310 and the intermediate support structure 320 which are aligned; a single fastener is inserted into aligned holes of the solar module 310 and the intermediate support structure 320). In one or some embodiments, the fastener insertion subassembly 610 may insert the at least one fastener into the aligned holes of the solar module 310 and the intermediate support structure 320.

In one or some embodiments, the one or more movements for inserting the at least one fastener into the aligned holes of the solar module 310 and the intermediate support structure 320 may include conveying the first fastener through one or more fastener delivery structures, such as to a fastener delivery tube 730 to a fastener delivery track 720. In one or some embodiments, the fastener delivery tube 730 may be a pneumatic tube and compressed air may be used to convey the first fastener through the fastener delivery tube 730.

In one or some embodiments, the one or more movements for inserting the at least one fastener into the aligned holes of the solar module 310 and the intermediate support structure 320 may further include pushing the first fastener along the fastener delivery track 720 using a fastener motion arm 740.

In one or some embodiments, the one or more movements for inserting the at least one fastener (into the aligned holes of the solar module 310 and the intermediate support structure 320) may further include pushing the first fastener to an installation position, in which the first fastener extends through the aligned holes of the solar module 310 and the intermediate support structure 320 using a fastener plunger 750.

At 1530, the at least one fastener may be automatically contacted, fixedly connecting the intermediate support structure 320 and the solar module 310. In one or some embodiments, as part of the fixing process, a second fastener (e.g., a threaded coupling 360) and the first fastener may be automatically contacted with one another and connected. In one or some embodiments, the fastener coupling subassembly 620 may automatically bring the first fastener and the second fastener into contact and connect the first fastener and the second fastener, move one or both of the first fastener or the second fastener (e.g., twist the threaded coupling 360). Optionally, one or more other automatic actions may be performed for fixedly contacting the at least one fastener (e.g., swaging the threaded coupling 360). Alternatively, no second fastener is used. Instead, at least one automatic action is performed to bind or fix the solar module 310 and the intermediate support structure 320 together with the single fastener (e.g., automatically pulling the blind rivet using a rivet gun so that the body of the rivet deforms, tightens, or bulges).

In one or some embodiments, automatically contacting the fastener (e.g., the first fastener) and connecting the solar module 310 and the intermediate support structure 320 may include providing a second fastener into a socket 810 of the fastener coupling subassembly 620. In one or some embodiments, the second fastener may be placed into the socket using one or more channels or pathways. For example, a pneumatic tube and corresponding air compressor may be used to provide the second fastener into the socket 810.

In one or some embodiments, automatically contacting the fastener to connect the solar module 310 and the intermediate support structure 320 may result in connecting the solar module 310 and the intermediate support structure 320 (e.g., moving the second fastener relative to the first fastener). For example, a linear slide 830 may move the socket 810 and the second fastener, such that the second fastener is in contact with the first fastener. In one or some embodiments, the linear slide 830 may be pneumatically actuated.

In one or some embodiments, automatically contacting the fastener to connect the solar module 310 and the intermediate support structure may include rotating the socket 810 and the second fastener relative to the first fastener, thereby threadedly coupling the first fastener and the second fastener. In accordance with some examples of the present disclosure, a motor 840 may rotate the socket 810 and the second fastener connecting the first fastener and the second fastener. In accordance with some examples, the motor 840 may be an air gear motor configured to rotate the socket 810 and the second fastener. In accordance with other examples, the motor may be an electric motor configured to rotate the socket 810 and the second fastener.

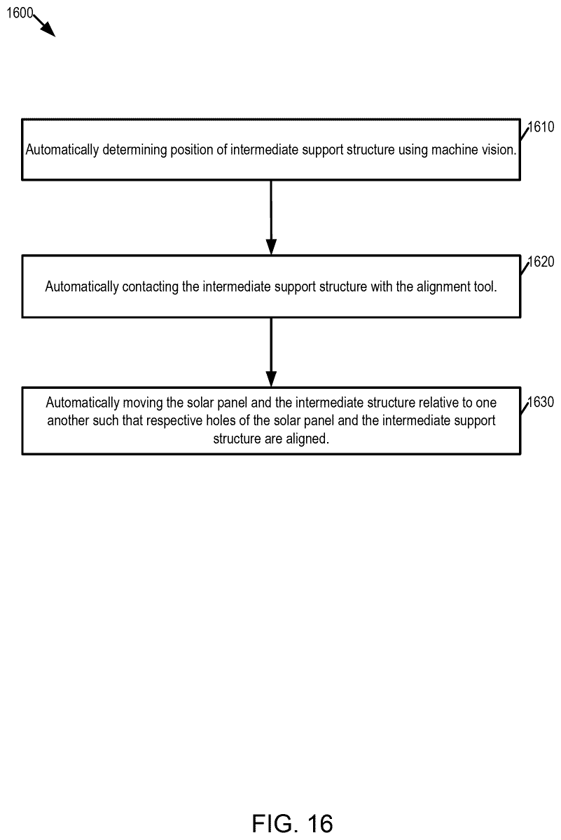

FIG. 16 is a flow chart 1600 for a computer-implemented method of automatically moving a solar module 310 relative to an intermediate support structure 320 such that respective holes of the solar module 310 and the intermediate support structure 320 are aligned in accordance with one example of the present disclosure. The flow chart 1600 may be used by the solar module installation system 100 and/or the system 900 for automatically installing a solar module 310 and an intermediate support structure 320 in accordance with one example of the present disclosure. Additional, different, or fewer acts may be provided.

At 1610, a position of the intermediate support structure 320 may be automatically determined using machine vision 131. For example, one or more sensors and/or cameras may collect sensor data and/or image(s), respectively, of the intermediate support structure 320. One or more computer systems, for example, controller(s) 110 may process and analyze the sensor data and/or images to determine a position of the intermediate support structure 320.

At 1620, an alignment tool 1300 may automatically be moved into contact with the intermediate support structure 320. In one or more examples, the mechanical alignment tool 1300 may be brought into contact with the intermediate support structure 320 using the position of the intermediate support structure 320 determined using machine vision 131. According to the present disclosure, the mechanical alignment tool 1300 may be coupled to a robotic system 112, as an end of arm assembly tool for aligning the solar module 310 and the intermediate support structure 320. The robotic system 112 may move the mechanical alignment tool 1300 such that the mechanical alignment tool 1300 contacts the intermediate support structure 320. For example, the robotic system 112 may move the mechanical alignment tool 1300 into the position illustrated in FIG. 14. In other words, the robotic system 112 may move the mechanical alignment tool 1300 to a position in which a cavity 1320 of the mechanical alignment tool 1300 receives the intermediate support structure 320 and a torque tube 331 of the underlying structure 330 and in which the body 1310 of the mechanical alignment tool 1300 contacts the intermediate support structure 320. The position of the mechanical alignment tool 1300 relative to the intermediate support structure 320, as shown in FIG. 14, may be a position in which the apertures 1341 of the mechanical alignment tool 1300 are in a position to receive a frame 311 of a solar module 310, such that, respective holes in the solar module 310 and the intermediate support structure 320 are aligned.

At 1630, the solar module 310 may be automatically moved relative to the intermediate support structure 320, such that respective holes of the solar module 310 and the intermediate support structure 320 are aligned. In accordance with some examples, an end of arm assembly tool 1710 may be coupled to a robotic system 112, for example, the first robotic system 910. The robotic system 112 may move the end of arm assembly tool 1710 into position to grab a solar module 310. For example, the robotic system 112 may move the end of arm assembly tool 1710, such that the end of arm assembly tool 1710 is brought into contact with a solar module 310 disposed in the cradle 930 for storing a plurality of solar modules 310. The end of arm assembly tool 1710 may grab or attach to the solar module 310 and the robotic system 112 may move the end of arm assembly tool 1710 and the solar module 310 and place the solar module 310 on the intermediate support structure 320 and the mechanical alignment tool 1300.

In one or some embodiments, the robotic system 112 may move the solar module 310 into position such that a frame 311 of the solar module 310 is disposed within the apertures 1341 of the mechanical alignment tool 1300. According to some examples, as described above, as the solar module 310 is placed, a respective pair of tabs 1340 may funnel the frame 311 of the solar module 310 to a center of the aperture.

Additionally, the robotic system 112 may place the solar module 310 in a position in which one or more holes disposed in the frame 311 of the solar module 310 receive a respective protrusion 1350 of the mechanical alignment tool 1300. According to some examples, as described above a protrusion 1350 of the mechanical alignment tool 1300 may center itself within a respective hole in the frame 311 as the solar module 310 is placed.

In one or some embodiments, after the solar module 310 is placed, one or more fasteners 350 may be inserted into the aligned holes of the solar module 310 and the intermediate support structure 320 and the one or more fasteners may be contacted, fixedly connecting the support structure and the solar module as described above in the flow chart 1500 of FIG. 15.

Returning to FIG. 1, in one or some embodiments, the solar module installation system 100 may include any one, any combination, or all of: vision system(s) 140; end of arm assembly tool(s) 150; and a positioning stage 152. The vision system(s) 140 may be configured to perform automatic inspection to identify aspects of the solar module 310 and/or one or more intermediate support structure(s) 320. The vision system(s) 140 may include one or more sensors configured to sense or detect one or more aspects (e.g., a position, whether an absolute position or a relative position) of one or both of: (i) the solar module 310; and (ii) the ground structure (e.g., one or more intermediate support structure(s) 320). For example, camera(s) may capture image(s) of one or both of: (i) the solar module 310; and (ii) one or more intermediate support structure(s) 320. In turn, computer system(s) may process and analyze the image(s) to determine various aspects, such as any one, any combination, or all of: a position of the intermediate support structure(s) 320; a position of the solar module 310; the position of the solar module 310 relative to the intermediate support structure(s) 320 (or vice versa); one or more features of the intermediate support structure(s) 320 (e.g., hole(s) in the intermediate support structure(s) 320); or one or more features of the solar module 310 (e.g., hole(s) in the solar module 310).

Thus, in one or some embodiments, one or more sensors (e.g., lidar sensors, capacitive sensors, cameras or the like) may generate sensor data, such as sensor data indicative of one or both of: one or more intermediate support structure(s) 320; or the solar module 310. As one example, cameras alone may generate the sensor data. Alternatively, cameras in combination with other types of sensors, such as one or both of lidar sensors or capacitive sensors, may generate the sensor data. Still alternatively, only other types of sensors may be used to generate the sensor data. Regardless, computer system(s), such as controller 110, may process and analyze the sensor data to determine various aspect(s) of the intermediate support structure(s) 320 and/or the solar module 310.

In one or some embodiments, the solar module installation system 100 may include multiple perception systems, such as multiple vision systems 140. In one or some embodiments, perception systems may generate sensor data that may be used in order to identify (such as place) features of the object under observation, such as aspects of the ground structure (e.g., holes (e.g., slots)) and/or aspects of the solar module (e.g., holes, corners, etc.). In one aspect, the identification may comprise position data (e.g., 2D or 3D spatial data and/or position data relative to another object). Further, in one or some embodiments, each of the vision systems 140 may include a different set or grouping of sensor(s) configured to sense or detect a position of one or both of: (i) the solar module 310; or (ii) one or more intermediate support structure(s) 320. In one or some embodiments, each of the vision system(s) 140 may be configured to sense different portions or aspects of one or both of: (i) the solar module 310; or (ii) the intermediate support structure(s) 320. For example, each of the vision system(s) 140 may sense one or both of the solar module 310 or the intermediate support structure(s) 320 from a different location or perspective.

In one or some embodiments, a first vision system 141 (an example of a perception system) may be different from a second vision system 142 (another example of a perception system) in one or more aspects, such as any one, any combination, or all of: which structure(s) are sensed; how the structure(s) are sensed (e.g., sensor is positioned above or below the structure being sensed); or a sequence of sensing (e.g., first vision system 141 sensed output is used as input for another system and prior to second vision system 142 performing its sense). For example, the first vision system 141 may be configured to sense or detect one or both of a solar module 310 or the intermediate support structure(s) 320 from above one or both of the solar module 310 or the intermediate support structure(s) 320. In one particular example, the first vision system 141 may be configured to perform any one, any combination, or all of: sense one or more aspects of the intermediate support structure(s) 320 from above the intermediate support structure(s) 320; sense the intermediate support structure(s) 320 before the solar module 310 is placed proximate to the intermediate support structure(s) 320; or provide the sensed aspect(s) of the intermediate support structure(s) 320 (e.g., its position) to another system (e.g., the robot that is moving the solar module 310 to the intermediate support structure(s) 320). In one or some embodiments, the second vision system 142 may be configured to sense or detect one or both of the solar module 310 or the intermediate support structure(s) 320 from below one or both of the solar module 310 or the intermediate support structure(s) 320.

In one or some embodiments, the first vision system 141 may include sensor(s) configured to sense or detect a position of the intermediate support structure(s) 320 (and optionally not solar module 310) and the second vision system 142 may include sensor(s) configured to sense or detect a position of both the solar module 310 and one or more intermediate support structure(s) 320. In one or some embodiments, computer system(s) may process and analyze the sensor data collected by the first vision system 141 to determine various aspects, such as one, or both of: a position of the intermediate support structure(s) 320; or one or more features of the intermediate support structure(s) 320 (e.g., hole(s) in the intermediate support structure 320). Computer system(s) may process and analyze the sensor data collected by the second vision system 142 to determine various aspects, such as any one, any combination, or all of: a position of the intermediate support structure(s) 320; a position of the solar module 310; the position of the solar module 310 relative to the intermediate support structure(s) 320 (or vice versa); one or more features of the intermediate support structure(s) 320 (e.g., hole(s) in the intermediate support structure 320); or one or more features of the solar module 310 (e.g., hole(s) in the solar module 310).

In this regard, the first vision system 141 may be configured to generate image(s) for analysis in order to move the solar module 310 proximate to at least a part of the ground structure (e.g., intermediate support structure 320). In one or some embodiments, proximity may be defined as being less than a first predetermined amount and/or no greater than a second predetermined amount (e.g., within a predefined range of the ground structure). Further, proximity may be defined with respect to a specific feature of the solar module 310 (e.g., a predetermined edge and/or predetermined side of the solar module). After moving the solar module 310 proximate to at least a part of the ground structure, another vision system, such as second vision system 142, may generate image(s) for analysis to move the solar module 310 into alignment with at least a part of the ground structure (e.g., aligning holes on the solar module 310 with holes on the intermediate support structure 320). In one or some embodiments, the image(s) generated by second vision system 142 include both of part (or all) of the solar module 310 and part (or all) of intermediate support structure 320 in the same image. Alternatively, second vision system 142 may generate separate images of part (or all) of the solar module 310 and part (or all) of intermediate support structure 320. Regardless, the image(s) generated by the second vision system 142 may be analyzed in order to perform the fine correction movement for the alignment. As such, the movement of the solar module 310 first proximate to and then in alignment with the ground structure may be considered a series of stages including a coarse stage (in which the solar module 310 is first moved proximate to the ground structure) and a subsequent fine stage (in which the solar module 310 is then moved into alignment with the ground structure). Such series of stages may thus be used in order to obtain the precise (e.g., less than 10 mm precision) desired.

As discussed above, separate perception systems, including first vision system 141 and second vision system 142, may be used in order to perform the separate stages, including the coarse stage and fine stage, for physical placement of the solar module 310 onto the ground structure. Alternatively, a single vision system may be used to perform the multiple stages, such as both the coarse stage and fine stage. For example, the single vision system may be used to first obtain image(s) of the ground structure in order to move the solar module 310 proximate to the ground structure. After which, the same single vision system may be used to generate additional image(s) (e.g., of both the solar module when proximate and the ground structure) in order to perform the fine stage alignment.

Thus, as discussed in more detail below, the vision system(s) 140 may facilitate alignment of the solar module 310 and intermediate support structure(s) 320 (e.g., so that respective holes included in the solar module 310 and the intermediate support structure(s) 320 are aligned for insertion of a fastener therein). In one or some embodiments, the vision system(s) 140 may facilitate alignment of the solar module 310 and the intermediate support structure(s) 320 in multiple stages or via multiple operations. In a particular example, as described hereinafter in greater detail, the vision system(s) 140 (e.g., a first vision system 141) may first sense or detect a position of the intermediate support structure(s) 320. The analysis of the sensor data indicative of a position of the intermediate support structure(s) 320 may be used as input to another device, such as a robotic system configured to move a solar module 310 (e.g., move the solar module 310 no greater than a predetermined distance away from the intermediate support structure(s) 320). After movement of the solar module proximate to the intermediate support structure(s) 320 (e.g., no greater than a predetermined distance away), the vision system(s) 140 (e.g., second vision system 142) may then sense or detect a position of the solar module 310 and the intermediate support structure(s) 320 (e.g., position of at least a part of the solar module 310 relative to at least a part of the intermediate support structure(s) 320, such as respective holes on both of the solar module 310 and the intermediate support structure(s) 320). In this regard, analysis of the sensor data indicative of a position of the solar module 310 and the intermediate support structure(s) 320 may be performed to determine a position of the solar module 310 relative to the intermediate support structure(s) 320. The determined position of the solar module 310 relative to the intermediate support structure(s) 320 may be used to align the solar module 310 and the intermediate support structure(s) 320 (e.g., so that respective holes included in the solar module 310 and the intermediate support structure 320 are aligned for insertion of a fastener therein).

The one or more sensors included in the vision system(s) 140 may be disposed in various locations. In one or some embodiments, one or more sensors included in the vision system(s) 140 may be disposed on or coupled to any one, any combination of, or all of: robotic system(s) 112 (e.g., first robotic system 910, second robotic system 920); an end of arm assembly tool 150 (e.g., end of arm assembly tool 1710, end of arm assembly tool 922, solar module installation tool 600 (which may comprise a part of the solar module installation system 100), end of arm assembly tool 1000, alignment tool 1300); a solar module holder 114; a mechanical support structure/motive force 120; or a positioning stage 152.

The end of arm assembly tool 150 may be configured to hold the solar module 310. For example, the end of arm assembly tool 150 may be the same as or substantially similar to the end of arm assembly tool 1710 as described above with respect to FIG. 9A. For example, the end of arm assembly tool 150 may include a frame 1712 and one or more attachment devices 1714 that may be releasably coupled to a surface of a solar module 310 and, at least in the aggregate, maintain attachment during manipulation of the solar module 310 by the robotic system(s) 112.

As discussed above, a sequence of position determination may comprise: (i) determining a position of at least a part of the ground structure (e.g., the first vision system 141 determining position of the intermediate support structure 320, such as information indicative of the position of the intermediate support structure 320); and (ii) after which determining a position of the solar module 310 relative to the ground structure (e.g., the second vision system 142 determining the position of the solar module 310 relative to the intermediate support structure 320, such as information indicative of the position of the solar module 310 relative to the intermediate support structure 320). More specifically, the determination with regard to (i) may be used to move the solar module 310 proximate to the ground structure, as discussed above. After which, the determination with regard to (ii) may be used to effectively fine-tune the placement of the solar module 310 relative to the ground structure (e.g., line up the holes of the solar module 310 with the holes in the intermediate support structure 320). In effect, the solar module may be at least (or at most) a predetermined distance away from the ground structure in the z-direction (with the z-direction being defined as perpendicular to the ground). Alignment of the solar module 310 with regard to the ground structure may thus be in the x-direction and/or y-direction and/or rotationally (e.g., moving the solar module 310 in the x-direction and/or y-direction and/or rotationally for alignment with holes in the intermediate support structure 320).

As discussed above, a solar module movement system may move the solar module 310 from cradle 930 to physical placement on the ground structure, such as the intermediate support structure 320. In one or some embodiments, a single device (or a single type of device), such as robotic system(s) 112, may comprise the solar module movement system. Alternatively, multiple devices (or multiple types of devices) may comprise the solar module movement system. As one example, robotic system(s) 112 and positioning stage 152 may be used to move the solar module 310 from the cradle to the physical placement on the ground structure, as discussed further below.

In one particular example of movement of the solar module 310 by the solar module movement system, accomplishing the alignment of the solar module 310 with the ground structure (e.g., the intermediate support structure 320) may be performed in one of several ways. In one way, a single device may perform the alignment. In another way, multiple devices may perform the alignment. As one example, robotic system 112 (which holds the solar module 310) may be tasked with: (a) moving the solar module 310 from the cradle 930 to the ground structure; and (b) aligning the solar module 310 with the ground structure. As such, responsive to the input from the second vision system 142, the robotic system 112, after moving the solar module 310 proximate to the ground structure, may make the fine-tuned movements for alignment. Alternatively, or in addition, a structure separate from the robotic system 112, such as positioning stage 152, may perform the fine-tuned movements for alignment (e.g., in the x-direction and/or y-direction and/or rotationally). In one particular case, in the event that the robotic system 112 is not configured for the fine-tuned movements for alignment, the positioning stage 152 may be configured to do so based on input from the second vision system 142. Alternatively, one or both of the robotic system 112 or the positioning stage 152 may perform the fine-tuned movements for alignment (e.g., one or both of the robotic system 112 or the positioning stage 152 may perform the rotational movement for alignment).

Further, the movements to perform the alignment (e.g., in the x-direction and/or y-direction and/or rotationally) and to perform the final placement (e.g., from the solar module 310 being a predetermined distance away from the ground structure to physically contacting the ground structure) may be performed serially or at least partly simultaneously. As one example, the alignment movements in the x-direction and/or y-direction and/or rotationally may be performed first. After which, the final downward movement in the z-direction may be performed to place the solar module 310 in physical contact with the intermediate support structure 320. As another example, the alignment movements in the x-direction and/or y-direction and/or rotationally may be performed as the final downward movement in the z-direction is performed. In this regard, the movement may be performed in two stages, with a first stage (e.g., the coarse stage) resulting in the solar module being proximate to at least a part of the ground structure (e.g., no greater than a first predetermined distance and/or no less than a second predetermined distance from the ground structure) and with a second stage (e.g., the fine stage) resulting in movement from being proximate to, to being in physical contact with and/or in alignment with the at least a part of the ground structure. In one or some embodiments, the second stage (e.g., the fine stage) may be performed in a single movement (e.g., the solar module alignment with and contact with the ground structure). Alternatively, the second stage may be performed in at least two distinct movement (e.g., a first movement performed to align the solar module alignment with the ground structure; after the first movement, a second movement performed to physically contact the aligned solar module with the ground structure).

Thus, one instance, depicted in FIG. 8A, uses a structure, separate from the robotic system 112 (e.g., positioning stage 152), to perform the fine-tune alignment. Specifically, the end of arm assembly tool 150 may be coupled to at least a part of robotic system 112, such as coupled to an end of the robotic system 112. The robotic system 112 may be configured to move the end of arm assembly tool 150 (and, in turn, the solar module 310 held by the end of arm assembly tool 150), such as proximate to the intermediate support structure(s) 320, discussed further below. After which, the positioning stage 152 may perform additional movements.

In particular, in one or some embodiments, the solar module installation system 100 may include a positioning stage 152, which may be disposed or positioned between the robotic system 112 and the end of arm assembly tool 150 (configured to hold the solar module 310). The positioning stage 152 may be configured to move the end of arm assembly tool 150 (e.g., move along an x-y plane, such as along an x-direction, along a y-direction, rotationally, or along both an x-direction and a y-direction). Alternatively, the positioning stage 152 may be configured to move the end of arm assembly tool 150 about three perpendicular axes (e.g., along the x-direction, the y-direction, rotationally, and/or the z-direction).

The positioning stage 152 may include one or more (e.g., linear) actuators configured to move the end of arm assembly tool 150 and/or a solar module 310 (held by the end of arm assembly tool 150). In one or some examples, the positioning stage 152 may include at least two actuators. For example, the positioning stage 152 may include a first (e.g., linear) actuator configured to move the end of arm assembly tool 150 and/or the solar module 310 along a first axis (e.g., the x-axis) and a second (e.g., linear) actuator configured to move the end of arm assembly tool 150 and/or solar module 310 along a second axis (e.g., perpendicular to the first axis, such as the y-axis).

The positioning stage 152 may be in communication with the controller(s) 110 of the solar module installation system 100. In one or some embodiments, the positioning stage 152 may receive control signal(s) from the controller(s) 110, such as for moving the end of arm assembly tool 150 and a solar module 310 (held by the end of arm assembly tool 150) (e.g., for alignment of the solar module 310 and the intermediate support structure(s) 320).

As discussed above, in one or some embodiments, alignment of the solar module 310 with respect to a part of the ground structure (e.g., slots in the intermediate support structure(s) 320) may be entirely performed by at least one robot (e.g., robotic system(s) 112). Alternatively, a positioning stage 152 may be used in combination with the at least one robot in order to perform the alignment (e.g., coarse alignment performed by the at least one robot; fine alignment performed by positioning stage 152). As such, referring back to FIG. 17, a partial view 1700 of a solar module installation system 100 is illustrated. In one or some embodiments, the end of arm assembly tool 150 (e.g., an end of arm assembly tool 150 configured to hold a solar module 310) may include a supporting bracket or arm 1722 extending from a frame (e.g., frame 1712) of the end of arm assembly tool 150 configured to support sensor(s) 1720. In one or some embodiments, the arm 1722 may be configured to support sensor(s) 1720 of the vision system(s) 140. In one or some embodiments, the arm 1722 may extend below a solar module 310 held by the end of arm assembly tool 150 (e.g., such that the sensor(s) 1720 is capable of sensing or detecting (e.g., a position of) the solar module 310 from below the solar module 310. As described hereinafter in greater detail, in one or some embodiments, the solar module 310, when held by the end of arm assembly tool 150, may be moved to be a predetermined distance from the intermediate support structure(s) 320 as a predicate step to aligning the solar module 310 with the intermediate support structure(s) 320. For example, the system may determine the intermediate support structure(s) 320 in space (such as 3D space). After which, the end of arm assembly tool 150 (while holding the solar module 310) may move so that the solar module 310 is proximate to, but not in complete alignment with, the intermediate support structure(s) 320. As one example, the solar module 310 may be moved so that the solar module 310 is within a predetermined range (e.g., be no greater than and/or no less than predetermined amounts) in each degree of freedom. In a particular example, the solar module 310 may be moved so that it is positioned above the intermediate support structure(s) 320 by a predetermined amount (e.g., approximately 2 inches above the intermediate support structure(s) 320; no greater than 4 inches and no less than 2 inches above the intermediate support structure(s) 320). After which, one or more images may be taken showing at least a part of the solar module 310 (e.g., alignment holes) and at least a part of the intermediate support structure(s) 320. Using the one or more images, the solar module 310 may then be aligned in the x-axis and y-axis (e.g., using positioning stage 152 so that the holes on the solar module 310 are aligned with corresponding holes on the intermediate support structure(s) 320). After the alignment in the x-and y-axes, the solar module 310 may then be moved in the z-axis in order to physically contact the intermediate support structure(s) 320 (e.g., by the end of arm assembly tool 150).

In the position of the solar module 310 proximate, one or more sensors, such as sensor(s) 1720, may then sense or detect the solar module 310 relative to the intermediate support structure(s) 320 (e.g., from a perspective above both of the solar module 310 and the intermediate support structure(s) 320 and/or from a perspective below both of the solar module 310 and the intermediate support structure(s) 320). After which, the solar module 310 may be moved (e.g., using positioning stage 152) into alignment with the intermediate support structure(s) 320 (e.g., stepwise in which alignment is first performed in x-and y-axis and/or rotationally, after which alignment is performed in the z-axis).

Thus, a solar module 310 and the intermediate support structure(s) 320 may be aligned in multiple stages or via multiple discrete operations. In one or some embodiments, a sequence for alignment of a solar module 310 and the intermediate support structure(s) 320 may include: (i) a first vision step of determining a position of the intermediate support structure(s) 320 (e.g., on which a solar module 310 is to be installed); (ii) movement (e.g., by a robotic system 112) of the solar module 310 to at least (or at most) a predetermined distance from the one or more intermediate support structure(s) 320; (iii) a second vision step of determining a position of the solar module 310 (disposed at least (or at most) a predetermined distance from the intermediate support structure(s) 320) relative to the intermediate support structure(s) 320 (or vice versa); (iv) adjusting a position of the solar module 310 relative to the intermediate support structure(s) 320 (e.g., by a positioning stage 152) such that respective holes in the solar module 310 and the intermediate support structure(s) 320 are aligned (e.g., moving the solar module 310 in the x-axis, y-axis, and/or rotationally so that corresponding holes on the solar module 310 and the intermediate support structure(s) 320 are aligned); and (v) moving the solar module 310 into contact with the intermediate support structure(s) 320 (e.g., by robotic system 112 moving the solar module 310 in the z-direction for physical contact). As discussed above, a solar module installation system 100 may include multiple vision systems 140. In one or some embodiments, a first vision system 141 may perform the first vision step (i) and a second vision system 142 may perform the second vision step (iii).

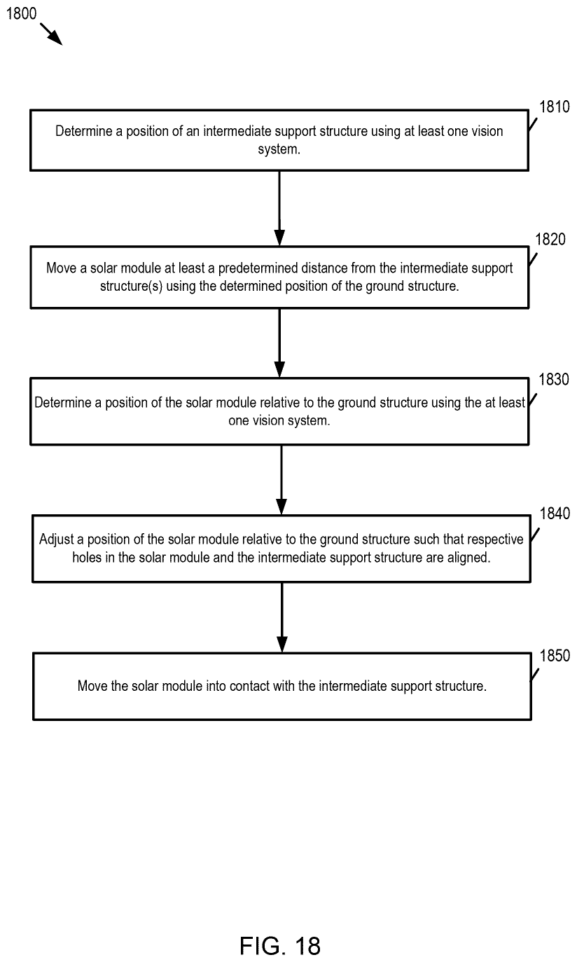

FIG. 18 is a flow chart 1800 for a method, such as a computer implemented method, of automatically moving the solar module 310 relative to the intermediate support structure(s) 320, such that respective holes of the solar module 310 and intermediate support structure(s) 320 are aligned (e.g., for insertion of a fastener therein). The flow chart 1800 may be used by the solar module installation system 100 and/or the system 900 for automatically installing a solar module 310 on the intermediate support structure(s) 320. Additional, different, or fewer acts may be provided.

At 1810, a position of the intermediate support structure(s) 320 may be automatically determined using a vision system 140. In one or some examples, a position of the intermediate support structure(s) 320 may be determined via first vision system 141. In one or some embodiments, the position of the intermediate support structure(s) 320 may be sensed or detected by sensor(s) (of the vision system 140) disposed above the intermediate support structure(s) 320.

At 1820, solar module 310 may be moved so as to be at least (or at most) a predetermined distance away from the intermediate support structure(s) 320. In one or some embodiments, robotic system 112 may move end of arm assembly tool 150 and solar module 310 (held by the end of arm assembly tool 150) such that the solar module 310 is at least (or at most) a predetermined distance away from the intermediate support structure(s) 320. In one or some embodiments, a position of the intermediate support structure(s) 320 determined at 1810 may be used to move the solar module 310 at least (or at most) a predetermined distance away from the intermediate support structure(s) 320.

At 1830, a position of the solar module 310 (e.g., disposed at least (or at most) a predetermined distance from the intermediate support structure(s) 320) relative to the one or more intermediate support structure(s) 320 may be automatically determined by the vision system 140. In one or some embodiments, the position of the solar module 310 relative to the intermediate support structure(s) 320 may be determined via second vision system 142. In one or some embodiments, the position of the solar module 310 relative to the intermediate support structure(s) 320 may be sensed or detected by sensor(s) (of the vision system 140) disposed below the solar module 310 and the intermediate support structure(s) 320.

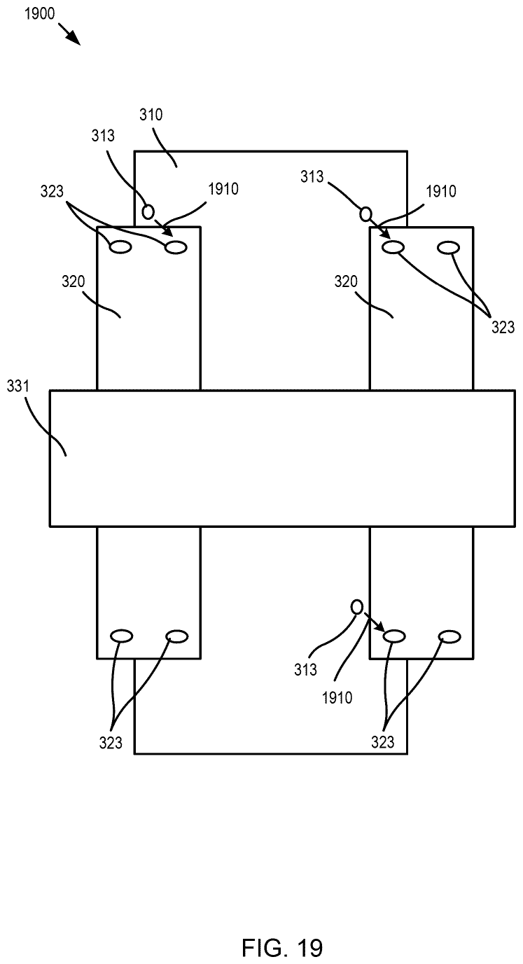

FIG. 19 is a view 1900 from below the solar module 310 and a pair of intermediate support structure(s) 320 (e.g., viewing upward from the ground), illustrating a position of a solar module 310 relative to the intermediate support structure(s) 320 as may be determined at 1830. Referring generally to FIG. 19, at 1830 the vision system 140 (e.g., second vision system 142) may determine an offset 1910 (an example of a deviation) between respective holes 323 in the intermediate support structure(s) 320 and holes 313 in the solar module 310 (e.g., with the offset 1910 indicating a direction of movement of the solar module 310 to move into alignment between respective holes 323 in the intermediate support structure(s) 320 and the holes 313 in the solar module 310). As discussed herein, the offset 1910 may be determined in one of several ways, such as a delta or a difference determined between 2D or 3D positions for the respective holes 323 in the intermediate support structure(s) 320 and holes 313 in the solar module 310. In one or some embodiments, the vision system 140 may determine the offset between respective holes 323 in the intermediate support structure(s) 320 and the holes 313 in the solar module 310 in a horizontal plane.

Returning back to FIG. 18, at 1840, a position of the solar module 310 may be adjusted in one of several ways, such as by using the positioning stage 152 such that respective holes in the solar module 310 and the intermediate support structure(s) 320 are aligned. The position of the solar module 310 relative to the intermediate support structure(s) 320 and/or an offset 1910 between respective holes in the solar module 310 and the intermediate support structure(s) 320 determined in 1830 may be used to move the solar module 310 such that respective holes in the solar module 310 and the intermediate support structure(s) 320 are aligned (e.g., for insertion of fastener(s) therein). In one or some embodiments, at 1840, the positioning stage 152 may move the end of arm assembly tool 150 and thus a solar module 310 held by the end of arm assembly tool about a plane (e.g., a horizontal plane), as described above. As one example, determining the offset 1910 may be performed once; after which, the solar module 310 is moved into alignment with the intermediate support structure(s) 320. As another example, determining the offset 1910 may be performed iteratively in which an image is taken of the respective holes in the solar module 310 and the intermediate support structure(s) 320, the offset 1910 is determined, the solar module 310 is moved, and the process is repeated (image taken, offset 1910 determined, solar module 310 moved) until the image indicates alignment of the respective holes in the solar module 310 and the intermediate support structure(s) 320. In one example, alignment may comprise at least a predetermined percentage of overlap of respective holes (e.g., at least 50% overlap of hole(s) 313 in the solar module 310 overlapping holes 323 in the intermediate support structure(s) 320 and/or vice-versa).

At 1850, after alignment, the solar module 310 is moved into physical contact with the intermediate support structure(s) 320. In one or some embodiments, the robotic system 112 may move the end of arm assembly tool 150 and a solar module 310 (held by the end of arm assembly tool 150) such that the solar module 310 is brought into physical contact with the intermediate support structure(s) 320. In one or some embodiments, robotic system 112 may move the solar module 310 in the z-direction the at least a predetermined distance between the solar module 310 and the one or more intermediate support structure(s) 320, such that the solar module 310 and the intermediate support structure(s) 320 are brought into physical contact. In one or more embodiments, 1850 may be performed such that the solar module 310 is brought into contact with the one or more intermediate support structure(s) 320 (e.g., lowered in the z-direction) after a position of the solar module 310 is adjusted by the positioning stage 152. In accordance with other examples, 1840 and 1850 may be performed at least partly (or entirely) concurrently, such that a robotic system 112 brings the solar module 310 into physical contact with the intermediate support structure(s) 320 while the positioning stage 152 adjusts a position of the solar module 310. Alternatively, the physical movement of the solar module 310 in the z-direction may be performed manually, such as by an operator (who may also perform or control the fastening).

FIG. 20 illustrates a flow chart 2000 for automatically fastening a solar module to at least part of the ground structure. At 2010, the fastening system may determine whether there is an indication (e.g., an input) that the solar module has been placed in alignment on the ground structure. In one instance where the solar module is automatically moved into alignment and placed on the ground structure, the indication may be received automatically from the positioning system. In another instance where the solar module is manually placed (whether manually placed after automatic alignment or entirely manually placed), the indication may be received manually via an input from an operator.

Responsive to the indication, at 2012, the fastening system may automatically access position information (e.g., 2D or 3D space data) indicative of the aligned holes on the solar module and the ground structure. In one or some embodiments, the position information was generated as part of the alignment process (e.g., by the perception system associated with the fastening system). In this regard, such position information may be stored in a memory and then accessed as part of the fastening process. Thus, reusing the position information connects the positioning and fastening processes. Alternatively, such as in the instance where delta is used to determine alignment, the position information may be generated by the fastening system as part of the fastening process. In particular, the perception system associated with the fastening system may generate sensor data (e.g., an image of the aligned holes), analyze the sensor data to generate the position data of the aligned holes, and store in memory the position data for later accessing. However, even when the fastening system generates the position data in such an instance, action(s) performed during the automatic alignment process connects the positioning and fastening processes. In particular, during the alignment process, the perception system associated with the fastening system is modified (e.g., the camera(s) of the perception system associated with the fastening system are focused or moved to point to the aligned holes; the perception system previously identified the aligned holes in generating the delta, which may be used to identify the holes in 2D or 3D space thereafter). At 2014, the fastening system may automatically move the fastening tool (e.g., see FIGS. 8A-B) based on the position data. In one or some embodiments, the fastening tool, as part of the fastening system, may comprise a movable portion in order to move to (or proximate to) the aligned holes.

After which, at 2016, the fastening tool may automatically route (such as along an at least partly non-linear path, such as a curved path) the fastener, which is in the predetermined orientation, into the aligned holes (e.g., the fastener follows an at least partly curved path on one end as the opposite end is at least partly or fully inserted into the aligned holes). As discussed above, it may be difficult to insert the fastener into the aligned holes due to limited clearance for the solar module. Thus, to enable the insertion, in one or some embodiments, the fastening tool may include hardware, such as a channel, in order to route the fastener into the aligned holes. In practice, after routing the fastener toward the aligned holes, the channel may curve resulting in the fastener falling, such as by gravity, into the aligned holes. After which, a force may be applied to one end of the fastener in order to fully seat the fastener into the aligned holes. In the instance of different solar modules with different clearances, the fastening tool may include different hardware to accommodate the different clearances. As such, the fastening tool may be configured to switch hardware to tailor the routing to different clearances. Alternatively, a robot, such as picker 1210, may be used in order to insert the fastener into the aligned holes. In one or some embodiments, the path that the robot guides the fastener into the aligned holes may be based on a look-up table (e.g., a look-up table that correlates identifying information with respective paths). In particular, the system may scan the solar module for identifying information or receiving operator input identifying information for the solar module 310 (e.g., a serial number, manufacturer/model, etc.), and may access the look-up table to identify the respective path correlated to the identifying information. Alternatively, the perception system may scan the clearance of the solar module in order to dynamically identify a path for the robot.

After which, at 2018, the fastening system automatically fastens the solar module to the ground structure. In one or some embodiments, to permanently or semi-permanently fasten the solar module comprises performing at least one action to the fastener inserted into the aligned holes. In the instance of a pin as the fastener, one or both of a collar may be screwed onto the pin or the pin (or pin/collar) may be swaged. In the instance of a rivet, the rivet may be torqued.

FIG. 21 is a diagram of an exemplary computer system 2100 that may be utilized to implement methods described herein. A central processing unit (CPU) 2102 is coupled to system bus 2104. The CPU 2102 may be any general-purpose CPU, although other types of architectures of CPU 2102 (or other components of exemplary computer system 2100) may be used as long as CPU 2102 (and other components of computer system 2100) supports the operations as described herein. Those of ordinary skill in the art will appreciate that, while only a single CPU 2102 is shown in FIG. 21, additional CPUs may be present. Moreover, the computer system 2100 may comprise a networked, multi-processor computer system that may include a hybrid parallel CPU/GPU system. The CPU 2102 may execute the various logical instructions according to various teachings disclosed herein. For example, the CPU 2102 may execute machine-level instructions for performing processing according to the operational flow described herein.

The computer system 2100 may also include computer components such as non-transitory, computer-readable media. Examples of computer-readable media include computer-readable non-transitory storage media, such as a random-access memory (RAM) 2106, which may be SRAM, DRAM, SDRAM, or the like. The computer system 2100 may also include additional non-transitory, computer-readable storage media such as a read-only memory (ROM) 2108, which may be PROM, EPROM, EEPROM, or the like. RAM 2106 and ROM 2108 hold user and system data and programs, as is known in the art. In this regard, computer-readable media may comprise executable instructions cause the system 900 for automatically installing a solar module 310 and an intermediate support structure 320 to perform any one, any combination, or all of the blocks in the flow charts of FIGS. 2P, 5C, 15, 16, 18, and 20. The computer system 2100 may also include an input/output (I/O) adapter 2110, a graphics processing unit (GPU) 2114, a communications adapter 2122 (e.g., a communication interface), a user interface adapter 2124, a display driver 2116, and a display adapter 2118.

The I/O adapter 2110 may connect additional non-transitory, computer-readable media such as storage device(s) 2112, including, for example, a hard drive, a compact disc (CD) drive, a floppy disk drive, a tape drive, and the like to computer system 2100. The storage device(s) may be used when RAM 2106 is insufficient for the memory requirements associated with storing data for operations of the present techniques. The data storage of the computer system 2100 may be used for storing information and/or other data used or generated as disclosed herein. For example, storage device(s) 2112 may be used to store configuration information or additional plug-ins in accordance with the present techniques. Further, user interface adapter 2124 couples user input devices, such as a keyboard 2128, a pointing device 2126 and/or output devices to the computer system 2100. The display adapter 2118 is driven by the CPU 2102 to control the display on a display device 2120 to, for example, present information to the user such as images generated according to methods described herein.

The architecture of computer system 2100 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 2100 may include various plug-ins and library files. Input data may additionally include configuration information.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

The following example embodiments of the invention are also disclosed:

### Embodiment 1

A computer-implemented method of automatically fastening a solar module to ground structure, the method comprising:
responsive to receiving an indication that the solar module has been placed in alignment on the ground structure:
   automatically accessing position information indicative of aligned holes on the solar module and the ground structure;
   automatically moving a fastener tool based the position information;
   automatically routing, along a nonlinear path, a fastener in a predetermined orientation into the aligned holes on the solar module and the ground structure; and
   automatically fastening, using at least one fastening robotic system, the solar module to the ground structure.

### Embodiment 2

The method of embodiment 1:
wherein the position information is 2D or 3D space data indicative of the aligned holes; and
wherein the solar module is automatically placed in to alignment on the ground structure using the 2D or 3D space data.

### Embodiment 3

The method of embodiments 1 or 2:
wherein the solar module includes a space through which to route the fastener, wherein clearance of the space is less than a length of the fastener; and
further comprising determining a curved path by which to insert the fastener into the aligned holes by:
   analyzing indicia of the solar module; and
   selecting, based on the indicia of the solar module, the curved path from a plurality of predetermined paths.

### Embodiment 4

The method of any of embodiments 1-3:
wherein the solar module includes a space through which to route the fastener, wherein clearance of the space is less than a length of the fastener;
further comprising determining a curved path by which to insert the fastener into the aligned holes by:
   scanning at least a part of the space; and

### Embodiment 5

The method of any of embodiments 1-4:
wherein the solar module includes a space through which to route the fastener, wherein clearance of the space is less than a length of the fastener; and
wherein automatically routing the fastener into the aligned holes comprises routing the fastener in the predetermined orientation via a tube or a track in order to guide the fastener through the space into the aligned holes.

### Embodiment 6

The method of any of embodiments 1-5:
wherein automatically routing further comprises, after the fastener is partially inserted into the aligned holes, applying additional force to an end of the fastener in order to seat the fastener entirely into the aligned holes.

### Embodiment 7

The method of any of embodiments 1-6:
wherein the solar module includes a space through which to route the fastener, wherein clearance of the space is less than a length of the fastener; and
wherein automatically routing the fastener into the aligned holes on the solar module and the ground structure comprises using at least one robot with a gripper in order to guide the fastener through the space into the aligned holes.

### Embodiment 8

The method of any of embodiments 1-7:
wherein automatically routing the fastener comprises automatically performing one or more movements so that the fastener is inserted into the aligned respective holes of the solar module and the ground structure includes automatically conveying the fastener from a fastener delivery track, feeding the fastener from a receptacle, or moving a belt storing a plurality of the fasteners.

### Embodiment 9

The method of any of embodiments 1-8:
wherein automatically performing the one or more movements so that the fastener is inserted into the aligned respective holes of the solar module and the ground structure comprises at least a first pushing motion of the fastener laterally using a fastener motion arm in order to push the fastener closer to the aligned respective holes and at least a second pushing motion downward using a fastener plunger in order to push the fastener so that the fastener is entirely seated in the aligned respective holes.

### Embodiment 10

The method of any of embodiments 1-9:
wherein automatically routing the fastener comprises automatically performing one or more movements so that the fastener is inserted into respective aligned holes of the solar module and the ground structure includes using at least one robotic system to push the fastener so that the fastener is entirely seated in the aligned respective holes.

### Embodiment 11

A system configured to automatically fasten a solar module to ground structure, the system comprising:
fastening tool configured to route a fastener and to fasten the fastener;
at least one motor configured to move at least a part of the fastening tool; and
at least one controller in communication with the at least one motor, the at least one controller configured to:
   responsive to receiving an indication that the solar module has been placed in alignment on the ground structure:
      automatically access position information indicative of aligned holes on the solar module and the ground structure;
      automatically control, based the position information and using the at least one motor, the fastening tool to move the at least a part of the fastener tool;
      automatically control the fastener tool to route, along a nonlinear path, the fastener in a predetermined orientation into the aligned holes on the solar module and the ground structure; and
      automatically control the fastening tool to fasten the solar module to the ground structure.

### Embodiment 12

The system of embodiment 11:
wherein the position information is 2D or 3D space data indicative of the aligned holes;
further comprising a positioning system configured to position the solar module in alignment with the ground structure; and
wherein the positioning system is configured to control the alignment of the solar module with the ground structure based on the 2D or 3D space.

### Embodiment 13

The system of embodiments 11-12:
wherein the solar module includes a space through which to route the fastener, wherein clearance of the space is less than a length of the fastener; and
wherein the at least one controller is configured to determine a curved path as the nonlinear path by which to insert the fastener into the aligned holes by:
   analyzing indicia of the solar module; and
   selecting, based on the indicia of the solar module, the curved path from a plurality of predetermined paths.

### Embodiment 14

The system of any of embodiments 11-13:
wherein the solar module includes a space through which to route the fastener, wherein clearance of the space is less than a length of the fastener;
wherein the at least one controller is configured to determine a curved path as the nonlinear path by which to insert the fastener into the aligned holes by:
   scanning at least a part of the space; and
   selecting, based on the scan, the curved path.

### Embodiment 15

The system of any of embodiments 11-14:
wherein the solar module includes a space through which to route the fastener, wherein clearance of the space is less than a length of the fastener; and
wherein the fastening tool comprises a tube or track by which to automatically route the fastener into the aligned holes.

### Embodiment 16

The system of any of embodiments 11-15:
wherein the at least one controller is further configured to control the fastening tool to, after the fastener is partially inserted into the aligned holes, apply additional force to an end of the fastener in order to seat the fastener entirely into the aligned holes.

### Embodiment 17

The system of any of embodiments 11-16:
wherein the solar module includes a space through which to route the fastener, wherein clearance of the space is less than a length of the fastener;
wherein the fastener tool comprises at least one robot with a gripper; and
wherein the at least one controller is configured to control the at least one robot in order to guide the fastener through the space into the aligned holes.

### Embodiment 18

The system of any of embodiments 11-17:
wherein the at least one controller is configured to control the fastening tool to: automatically convey the fastener from a fastener delivery track; feed the fastener from a receptacle; or move a belt storing a plurality of the fasteners.

### Embodiment 19

The system of any of embodiments 11-18:
wherein the at least one controller is configured to control the fastening tool to:
generate a first pushing motion of the fastener laterally using a fastener motion arm in order to push the fastener closer to the aligned holes and at least a second pushing motion downward using a fastener plunger in order to push the fastener so that the fastener is entirely seated in the aligned holes.

### Embodiment 20

The system of any of embodiments 11-19:
wherein the at least one controller is configured to control the fastening tool to automatically perform one or more movements so that the fastener is inserted into the aligned holes of the solar module and the ground structure includes using at least one robotic system to push the fastener so that the fastener is entirely seated in the aligned respective holes.

### Embodiment 21

A computer-implemented method of, in combination, automatically orienting a fastener and automatically inserting the fastener into aligned holes of a solar module and ground structure, the method comprising:
automatically orienting the fastener in a predetermined orientation at: a central station that replenishes the fasteners in an automated vehicle that performs automatic fastening; an automated trailer that transports the fasteners to the automated vehicle; or the automated vehicle; and
automatically inserting, by the automated vehicle, the fasteners that are in the predetermined orientation into the aligned holes of the solar module and the ground structure.

### Embodiment 22

The method of embodiment 21:
wherein automatically orienting the fastener in the predetermined orientation comprises automatically performing one or more movements that include:
using at least one structure with at least one slot shaped so that the respective fastener is at least partly inserted therein in the predetermined orientation.

### Embodiment 23

The method of embodiments 21-22:
wherein the one or more fasteners are moving;
wherein the at least one structure is stationary; and
wherein the movement of the one or more fasteners results in the respective fastener being inserted into the at least one slot in the predetermined orientation.

### Embodiment 24

The method of any of embodiments 21-23:
wherein the at least one structure comprises: a drum configured to move; and a drum holder;
wherein the drum moves as the one or more fasteners move;
wherein the drum holder is stationary;
wherein the drum includes one or more drum slots into which the one or more fasteners are seated;
wherein the drum holder includes one or more drum holder exit slots;
wherein the movement of the one or more fasteners results in seating within the one or more drum slots; and
wherein, after the one or more fasteners are seated within the one or more drum slots, the movement of the drum relative to the drum holder that is stationary results in alignment of a respective drum slot with a respective drum holder exit slot so that a respective fastener exits the drum holder aligned.

### Embodiment 25

The method of any of embodiments 21-24:
wherein the movement of the drum is rotational; and
wherein the one or more fasteners are inserted within the drum and rotate as the drum is rotated.

### Embodiment 26

The method of any of embodiments 21-25:
wherein after the respective fastener mates within the at least one slot in the predetermined orientation, the respective fastener is routed to the respective drum holder exit slot.

### Embodiment 27

The method of any of embodiments 21-26:
wherein automatically orienting the fastener in the predetermined orientation comprises automatically performing one or more movements by:
using at least one robotic system to perform one or both of:
   selecting the fasteners, from a container of unordered or randomly oriented fasteners, with the predetermined orientation; or
   selecting the fasteners from the container of unordered or randomly oriented fasteners and performing one or more movements so that the fasteners that were selected achieve the predetermined orientation.

### Embodiment 28

The method of any of embodiments 21-27:
wherein automatically orienting the fastener in the predetermined orientation comprises automatically performing one or more movements by:
using at least one vibration system to vibrate unordered or randomly oriented fasteners in order to route the fasteners with the predetermined orientation to one or more automatic fastener installation tools.

### Embodiment 29

The method of any of embodiments 21-28:
wherein the fasteners that are automatically oriented in either the central station or the trailer are loaded into one or more receptacles; and
wherein the one or more receptacles are inserted into one or more automatic fastener installation tools on an autonomous vehicle.

### Embodiment 30

The method of any of embodiments 21-29:
wherein a first autonomous vehicle automatically places the solar module into alignment with the ground structure;
wherein a second autonomous vehicle automatically fastens the solar module to the ground structure;
wherein automatically orienting the fastener is performed on the first autonomous vehicle; and
wherein the fasteners that are oriented on the first autonomous vehicle is transferred to the second autonomous vehicle.

### Embodiment 31

A system configured to, in combination, automatically orient a fastener and automatically insert the fastener into aligned holes of a solar module and ground structure, the system comprising:
structure configured to orient the fasteners into a predetermined orientation, the structure resident on a central station that replenishes the fasteners in at least one automated vehicle that performs automatic fastening; an automated trailer that transports the fasteners to the at least one automated vehicle; or the at least one automated vehicle;
a fastener tool configured to insert the fasteners into the aligned holes and to fasten the solar module to the ground structure using the fasteners; and
at least one controller configured to:
   control the structure to orient the fasteners into the predetermined orientation; and
   control the fastener tool to automatically insert the fasteners in the predetermined orientation into the aligned holes of and to fasten the solar module to the ground structure using the fasteners.

### Embodiment 32

The system of embodiment 31:
wherein the structure is configured to automatically orient the fastener in the predetermined orientation by automatically performing one or more movements that include:
using at least one structure with at least one slot shaped so that the respective fastener is at least partly inserted therein in the predetermined orientation.

### Embodiment 33

The system of embodiments 31-32:
wherein the one or more fasteners are moving;
wherein the at least one structure is configured to be stationary; and
wherein the movement of the one or more fasteners results in the respective fastener being inserted into the at least one slot in the predetermined orientation.

### Embodiment 34

The system of any of embodiments 31-33:
wherein the at least one structure comprises: a drum configured to move; and a drum holder;
wherein the drum is configured to move as the one or more fasteners move;
wherein the drum holder is configured to be stationary;
wherein the drum includes one or more drum slots into which the one or more fasteners are seated;
wherein the drum holder includes one or more drum holder exit slots;
wherein the movement of the one or more fasteners is configured to result in seating within the one or more drum slots; and
wherein, after the one or more fasteners are seated within the one or more drum slots, the movement of the drum relative to the drum holder that is stationary results in alignment of a respective drum slot with a respective drum holder exit slot so that a respective fastener exits the drum holder aligned.

### Embodiment 35

The system of any of embodiments 31-34:
wherein the drum is configured to move rotationally; and
wherein the one or more fasteners are inserted within the drum and rotate as the drum is rotated.

### Embodiment 36

The system of any of embodiments 31-35:
wherein after the respective fastener mates within the at least one slot in the predetermined orientation, the structure is configured to route the respective fastener to the respective drum holder exit slot.

### Embodiment 37

The system of any of embodiments 31-36:
wherein the structure is configured to automatically orient the fastener in the predetermined orientation by automatically performing one or more movements of:
   using at least one robotic system to perform one or both of:
      selecting the fasteners, from a container of unordered or randomly oriented fasteners, with the predetermined orientation; or
      selecting the fasteners from the container of unordered or randomly oriented fasteners and performing one or more movements so that the fasteners that were selected achieve the predetermined orientation.

### Embodiment 38

The system of any of embodiments 31-37:
wherein the structure is configured to automatically orient the fastener in the predetermined orientation by automatically performing one or more movements of:
using at least one vibration system to vibrate unordered or randomly oriented fasteners in order to route the fasteners with the predetermined orientation to one or more automatic fastener installation tools.

### Embodiment 39

The system of any of embodiments 31-38:
wherein the fasteners that are automatically oriented in either the central station or the trailer are loaded into one or more receptacles; and
wherein the one or more receptacles are inserted into one or more automatic fastener installation tools on the autonomous vehicle.

### Embodiment 40

The system of any of embodiments 31-39:
wherein the system comprises:
a first autonomous vehicle configured to automatically place the solar module into alignment with the ground structure;
a second autonomous vehicle automatically configured to fasten, using the fasteners, the solar module to the ground structure;
wherein the structure to automatically orient the fastener is resident on the first autonomous vehicle; and
wherein the fasteners that are oriented on the first autonomous vehicle is transferred to the second autonomous vehicle.

### Embodiment 41

A computer-implemented method of automatically positioning a solar module to be in alignment with ground structure, the method comprising:
automatically generating, using at least one perception system associated with fastening, alignment data; and
automatically moving, using the alignment data from the at least one perception system associated with fastening, the solar module to be in alignment with the ground structure.

### Embodiment 42

The method of embodiment 41:
further comprising using the at least one perception system associated with fastening in order to automatically move the solar module to be in predetermined relation to, but not in alignment with, the ground structure; and
wherein, subsequent to automatically moving the solar module to be in the predetermined relation to the ground structure, using the at least one perception system associated with fastening to automatically move the solar module into alignment with the ground structure.

### Embodiment 43

The method of embodiments 41-42:
wherein the at least one perception system associated with fastening automatically generates ground structure data in order to automatically move the solar module to be in predetermined relation to the ground structure;
wherein the at least one perception system associated with fastening automatically generates the ground structure data prior to performing automatically picking the solar module; and
wherein, after automatically picking the solar module, automatically moving, using the ground structure data, in order to automatically move the solar module to be in the predetermined relation to, but not in alignment with, the ground structure.

### Embodiment 44

The method of any of embodiments 41-43:
where automatically picking the solar module is automatically performed using at least one perception system associated with picking.

### Embodiment 45

The method of any of embodiments 41-44:
wherein automatically moving the solar module is performed by at least one positioning robot resident on a first autonomous vehicle;
wherein the at least one perception system associated with fastening is resident on a second autonomous vehicle;
wherein the second autonomous vehicle further includes at least one fastening robot; and
wherein after alignment of the solar module with the ground structure, the at least one robot resident on the second autonomous vehicle automatically fastens the solar module to the ground structure.

### Embodiment 46

The method of any of embodiments 41-45:
wherein, in aligning the solar module with the ground structure, the at least one perception system associated with fastening generates sensor data; and
wherein the sensor data, used for the aligning of the solar module with the ground structure, is further used for automatically fastening the solar module to the ground structure.

### Embodiment 47

The method of any of embodiments 41-46:
wherein the sensor data used for the aligning of the solar module with the ground structure is indicative of 2D or 3D space data of aligned holes on the solar module and the ground structure; and
wherein the 2D or 3D space data of aligned holes on the solar module and the ground structure is used for automatically inserting a fastener into the aligned holes.

### Embodiment 48

A system configured to automatically position a solar module to be in alignment with ground structure, the system comprising:
at least one perception system associated with fastening;
at least one positioning system configured to position the solar module; and
at least one controller in communication with the at least one perception system and the at least one positioning system, the at least one controller configured to:
   automatically generate, using the at least one perception system associated with fastening, alignment data; and
   automatically controlling the at least one positioning system to move, using the alignment data from the at least one perception system associated with fastening, the solar module to be in alignment with the ground structure.

### Embodiment 49

The system of embodiment 48:
wherein the at least one controller is further configured to use the at least one perception system associated with fastening in order to automatically control the at least one positioning system to move the solar module to be in predetermined relation to, but not in alignment with, the ground structure; and
wherein, subsequent to automatically moving the solar module to be in the predetermined relation to the ground structure, the at least one controller is further configured to use the at least one perception system associated with fastening to control the at least one positioning system to automatically move the solar module into alignment with the ground structure.

### Embodiment 50

The system of embodiments 48-49:
The system of claim 69, wherein the at least one perception system associated with fastening automatically is configured to generate ground structure data for automatically moving by the solar module to be in predetermined relation to the ground structure;
wherein the at least one perception system associated with fastening is configured to automatically generate the ground structure data prior to performing automatically picking the solar module; and
wherein, after automatically picking the solar module, the at least one controller is further configured to control the at least one positioning system to automatically move, using the ground structure data, in order to automatically move the solar module to be in the predetermined relation to, but not in alignment with, the ground structure.

### Embodiment 51

The system of any of embodiments 48-50:
where the at least one positioning system is configured to automatically pick the solar module using at least one perception system associated with picking.

### Embodiment 52

The system of any of embodiments 48-51:
wherein the at least one positioning system comprises at least one positioning robot that is resident on a first autonomous vehicle;
wherein the at least one perception system associated with fastening is resident on a second autonomous vehicle;
wherein the second autonomous vehicle further includes at least one fastening robot; and
wherein after alignment of the solar module with the ground structure, the at least one robot resident on the second autonomous vehicle is configured to automatically fasten the solar module to the ground structure.

### Embodiment 53

The system of any of embodiments 48-52:
wherein, in aligning the solar module with the ground structure, the at least one perception system associated with fastening is configured to generate sensor data; and
wherein the at least one controller is configured to use the sensor data, used for the aligning of the solar module with the ground structure, for automatically fastening the solar module to the ground structure.

### Embodiment 54

The system of any of embodiments 48-53:
wherein the sensor data for the aligning of the solar module with the ground structure is indicative of 2D or 3D space data of aligned holes on the solar module and the ground structure; and
wherein the at least one controller is configured to use the 2D or 3D space data of aligned holes on the solar module and the ground structure for automatically inserting a fastener into the aligned holes.

### Embodiment 55

A computer-implemented method of, in combination, automatically moving a solar module into alignment with ground structure and automatically fastening the solar module to the ground structure, the method comprising:
automatically moving, using at least one perception system, the solar module into alignment with the ground structure; and
automatically fastening, using the at least one perception system, the solar module that is aligned to the ground structure;
wherein automatically moving and automatically fastening are performed in combination.

### Embodiment 56

The method of embodiment 55:
wherein automatically moving and automatically fastening are performed in combination in one or both of: using a same perception system; or using at least same perception system data output.

### Embodiment 57

The system of embodiments 55-56:
wherein the same perception system comprises a perception system associated with a fastening system that performs the automatic fastening; and
wherein the same perception system data output is generated by the perception system associated with the fastening system.

### Embodiment 58

The method of any of embodiments 55-57:
wherein automatically moving and automatically fastening are performed in combination by using 2D or 3D space data indicative of aligned holes on the solar module and the ground structure both for automatically moving and automatically fastening;
wherein the 2D or 3D space data is used in determining whether the holes are aligned for purposes of automatically moving the solar module into alignment with the ground structure; and
wherein the 2D or 3D space data is used in determining how to move at least one robot for inserting the fastener into the aligned holes.

### Embodiment 59

The method of any of embodiments 55-58:
wherein automatically moving and automatically fastening are performed in combination by using the same perception system to perform the automatically moving and the automatically fastening.

### Embodiment 60

The method of any of embodiments 55-59:
wherein the same perception system comprises a perception system associated with a fastening system that performs the automatic fastening; and
wherein the perception system associated with the fastening system generates sensor data to:
   align the solar module with the ground structure; and
   fasten the solar module to the ground structure.

### Embodiment 61

The method of any of embodiments 55-60:
wherein automatically fastening is performed by at least one fastening robot; and
wherein automatically moving and automatically fastening are performed in combination by:
   sensor data generated by the at least one perception system associated with the at least one fastening robot is used to automatically move the solar module into alignment with the ground structure; and
   the at least one fastening robot is used to automatically fasten the solar module to the ground structure.

### Embodiment 62

The method of any of embodiments 55-61:
wherein the at least one perception system is associated with the at least one fastening robot by being positioned in or on an autonomous vehicle that also includes the at least one fastening robot; and
wherein at least one positioning robot, which automatically moves the solar module, is positioned in or on a separate autonomous vehicle.

### Embodiment 63

The method of any of embodiments 55-62:
wherein the sensor data generated by the at least one perception system associated with the at least one fastening robot is further used to automatically move the solar module in predetermined relation to the ground structure; and
wherein, after moving the solar module in predetermined relation to the ground structure, the sensor data generated by that at least one perception system associated with the at least one fastening robot is used to automatically move the solar module into alignment with the ground structure.

### Embodiment 64

The method of any of embodiments 55-63:
wherein the at least one perception system associated with the at least one fastening robot is configured to iteratively generate the sensor data in order to iteratively move the solar module into alignment with the ground structure.

### Embodiment 65

A system configured to perform, in combination, automatically moving a solar module into alignment with ground structure and automatically fastening the solar module to the ground structure, the system comprising:
at least one solar module movement system to move the solar module;
at least one fastening system to fasten the solar module to the ground structure;
at least one perception system; and
at least one controller in communication with the at least one solar module movement system and the at least one fastening system, the at least one controller configured to:
   automatically control, using the at least one perception system, the at least one solar module movement system to move the solar module into alignment with the ground structure; and
   automatically control, using the at least one perception system, the at least one fastening system to fasten the solar module that is aligned to the ground structure;
wherein the at least one controller is configured to control automatically moving and automatically fastening to be performed in combination.

### Embodiment 66

The system of embodiment 65:
wherein the at least one controller is configured to control automatically moving and automatically fastening to be performed in combination in one or both of: using a same perception system; or using at least same perception system data output.

### Embodiment 67

The system of embodiments 65-66:
wherein the same perception system comprises a perception system associated with a fastening system that performs the automatic fastening; and
wherein the same perception system data output is generated by the perception system associated with the at least one fastening system.

### Embodiment 68

The system of any of embodiments 65-67:
wherein the at least one controller is configured to control automatically moving and automatically fastening to be performed in combination by using 2D or 3D space data indicative of aligned holes on the solar module and the ground
structure both for controlling automatically moving and automatically fastening;
wherein the 2D or 3D space data is used in determining whether the holes are aligned for purposes of automatically moving the solar module into alignment with the ground structure; and
wherein the 2D or 3D space data is used in determining how to move at least one robot for inserting the fastener into the aligned holes.

### Embodiment 69

The system of any of embodiments 65-68:
wherein the at least one controller is configured to control automatically moving and automatically fastening to be performed in combination by using the same perception system to perform the automatically moving and the automatically fastening.

### Embodiment 70

The system of any of embodiments 65-69:
wherein the same perception system comprises a perception system associated with the at least one fastening system; and
wherein the at least one controller uses sensor data generated by the perception system associated with the fastening system to:
   control alignment the solar module with the ground structure; and
   control fastening the solar module to the ground structure.

### Embodiment 71

The system of any of embodiments 65-70:
wherein the at least one fastening system comprises at least one fastening robot; and
wherein the at least one controller is configured to control automatically moving and automatically fastening to be performed in combination by:
   using sensor data generated by that at least one perception system associated with the at least one fastening robot to automatically move the solar module into alignment with the ground structure; and
   using the at least one fastening robot to automatically fasten the solar module to the ground structure.

### Embodiment 72

The system of any of embodiments 65-71:
wherein the at least one perception system is associated with the at least one fastening robot by being positioned in or on an autonomous vehicle that also includes the at least one fastening robot;
wherein the at least one solar module movement system comprises at least one positioning robot; and
wherein the at least one positioning robot, which is configured to automatically move the solar module, is positioned in or on a separate autonomous vehicle.

### Embodiment 73

The system of any of embodiments 65-72:
wherein the at least one controller is configured to use the sensor data generated by the at least one perception system associated with the at least one fastening robot to control automatically moving the solar module in predetermined relation to the ground structure; and
wherein, after moving the solar module in predetermined relation to the ground structure, the at least one controller is configured to use the sensor data generated by that at least one perception system associated with the at least one fastening robot to automatically move the solar module into alignment with the ground structure.

### Embodiment 74

The system of any of embodiments 65-73:
wherein the at least one controller is configured to iteratively use the sensor data generated the at least one perception system associated with the at least one fastening robot to iteratively control movement of the solar module into alignment with the ground structure.

What is claimed is:

1. A computer-implemented method of, in combination, automatically moving a solar module into alignment with ground structure and automatically fastening the solar module to the ground structure, the method comprising:
automatically moving, using at least one perception system, the solar module into alignment with the ground structure; and
automatically fastening, using the at least one perception system, the solar module that is aligned to the ground structure;
wherein automatically moving and automatically fastening are performed in combination.

2. The method of claim 1, wherein automatically moving and automatically fastening are performed in combination in one or both of: using a same perception system; or using at least same perception system data output.

3. The method of claim 2, wherein the same perception system comprises a perception system associated with a fastening system that performs the automatic fastening; and
wherein the same perception system data output is generated by the perception system associated with the fastening system.

4. The method of claim 2, wherein automatically moving and automatically fastening are performed in combination by using 2D or 3D space data indicative of aligned holes on the solar module and the ground structure both for automatically moving and automatically fastening;
wherein the 2D or 3D space data is used in determining whether the holes are aligned for purposes of automatically moving the solar module into alignment with the ground structure; and
wherein the 2D or 3D space data is used in determining how to move at least one robot for inserting the fastener into the aligned holes.

5. The method of claim 2, wherein automatically moving and automatically fastening are performed in combination by using the same perception system to perform the automatically moving and the automatically fastening.

6. The method of claim 5, wherein the same perception system comprises a perception system associated with a fastening system that performs the automatic fastening; and
wherein the perception system associated with the fastening system generates sensor data to:
align the solar module with the ground structure; and
fasten the solar module to the ground structure.

7. The method of claim 1, wherein automatically fastening is performed by at least one fastening robot; and
wherein automatically moving and automatically fastening are performed in combination by:
sensor data generated by the at least one perception system associated with the at least one fastening robot is used to automatically move the solar module into alignment with the ground structure; and
the at least one fastening robot is used to automatically fasten the solar module to the ground structure.

8. The method of claim 7, wherein the at least one perception system is associated with the at least one fastening robot by being positioned in or on an autonomous vehicle that also includes the at least one fastening robot; and
wherein at least one positioning robot, which automatically moves the solar module, is positioned in or on a separate autonomous vehicle.

9. The method of claim 7, wherein the sensor data generated by the at least one perception system associated with the at least one fastening robot is further used to automatically move the solar module in predetermined relation to the ground structure; and
wherein, after moving the solar module in predetermined relation to the ground structure, the sensor data generated by that at least one perception system associated with the at least one fastening robot is used to automatically move the solar module into alignment with the ground structure.

10. The method of claim 7, wherein the at least one perception system associated with the at least one fastening robot is configured to iteratively generate the sensor data in order to iteratively move the solar module into alignment with the ground structure.

11. A system configured to perform, in combination, automatically moving a solar module into alignment with ground structure and automatically fastening the solar module to the ground structure, the system comprising:
at least one solar module movement system to move the solar module;
at least one fastening system to fasten the solar module to the ground structure;
at least one perception system; and
at least one controller in communication with the at least one solar module movement system and the at least one fastening system, the at least one controller configured to:
automatically control, using the at least one perception system, the at least one solar module movement system to move the solar module into alignment with the ground structure; and
automatically control, using the at least one perception system, the at least one fastening system to fasten the solar module that is aligned to the ground structure;
wherein the at least one controller is configured to control automatically moving and automatically fastening to be performed in combination.

12. The system of claim 11, wherein the at least one controller is configured to control automatically moving and automatically fastening to be performed in combination in one or both of: using a same perception system; or using at least same perception system data output.

13. The system of claim 12, wherein the same perception system comprises a perception system associated with a fastening system that performs the automatic fastening; and
wherein the same perception system data output is generated by the perception system associated with the at least one fastening system.

14. The system of claim 12, wherein the at least one controller is configured to control automatically moving and automatically fastening to be performed in combination by using 2D or 3D space data indicative of aligned holes on the solar module and the ground structure both for controlling automatically moving and automatically fastening;
wherein the 2D or 3D space data is used in determining whether the holes are aligned for purposes of automatically moving the solar module into alignment with the ground structure; and
wherein the 2D or 3D space data is used in determining how to move at least one robot for inserting the fastener into the aligned holes.

15. The system of claim 12, wherein the at least one controller is configured to control automatically moving and automatically fastening to be performed in combination by using the same perception system to perform the automatically moving and the automatically fastening.

16. The system of claim 15, wherein the same perception system comprises a perception system associated with the at least one fastening system; and
wherein the at least one controller uses sensor data generated by the perception system associated with the fastening system to:
control alignment the solar module with the ground structure; and
control fastening the solar module to the ground structure.

17. The system of claim 11, wherein the at least one fastening system comprises at least one fastening robot; and
wherein the at least one controller is configured to control automatically moving and automatically fastening to be performed in combination by:
using sensor data generated by that at least one perception system associated with the at least one fastening robot to automatically move the solar module into alignment with the ground structure; and
using the at least one fastening robot to automatically fasten the solar module to the ground structure.

18. The system of claim 17, wherein the at least one perception system is associated with the at least one fastening robot by being positioned in or on an autonomous vehicle that also includes the at least one fastening robot;
wherein the at least one solar module movement system comprises at least one positioning robot; and
wherein the at least one positioning robot, which is configured to automatically move the solar module, is positioned in or on a separate autonomous vehicle.

19. The system of claim 17, wherein the at least one controller is configured to use the sensor data generated by the at least one perception system associated with the at least one fastening robot to control automatically moving the solar module in predetermined relation to the ground structure; and
wherein, after moving the solar module in predetermined relation to the ground structure, the at least one controller is configured to use the sensor data generated by that at least one perception system associated with the at least one fastening robot to automatically move the solar module into alignment with the ground structure.

20. The system of claim 17, wherein the at least one controller is configured to iteratively use the sensor data generated the at least one perception system associated with the at least one fastening robot to iteratively control movement of the solar module into alignment with the ground structure.
